(19) United States
(12) Patent Application Publication
(10) Pub. No.: US 2024/0370865 A1
(43) Pub. Date: Nov. 7, 2024

(54) Method and System to Implement an NFT Architecture Framework for Bitcoin Inscriptions, Ordinals and Smart Contracts Interworking with a Cross-Chain Communications Network of Bridges, Substrates, and Parachains, Off-Chain IPFS Decentralized Smart Contract Storage, Zero Trust Security Framework, Bitcoin NFT Tokenization, Bitcoin NFT Copyright Ownership and Validation using DRM, Open AI Applications for Smart Contracts, and WebRTC-QUIC Secure Video and Messaging Communications

(71) Applicant: AVILA TECHNOLOGY, LLC, Fort Collins, CO (US)

(72) Inventor: ROBERT BERNARDI, MCLEAN, VA (US)

(21) Appl. No.: 18/144,252

(22) Filed: May 8, 2023

Related U.S. Application Data
(60) Provisional application No. 63/463,072, filed on May 1, 2023.

(51) Int. Cl. G06Q 20/40; G06Q 20/36; G06Q 20/38

(52) U.S. Cl. CPC G06Q 20/401; G06Q 20/36; G06Q 20/389

(57) ABSTRACT

The invention relates to systems and methods for providing an NFT Architecture Framework for Bitcoin NFTs and Smart Contracts Interworking with Cross-Chain Decentralized Communications Networks of Parachains, Substates, Oracles, Sidechains and Protocols, Zero Trust Security, Off-Chain IPFS Smart Contract Storage, Bitcoin NFT Tokenization, NFT Copyright Ownership and Validation System, Open AI Applications for Smart Contact Visualization and WebRTC-UDP/QUIC Video and Messaging Communications between Bitcoin NFT Buyers and Sellers.

### BACKGROUND

### Field of the Invention

The invention relates to systems and methods for providing an NFT Architecture Framework for Bitcoin NFTs and Smart Contracts Interworking with Cross-Chain Decentralized Communications Networks of Parachains, Substates, Oracles, Sidechains and Protocols, Zero Trust Security, Off-Chain IPFS Smart Contract Storage, Bitcoin NFT Tokenization, NFT Copyright Ownership and Validation System, Open AI Applications for Smart Contact Visualization and WebRTC-UDP/QUIC Video and Messaging Communications between Bitcoin NFT Buyers and Sellers.

### Background of the Invention

Bitcoin was introduced in 2009 as a Peer-to-Peer Electronic Cash System. A purely peer-to-peer version of electronic cash allows online payments to be sent directly from one party to another without going through a financial institution. Bitcoin proposed a solution to the double-spending problem using a peer-to-peer network. The network timestamps transactions by hashing them into an ongoing chain of hash-based proof-of-work, forming a record that cannot be changed without redoing the proof-of-work. The network itself requires minimal structure. Messages are broadcast on a best effort basis, and nodes can leave and rejoin the network at will, accepting the longest proof-of-work chain as proof of what happened while they were gone.

A Bitcoin smart contract is just like any other smart contract. It is a code that automatically executes when certain predefined conditions or criteria are met. Smart contracts can have single or multiple criteria. The Script programming language is simple. It allows Bitcoin users to set conditions for the spending of their BTC. Bitcoin transactions can lock a specific amount of Bitcoin to a script and this amount can only be unlocked for spending when predefined criteria are met. Therefore, in a sense, all Bitcoin transactions are smart contracts.

### Bitcoin Smart Contracts on Layer 2 Blockchain Platforms

The Bitcoin network supports a broad range of smart contracts including Smart Contracts on Layer 2 Blockchain Platforms. Bitcoin can power smart contracts on protocols such as the Lightning Network (LN), which was built on top of the Bitcoin network. LN depends on multi-signature transactions known as Hashed Time-Locked Contracts (HTLCs) to allow low-cost and instant Bitcoin micropayments.

Bitcoin smart contracts have evolved over time due to different upgrades the network has implemented. The most recent soft upgrade, Taproot, occurred in November 2021, giving users more flexibility when building complex smart contracts on Bitcoin's blockchain. This increases Bitcoin's payment function, but it doesn't mean that Bitcoin smart contracts can support decentralized applications (dApps) from blockchains like Ethereum, Solana, Cardona or Binance.

Although Bitcoin may never achieve fully expressive smart contracts on its base layer, it could attain this goal by interworking with on other Blockchains and p2p networks. For example, Stacks is an open-source Layer 1 blockchain that connects to the Bitcoin network, allowing users to build smart contracts and dApps. It connects to Bitcoin through the proof-of-transfer (PoX) consensus mechanism where Stacks miners pay Bitcoin to mint new Stacks coins (STX). Stacks leverages Bitcoin's security and brings smart contracts to the Bitcoin network. The smart contracts are created using a programming language known as Clarity.

Bitcoin's programmability trade-off is not a bad thing, and its smart contract functionality can be expanded on Layer 2 networks or separate blockchains connected to the Bitcoin network. Also, Bitcoin's security has proved to be highly effective compared to other blockchains, a factor that may encourage more projects to leverage Bitcoin's security while delivering fully expressive smart contracts on top of Bitcoin's base layer blockchain.

### Bitcoin Inscriptions, Ordinals and Smart Contracts

In December 2022, Bitcoin released open-source software called ORD that runs on top of a Bitcoin Core full node. The software allows users to encode computer files into hexadecimal data inside a Bitcoin transaction (“Inscription”) with a 4 MB size limit and “bind” that posted data to an individual Satoshi, effectively creating an NFT (“Ordinal”). Inscriptions are blobs of arbitrary data and associated metadata, the latter of which tells a Bitcoin node how to render said data (an image, digital art, intellectual property, etc.). The inscriptions are like “call data” on Ethereum in that they store read-only data. Together Inscriptions and Ordinals allows Bitcoin users to now offer the sales of NFTs and the creation of on-chain smart contracts like NFTs on Ethereum and other Blockchains.

### Bitcoin NFT Smart Contracts

The recent Bitcoin Taproot upgrade does not allow smart contracts to be moved to permanent off-chain storage and will not enable the same fully expressive and recursive smart contracts that exist in alternative blockchain systems such as Ethereum, Solana, Cardano and Binance and this flexible transfer of smart contracts to other Blockchains or to permanent storage will almost certainly never happen as recursive smart contracts are widely considered to be unacceptably risky for Bitcoin.

### Bitcoin Ordinal NFTs

NFTs on Bitcoin are different from the Ethereum NFTs most people are familiar with. Here is how they are different.

Non-fungible tokens (NFT) are most widely known as Ethereum-based tokens, but lately the buzz is all about Bitcoin NFTs, which are also known as Ordinal NFTs or Bitcoin Ordinals. The introduction of something called inscriptions on Bitcoin's mainnet in January 2023 enabled the creation of Ordinal NFTs, which are basically NFTs on Bitcoin. The novel project has captured the collective mindshare of both NFT lovers and haters. CoinDesk's coverage of Ordinals has ranged from how it has led to a resurgence in Bitcoin development, how it might have accidentally fixed Bitcoin's security budget and how it can potentially lift the entire crypto ecosystem.

Ordinal NFTs use inscriptions to work. Inscriptions are powered by Ordinal theory through the Ordinal protocol, which was developed by Casey Rodarmor. Ordinal theory aims to give satoshis (the smallest unit of bitcoin at 1/100,000,000 of a full bitcoin) “individual identities allowing them to be tracked, transferred and imbued with meaning.”

Basically, the Ordinal protocol assigns each satoshi a sequential number. After that number is assigned, each satoshi can then be inscribed with data such as pictures, text, or videos through a Bitcoin transaction. Once that transaction is mined, the arbitrary data is permanently part of the Bitcoin blockchain and viewable through Ordinal-enabled Bitcoin wallets and online Ordinal viewers.

The one main difference between Ordinal NFTs and other NFTs has to do with data storage. Most NFTs are created using the Ethereum blockchain through the ERC-721 Non-Fungible Token Standard. ERC 721 is a standard which outlines how an NFT should be created so that it will be properly recognized across the Ethereum ecosystem. When an ERC-721 NFT is created, a file of metadata—literally data which provides information about other data (hence, “meta”)—provides information about the NFT. The easiest way to think of it is that the NFT itself is a contract that proves ownership of another item, which is detailed in that metadata. In the case of the most common NFTs, which are digital art, the actual JPG or file of the art is usually stored off the Ethereum blockchain and the metadata includes a link to that file. This means that the actual file or artwork can be altered since it is not embedded in the blockchain.

Bitcoin's Ordinal NFTs are different in that there isn't a file of referenceable metadata that describes the NFT; instead, the entire data file resides in the witness signature field of Bitcoin transactions. That means the entirety of Ordinal NFTs live and breathe on the blockchain.

Whether that matters or not is up to the user, but Ordinal NFTs bring an additional level of immutability to NFTs.

### Mint an Ordinal NFT

Ordinal NFTs are new, so their accessibility is limited as the ecosystem builds out. There are two main ways to mint a user's own Ordinal NFT right now. The first way is by starting up a full Bitcoin node and running Ord on the node. Then a user can start inscribing satoshis into a wallet the user controls to make Ordinal NFTs. This method is technically involved and is more suitable for tech savvy hobbyists and those who really love NFTs.

The other way to inscribe an Ordinal NFT is to use a no-code inscription tool. It's a far more casual experience and works fine if a user does not mind inserting a little trust into the minting process. A user can own and mint an Ordinal MFT using one of these no-code tools called Gamma. It is relatively straightforward for those familiar with Bitcoin, but it can be a bit tricky at parts.

Before a user starts, they must have some bitcoin (˜$50 worth) so they can pay the transaction fee for the inscription. The wallet a user has it in must be able to send bitcoin to Taproot addresses using a wallet and service provider that supports Taproot. A user needs to look for the “Send to Bech32m” column-which is different than the “Send to Bech32” column, to make sure they are scanning the correct one. A “Yes” in that Bech32m column indicates if the wallet can send bitcoin to Taproot addresses. Note that popular exchanges like Coinbase and Binance do not support Taproot.

Once a user has their transaction fee bitcoin secured in their wallet, the user can start minting their Ordinal NFT. Here's the step-by-step process used to mint an Ordinal using Gamma. A user could also use something like OrdinalsBot and the process would be the same, as follows: Choose the inscription type, either an image file or just plain text; Upload the desired file by selecting the file from the desktop or typing in the text directly where indicated; Select a transaction fee rate based on how long a user is willing to wait for the NFT to mint. Take note of the estimated mint times provided for the various fee rate choices. Select the transaction fees (which range from $8-$17, which can take hours to days to process).

The next step is to designate the Ordinal NFT receipt address where the Ordinal NFT should be sent. The address needs to be either a Taproot address or an Ordinal-compatible address. The Bitcoin address where the Ordinal will be transferred after created should be a new, unused Taproot address or Ordinals-compatible address.

A receipt Bitcoin address is the address where to send the Ordinal. This address is also used for refunds. An example address is: bc1p4djmu70t288t25q8evq. In case of refund, the funds will be sent to this address.

Many Wallets are available, but the Sparrow Wallet is recommended to be used for Ordinal NFTs. Once the Sparrow Wallet address is set up, drop it into the “Recipient bitcoin address” field on the Gamma website. Make sure the first four characters of this address are “bc1p.” as shown above since this prefix indicates that the address is a Taproot address.

Pay the transaction fee for minting the Ordinal NFT by sending the indicated amount of Bitcoin to the indicated address. Note that this address will also start with “bc1p.” The user must employ coin control, sending bitcoin for payment from a different wallet than the wallet receiving the Ordinal NFT, to avoid mistakenly sending a previously inscribed satoshi that they own, and they'd no longer have access to that NFT.

Unfortunately, with Bitcoin NFTs, the process could take up to a few days depending on the fee rate selected. A user will have received a link to check on the status of their minting. The buyer can usually enjoy the purchased NFT through an Ordinal viewer. As always, the buyer needs to be cognizant and careful with this new NFT capability on Bitcoin. Ordinals are new and can be finicky. And everything a buyer and seller does on bitcoin can be easily tracked so privacy must be considered.

### SUMMARY OF THE INVENTION

The invention provides a Blockchain based NFT architecture framework for Bitcoin Inscriptions, Ordinals and Smart Contracts based on a cross-chain interoperable communications network of substrates, parachains, oracles, sidechains and protocols integrated with a Zero Trust Security framework, off-chain IPFS decentralized p2p smart contract storage, Bitcoin NFT tokenization, NFT copyright ownership and validation, Open AI smart contract applications and WebRTC-UDP/QUIC secure video and messaging communications for Bitcoin NFT buyers and sellers who require privacy, confidentiality and security.

In a preferred embodiment, the invention is a system for a Bitcoin NFT architecture framework with cross chain inter-operability, comprising:
a bitcoin-inscriptions and ordinals (BIO) module having an Unspent Transaction Output (UTXO) module, an inscriptions module, an ordinals module, a 4 MB Satoshi module, a taproot module, and a smart contracts module;
a seller module, having a seller digital wallet, configured with a self sovereign identity module, and a buyer module having a buyer digital wallet, configured with a self sovereign identity module, is operatively connected to the bitcoin-inscriptions and ordinals module;
a Zero Trust Security Platform (“ZTS Platform”) in operative communication with the BIO module using a UDP-QUIC protocol, the ZTS platform having a Smart Contract module with seller-side ownership verification and buyer-side authentication, a Cross-chain Module in communication with the Smart Contract module to provide Smart Contract parachains using Solidity & Web Assembly (WASM) code, the Cross-chain Module having a Bridges & Substrates module for cross-chain interoperability, the Cross-chain Module in operative communication with a public key encryption (PKI) module, a Self-Sovereign Identity Management (SSI) module, a Digital Rights Management (DRM) module, a Zero Knowledge Proofs (ZKP) module, and an Elliptical curve-Diffie Hellman (ECDH) encryption module;
an IPFS Decentralized Storage module in operative communication with the ZTS module and having a Virtual Machine (VM) module, an IPFS Gateway module, a gateway Registry module, a Bitcoin NFT & Smart Contract IPFS module, and an OpenAI-Smart Contact Visualization module, the IPFS Gateway module in communication with a Merkle-DAGs module and a DHT module, the IPFS Decentralized Storage module in operative communication with a Content Address module and a Content Link module, the OpenAI-Smart Contact Visualization module in operative communication with a Solidity WASM module and a ChatGPT module;
a Bitcoin-NFT Tokenization module is operatively connected to the IPFS Decentralized Storage module, the Bitcoin-NFT Tokenization module having a Bitcoin Tokens module, a Bitcoin NFTs module, and an Infrastructure Finance Instruments module, a Bank & Private Loan module and a VCs and Private Investor module are operatively connected to the Bitcoin-NFT Tokenization module;
an NFT Copyright Ownership & Validation module is operatively connected to the Bitcoin-NFT Tokenization module, the NFT Copyright Ownership & Validation module having an NFT Copyright Registry module, and a Smart/Ricardian Contract module using legal prose and structured language protocols;
a WebRTC-QUIC Real Time Communications platform is in operative communication with the NFT Copyright Ownership & Validation module, the WebRTC-QUIC Real Time Communications platform having a P2P de-Net using a HTTP/3-QUIC-UDP Transport layer protocol, said P2P de-Net connecting a plurality of user devices having a DRM Application, each user device configured to receive, transmit, and store a smart contract, a video, a text document, and a photo, each user device configured to apply DRM rights restrictions selected from copy restriction, print restriction, forward restriction, expiration, and revoke access, each user device configured with SSI ID, wherein said P2P de-Net having a Blockchain module configured to provide and manage DLT, Crypto hash, SSI ID, and Smart Contracts Metadata, said P2P de_net having a DRM Server-Side Rendering module to apply, monitor, and enforce DRM restrictions on files transferred thru the P2P de-Net; and,
a Bitcoin Social Interaction Platform is in operative communication with the WebRTC-QUIC Real Time Communications platform, said Bitcoin Social Interaction Platform configured to provide access to a video, a podcast, or a live chat on said user devices.

In another preferred embodiment, the invention is a method, comprising:
implementing the system claimed herein to generate and transmit from a first user to a second user, a BTC+NFT identifier using BitCoin blockchain to provide a secure, anonymous, and confidential NFT transaction for an NFT buyer and an NFT seller for transacting an NFT identifying a piece of art, a video game product, an intellectual property (IP) asset, a sport related wager or transaction, an on-line gaming transaction, a real estate asset and transaction, and a music-related asset, said BTC+NFT identifier configured to fit within a 4 MB space of a Satoshi unit in a BitCoin block in a BitCoin blockchain, said BTC+NFT identifier pointing to a distributed ledger having a smart contract stored in an IPFS storage facility.

### BRIEF DESCRIPTION OF THE FIGURES

FIG. 1 is an illustration of a non-limiting example of the NFT Architecture Framework for Bitcoin Inscriptions, Ordinals and Smart Contracts.

FIG. 2 is an illustration of a non-limiting example of the NFT Architecture Framework for Bitcoin Inscriptions, Ordinals and Smart Contracts.

FIG. 3 is an illustration of a non-limiting example of the Integration of zero trust principles with blockchain and IPFS Decentralized Storage.

FIG. 4 is an illustration of a non-limiting example of Self Sovereign Identity with Blockchain, Verifiable Credentials and Decentralized Identifiers.

FIG. 5 is an illustration of a non-limiting example of Benefits of implementing Fractal decentralized identity for NFTs.

FIG. 6 is an illustration of a non-limiting example of the Elements of a PKI.

FIG. 7 is an illustration of a non-limiting example of Certificate Authority for Digital Certificates.

FIG. 8 is an illustration of a non-limiting example of Polkadot Cross-Chain Architecture.

FIG. 9 is an illustration of a non-limiting example of Cross-Chain Communication.

FIG. 10 is an illustration of a non-limiting example of Cross Chain Communications using a Zero Trust Security Interoperability Gateway Nodes to Enable Secure Smart Contract Communications among different Blockchains.

FIG. 11 is an illustration of a non-limiting example of Dynamic NFTs.

FIG. 12 is an illustration of a non-limiting example of Zero Trust Security Architecture.

FIG. 13 is an illustration of a non-limiting example of Traditional Perimeter Security Versus Zero Trust Security.

FIG. 14 is an illustration of a non-limiting example of the Zero Trust Security Interworking with Bitcoin NFTs.

FIG. 15 is an illustration of a non-limiting example of Public Key Encryption.

FIG. 16 is an illustration of a non-limiting example of Self Sovereign Identity Management.

FIG. 17 is an illustration of a non-limiting example of Zero Knowledge Proof-Its Role in Blockchain for Authentication.

FIG. 18 is an illustration of a non-limiting example of Digital Rights Management with Server-Side Rendering.

FIG. 19 is an illustration of a non-limiting example of Secure Multiparty Computation Protocol.

FIG. 20 is an illustration of a non-limiting example of Homomorphic Encryption.

FIG. 21 is an illustration of a non-limiting example of Data Sharing on IPFS by Smart Contract or Ricardian Contract Owner.

FIG. 22 is an illustration of a non-limiting example of IPFS Content Addressing Flow Process.

FIG. 23 is an illustration of a non-limiting example of the IPFS-Bitcoin workflow, a 4-step process for securing and sharing smart contracts and data files.

FIG. 24 is an illustration of a non-limiting example of Bitcoin NFT Tokenization.

FIG. 25 is an illustration of a non-limiting example of the Applicability of Bitcoin Tokenization.

FIG. 26 is an illustration of a non-limiting example of Comparison of Ricardian Contracts and Smart Contracts.

FIG. 27 is an illustration of a non-limiting example of a Ricardian Contract with Legal Prose and Structured Language.

FIG. 28 is an illustration of a non-limiting example of an Open AI-ChatGPT Application for Smart Contract Visualization on Bitcoin.

FIG. 29 is an illustration of a non-limiting example of the NFT Ricardian Contract Copyright Ownership, Validation and Verification Network.

FIG. 30 is an illustration of a non-limiting example of the Bitcoin Based Copyright Ownership, Validation and Verification Process for Ricardian Contracts using an IPFS Gateway Registry and IPFS Decentralized Storage.

FIG. 31 is an illustration of a non-limiting example of the IPFS-Copyright Registry workflow, a 4-step process for securing and sharing Ricardian Contract files.

FIG. 32 is an illustration of a non-limiting example of WebRTC-QUIC Multimedia Communications for Secure DRM Protected NFT Video Chats and Content Messaging Between a Bitcoin Buyer and Seller.

FIG. 33 is an illustration of a non-limiting example of the WebRTC-QUIC HTTP/3 Protocol Stack.

FIG. 34 is an illustration of a non-limiting example of Comparison of HTTP/2-TLS with HTTP/3 UDP-QUIC.

FIG. 35 is an illustration of a non-limiting example of UDP-QUIC versus TCP for RTT Connection Establishment for Video Streams.

FIG. 36 is an illustration of a non-limiting example of a WebRTC-QUIC Transport Layer Protocol with Bitcoin Social Interaction Platform.

### DETAILED DESCRIPTION OF THE INVENTION

Disclosed herein is a system for a Bitcoin NFT architecture framework with cross chain inter-operability, comprising:
a bitcoin-inscriptions and ordinals (BIO) module having an Unspent Transaction Output (UTXO) module, an inscriptions module, an ordinals module, a 4 MB Satoshi module, a taproot module, and a smart contracts module;
a seller module, having a seller digital wallet, configured with a self sovereign identity module, and a buyer module having a buyer digital wallet, configured with a self sovereign identity module, is operatively connected to the bitcoin-inscriptions and ordinals module;
a Zero Trust Security Platform (“ZTS Platform”) in operative communication with the BIO module using a UDP-QUIC protocol, the ZTS platform having a Smart Contract module with seller-side ownership verification and buyer-side authentication, a Cross-chain Module in communication with the Smart Contract module to provide Smart Contract parachains using Solidity & Web Assembly (WASM) code, the Cross-chain Module having a Bridges & Substrates module for cross-chain interoperability, the Cross-chain Module in operative communication with a public key encryption (PKI) module, a Self-Sovereign Identity Management (SSI) module, a Digital Rights Management (DRM) module, a Zero Knowledge Proofs (ZKP) module, and an Elliptical curve-Diffie Hellman (ECDH) encryption module;
an IPFS Decentralized Storage module in operative communication with the ZTS module and having a Virtual Machine (VM) module, an IPFS Gateway module, a gateway Registry module, a Bitcoin NFT & Smart Contract IPFS module, and an OpenAI-Smart Contact Visualization module, the IPFS Gateway module in communication with a Merkle-DAGs module and a DHT module, the IPFS Decentralized Storage module in operative communication with a Content Address module and a Content Link module, the OpenAI-Smart Contact Visualization module in operative communication with a Solidity WASM module and a ChatGPT module;
a Bitcoin-NFT Tokenization module is operatively connected to the IPFS Decentralized Storage module, the Bitcoin-NFT Tokenization module having a Bitcoin Tokens module, a Bitcoin NFTs module, and an Infrastructure Finance Instruments module, a Bank & Private Loan module and a VCs and Private Investor module are operatively connected to the Bitcoin-NFT Tokenization module;
an NFT Copyright Ownership & Validation module is operatively connected to the Bitcoin-NFT Tokenization module, the NFT Copyright Ownership & Validation module having an NFT Copyright Registry module, and a Smart/Ricardian Contract module using legal prose and structured language protocols;
a WebRTC-QUIC Real Time Communications platform is in operative communication with the NFT Copyright Ownership & Validation module, the WebRTC-QUIC Real Time Communications platform having a P2P de-Net using a HTTP/3-QUIC-UDP Transport layer protocol, said P2P de-Net connecting a plurality of user devices having a DRM Application, each user device configured to receive, transmit, and store a smart contract, a video, a text document, and a photo, each user device configured to apply DRM rights restrictions selected from copy restriction, print restriction, forward restriction, expiration, and revoke access, each user device configured with SSI ID, wherein said P2P de-Net having a Blockchain module configured to provide and manage DLT, Crypto hash, SSI ID, and Smart Contracts Metadata, said P2P de_net having a DRM Server-Side Rendering module to apply, monitor, and enforce DRM restrictions on files transferred thru the P2P de-Net; and,
a Bitcoin Social Interaction Platform is in operative communication with the WebRTC-QUIC Real Time Communications platform, said Bitcoin Social Interaction Platform configured to provide access to a video, a podcast, or a live chat on said user devices.

In another preferred embodiment, the invention is a method, comprising:
implementing the system claimed herein to generate and transmit from a first user to a second user, a BTC+NFT identifier using BitCoin blockchain to provide a secure, anonymous, and confidential NFT transaction for an NFT buyer and an NFT seller for transacting an NFT identifying a piece of art, a video game product, an intellectual property (IP) asset, a sport related wager or transaction, an on-line gaming transaction, a real estate asset and transaction, and a music-related asset, said BTC+NFT identifier configured to fit within a 4 MB space of a Satoshi unit in a BitCoin block in a BitCoin blockchain, said BTC+NFT identifier pointing to a distributed ledger having a smart contract stored in an IPFS storage facility;
providing the system claimed herein, the system comprising
a bitcoin-inscriptions and ordinals (BIO) module having an Unspent Transaction Output (UTXO) module, an inscriptions module, an ordinals module, a 4 MB Satoshi module, a taproot module, and a smart contracts module;
a seller module, having a seller digital wallet, configured with a self sovereign identity module, and a buyer module having a buyer digital wallet, configured with a self sovereign identity module, is operatively connected to the bitcoin-inscriptions and ordinals module;
a Zero Trust Security Platform (“ZTS Platform”) in operative communication with the BIO module using a UDP-QUIC protocol, the ZTS platform having a Smart Contract module with seller-side ownership verification and buyer-side authentication, a Cross-chain Module in communication with the Smart Contract module to provide Smart Contract parachains using Solidity & Web Assembly (WASM) code, the Cross-chain Module having a Bridges & Substrates module for cross-chain interoperability, the Cross-chain Module in operative communication with a public key encryption (PKI) module, a Self-Sovereign Identity Management (SSI) module, a Digital Rights Management (DRM) module, a Zero Knowledge Proofs (ZKP) module, and an Elliptical curve-Diffie Hellman (ECDH) encryption module;
an IPFS Decentralized Storage module in operative communication with the ZTS module and having a Virtual Machine (VM) module, an IPFS Gateway module, a gateway Registry module, a Bitcoin NFT & Smart Contract IPFS module, and an OpenAI-Smart Contact Visualization module, the IPFS Gateway module in communication with a Merkle-DAGs module and a DHT module, the IPFS Decentralized Storage module in operative communication with a Content Address module and a Content Link module, the OpenAI-Smart Contact Visualization module in operative communication with a Solidity WASM module and a ChatGPT module;
a Bitcoin-NFT Tokenization module is operatively connected to the IPFS Decentralized Storage module, the Bitcoin-NFT Tokenization module having a Bitcoin Tokens module, a Bitcoin NFTs module, and an Infrastructure Finance Instruments module, a Bank & Private Loan module and a VCs and Private Investor module are operatively connected to the Bitcoin-NFT Tokenization module;
an NFT Copyright Ownership & Validation module is operatively connected to the Bitcoin-NFT Tokenization module, the NFT Copyright Ownership & Validation module having an NFT Copyright Registry module, and a Smart/Ricardian Contract module using legal prose and structured language protocols;
a WebRTC-QUIC Real Time Communications platform is in operative communication with the NFT Copyright Ownership & Validation module, the WebRTC-QUIC Real Time Communications platform having a P2P de-Net using a HTTP/3-QUIC-UDP Transport layer protocol, said P2P de-Net connecting a plurality of user devices having a DRM Application, each user device configured to receive, transmit, and store a smart contract, a video, a text document, and a photo, each user device configured to apply DRM rights restrictions selected from copy restriction, print restriction, forward restriction, expiration, and revoke access, each user device configured with SSI ID, wherein said P2P de-Net having a Blockchain module configured to provide and manage DLT, Crypto hash, SSI ID, and Smart Contracts Metadata, said P2P de_net having a DRM Server-Side Rendering module to apply, monitor, and enforce DRM restrictions on files transferred thru the P2P de-Net; and,
a Bitcoin Social Interaction Platform is in operative communication with the WebRTC-QUIC Real Time Communications platform, said Bitcoin Social Interaction Platform configured to provide access to a video, a podcast, or a live chat on said user devices.

Any of the embodiments herein may include wherein the cross-chain communication is Polkadot Blockchain, wherein said Polkadot Blockchain is configured as a blockchain platform designed to allow blockchains to exchange messages and perform transactions with each other without a trusted third-party permitting cross-chain transfers of data and assets including smart contracts between different blockchains, and said Polkadot Blockchain is configured for decentralized applications (DApps) to be built using a Polkadot Network, said Polkadot Network configured with a network protocol that allows smart contracts to be transferred across blockchains in a multi-chain application environment where cross-chain registries, cross-chain computation and transfer of smart contracts are possible, said Polkadot Network configured to unite a network of heterogeneous blockchains called parachains, said parachains connect to and are secured by a Polkadot Relay Chain.

Any of the embodiments herein may include wherein the cross-chain communication is Chainlink, wherein Chainlink is configured as a decentralized Oracle Network that provides cross-chain interoperability and enables non-blockchain enterprises to securely connect with many blockchain platforms, wherein Chainlink is a decentralized oracle network or blockchain abstraction layer that uses blockchain technology to securely enable computations on-chain and off-chain, supporting hybrid smart contracts, wherein Chain is configured wherein any Bitcoin NFT marketplace that integrates with Chainlink can access a blockchain network selected from the group consisting of Ethereum, Solana, Cardano, and Binance, wherein Chainlink blockchain is hosted on the Ethereum platform, which uses the proof-of-stake (POS) operating protocol, wherein Decentralized Oracles are entities that connect blockchains to external systems, thereby allowing smart contracts to execute based on inputs and outputs originating from the blockchain, wherein Chainlink decentralizes the process of moving smart contracts on and off blockchains through “hybrid smart contracts”.

Any of the embodiments herein may include wherein the cross-chain communication is Kusama (Cosmos), wherein Cosmos is configured as a scalable network of specialized blockchains built using Polkadot Substrates, Cosmos has an Inter-Blockchain Communication (IBC) protocol that provides ability to exchange data and token value securely and restlessly across sovereign blockchains that support IBC, wherein tokens and data (smart contracts) can be exchanged across different blockchains, wherein IBC takes siloed, Cosmos-based blockchains and combines to make an ecosystem called a Cosmos Network.

In a preferred embodiment, the invention provides a Blockchain based NFT architecture framework for Bitcoin Inscriptions, Ordinals and Smart Contracts based on a cross-chain interoperable communications network of substrates, parachains, oracles, sidechains and protocols integrated with a Zero Trust Security framework, off-chain IPFS decentralized p2p smart contract storage, Bitcoin NFT tokenization, NFT copyright ownership and validation, Open AI smart contract applications and WebRTC-UDP/QUIC secure video and messaging communications for Bitcoin NFT buyers and sellers who require privacy, confidentiality and security, all of which are needed for Bitcoin NFTs to be competitive with alternative Blockchain NFT Platforms, including Ethereum, Solana, Cardano, Flow, EOS, and Binance Smart Chain.

In a preferred embodiment, the Bitcoin NFT architecture framework facilitates the transfer of on-chain Bitcoin smart contracts to a cross-chain interoperable communications network of parachains, substrates, oracles and protocols that facilitates the transfer of on-chain Bitcoin smart contracts to permanent off-chain IPFS decentralized p2p storage whereby Bitcoin NFT buyers and sellers and authorized third parties can access the stored smart contracts at any time in the future.

In a preferred embodiment, the Bitcoin NFT architecture framework is seamlessly integrated with a Zero Trust Security Framework to provide private and secure NFT transactions between Bitcoin buyers and sellers and which uses public-key encryption, self-sovereign identity (SSI) management, zero knowledge proofs (ZKP), multiparty computation (MPC), and digital rights management (DRM), where the Zero Trust Security framework is configured to obfuscate user identities, secure Bitcoin NFT Ordinal transactions and on-chain Bitcoin smart contracts and/or Ricardian contracts, facilitate off-chain IPFS decentralized Bitcoin smart contract storage, integrate with Bitcoin NFT tokenization for collateralized NFT investments, deploy Open AI applications for Bitcoin smart contract visualization, integrate with NFT copyright ownership and validation system and seamlessly integrate with a secure video and messaging communications system using DRM for Bitcoin NFT buyers and sellers.

In another preferred embodiment for cross-chain communications, the Polkadot Blockchain is a blockchain platform designed to allow blockchains to exchange messages and perform transactions with each other without a trusted third-party. This allows for cross-chain transfers of data and assets including smart contracts between different blockchains, and for decentralized applications (DApps) to be built using the Polkadot Network. Polkadot has developed a network protocol that allows smart contracts to be transferred across blockchains which means that Polkadot is a true multi-chain application environment where cross-chain registries, cross-chain computation and transfer of smart contracts are possible. Polkadot unites a network of heterogeneous blockchains called parachains. These chains connect to and are secured by the Polkadot Relay Chain.

In another preferred embodiment for cross-chain communications, Chainlink is a decentralized Oracle Network that provides cross-chain interoperability and enables non-blockchain enterprises to securely connect with many blockchain platforms. Chainlink is known as a decentralized oracle network or blockchain abstraction layer that uses blockchain technology to securely enable computations on-chain and off-chain, supporting what are called hybrid smart contracts. Any Bitcoin NFT marketplace that integrates with Chainlink can access any major blockchain network, including Ethereum, Solana, Cardano, and Binance. The Chainlink blockchain is hosted on the Ethereum platform, which uses the proof-of-stake (POS) operating protocol. Decentralized Oracles are entities that connect blockchains to external systems, thereby allowing smart contracts to execute based on inputs and outputs originating from the blockchain. Though traditional oracles are centralized, Chainlink decentralizes the process of moving smart contracts on and off blockchains through “hybrid smart contracts”.

In another preferred embodiment for cross-chain communications, Kusama (Cosmos) is a scalable network of specialized blockchains built using Polkadot Substrates. Cosmos' flagship product, the Inter-Blockchain Communication (IBC) protocol marks the emergence of a much-anticipated interoperable Cosmos network: the ability to exchange data and token value securely and restlessly across sovereign blockchains that support IBC. That means that tokens and data (smart contracts) can be exchanged across different blockchains. IBC is what will take siloed, Cosmos-based blockchains and bring them together to make an ecosystem called the Cosmos Network.

In a preferred embodiment, NFTs are unique digital objects that exist on a blockchain. Every NFT can be differentiated from another through a 1-of-1 tokenID and its unique contract address. Metadata such as images, video files, or other data can be attached, meaning that it's possible to own a token that represents a unique digital object. Registering unique assets and freely trading them on a common decentralized platform (blockchain) has standalone value. The limitation is that the blockchain creates its value of decentralized security by disconnecting from all other systems, meaning NFT-based assets do not interface with data and systems outside the blockchain (static). Oracles can resolve this connectivity problem by allowing NFTs to interact with the outside world. The next evolution in NFTs is moving from static NFTs to dynamic NFTs-perpetual smart contracts that use oracles to communicate with and react to external data and systems. The oracle allows the NFT to use external data/systems as a mechanism for minting/burning NFTs, trading peer-to-peer, and checking state. Static NFTs are currently the most common type of NFT. However, this model is limited by the permanence of static NFTs, because the metadata attached to them is fixed once they're minted on a blockchain. Use cases such as tokenizing real-world assets, building progression-based video games, or creating blockchain-based fantasy sports leagues often require data to be updated. dNFTs offer a best-of-both-worlds approach, with NFTs retaining their unique identifiers while able to update aspects of their metadata.

In a preferred embodiment, Interplanetary File System (IPFS) is an off-chain distributed p2p system for storing and accessing files and smart contracts from any Blockchain including Bitcoin. IPFS makes this possible for not only smart contracts but also any kind of file a computer might store, whether it's a document, an email, or even a database record. Instead of being location-based, IPFS addresses a file (smart contract) by what's in it, or by its content. The content identifier is a cryptographic hash of the content at that address. The hash is unique to the content that it came from, even though it may look short compared to the original content. It also allows content owners and third parties to verify that you got what you asked for-bad actors can't just hand you content that doesn't match. Because the address of a file in IPFS is created from the content itself, links in IPFS can't be changed. For example, if the text on a smart contract page is changed, the new version gets a new, different address. The content can't be moved to a different address. There are three fundamental principles to understand IPFS: (1) Unique identification via content addressing, (2) Content linking via directed acyclic graphs (DAGs) and (3) Content discovery via distributed hash tables (DHTs).

In another preferred embodiment, the tokenization of Bitcoin NFTs for VCs, Investors, and Banks by providing collateral based NFT transactions using the Bitcoin NFT platform with an integrated Artificial Intelligence (AI) module to provide adaptive computing, intelligent agents and learning algorithms to monetize NFT assets and ownership both traded and non-traded tokens. Key benefits of tokenization include increased liquidity, faster settlement, lower costs, and bolstered risk management. Fundamentally, NFT tokenization is the process of converting rights—or a unit of NFT ownership—into a digital token on a blockchain including Bitcoin. NFT Tokenization can be applied to regulated financial instruments such as equities and bonds, and tangible assets such as real estate, precious metals, and even to NFT tokenization of copyright to works of authorship (e.g., music) and intellectual property such as patents. The benefits of tokenization are particularly apparent for NFT assets not currently traded electronically, such as works of digital art or exotic cars.

In another preferred embodiment, smart contracts and Ricardian contracts can be used interchangeably to memorialize NFT purchase agreements between Bitcoin buyers and sellers. Smart contracts are the executable programs that run on most Blockchains. Smart contracts are written using specific programming languages that compile to Blockchain bytecode (low-level machine instructions called opcodes). Not only do smart contracts serve as open-source libraries, but they are also essentially open API services that are always running and can't be taken down. Smart contracts provide public functions which users and applications (Dapps) may interact with, without needing permission. Any application may integrate with deployed smart contracts to compose functionality, such as adding data feeds or to support token swaps. Additionally, anyone can deploy new smart contracts to Blockchain to add custom functionality to meet their application's needs. The only issue with Smart Contracts is that they are not legally binding agreements, which is why, if anything goes wrong, it is hard to prove a case against fraud or scam in the court of law as it is not a legally binding agreement. The second core difference is it is not human readable as well. By contrast, a Ricardian Contract is a legal contract that is a form of digital documents that act as an agreement between two parties on the terms and condition for an interaction between the agreed parties. What makes it unique is—it is cryptographically signed and verified. Even when it is a digital document, it is available in a human-readable text that is also easy to understand for people (lawyers). It is a unique legal agreement or document that is readable for computer programs as well as humans at the same time. Ricardian contracts have two parts or serve two purposes. First, it is an easy-to-read legal contract between two or more parties. A lawyer can easily understand it, and even you can read it and understand the core terms of the Contract. Second, Ricardian contracts are the executable programs that run on most Blockchains like smart contracts.

In another preferred embodiment, Blockchain developers still struggle with the programming of smart contracts for Blockchain on-chain transaction records and for off-chain IPFS decentralized smart contract storage. This issue can be resolved with the help of Open AI for smart contracts on Bitcoin. Open AI is a natural language processing tool driven by AI technology that allows users to have human-like conversations and much more with the chatbot. The language model can answer questions and assist NFT users (and lawyers) with tasks like composing text and code for smart contracts. It uses a sequence model and was built for text production tasks including question-and-answer, text-summarization, and machine translation. Think of a smart contract assistant that will provide the appropriate smart contract code snippet for a developer if they input “What is the solidity program to obtain a loan at a Bank or a tokenized finance from a VC or institutional investor,”

In another preferred embodiment, the Copyright Ownership, Validation and Verification system has been designed to create and deploy Smart and/or Ricardian contracts that are recorded on Bitcoin, then processed off-chain in an IPFS gateway copyright registry and then stored in IPFS decentralized storage to legally validate and verify NFT digital copyright ownership between NFT buyers and sellers. The decentralized file and data sharing application ensures that the digital content would only be accessible in the application and will not be available in the end-users' operating system. Any modify or share operations performed on shared files are recorded separately to the blockchain to ensure security, integrity, and transparency.

In a final preferred embodiment, WebRTC-QUIC is a technology that enables NFT buyers and sellers to capture and stream audio, video media and messaging content between smart phone or PC browsers without requiring an intermediary. The set of standards that comprise WebRTC makes it possible to share messages and perform p2p video teleconferencing without requiring that users install plug-ins or any other third-party software. As opposed to specialized applications and hardware, WebRTC leverages a set of plugin-free APIs used in both desktop and mobile browsers to provide high-quality functional video streaming and messaging services. WebRTC-QUIC uniquely combines advanced security technologies to provide user-based permissions control when communicating and sharing rich media content with other users including End-to-End Encryption (E2EE), Digital Hash Technology (DHT), and Digital Rights Protection (DRM). It has also designed a unique cloud based streamed video storage and sharing platform service for Bitcoin NFT buyers, sellers, and businesses to view secure NFT videos including digital art, music, sports, intellectual property (IP), etc.

Provided below are eleven (11) sections describing and enabling various aspects and embodiments of the invention, namely: (i) Bitcoin Inscriptions, Ordinals and Smart Contracts; (ii) Bitcoin NFT Architecture Framework; (iii) Cross-Chain Network of Bridges, Substrates and Parachains; (iv) Bitcoin Cross-Chain NFT Communications; (v) Zero Trust Security Framework for Bitcoin NFTs; (vi) Off-Chain IPFS Decentralized Smart Contract Storage; (vii) Bitcoin NFT Tokenization; (viii) Ricardian Contracts versus Smart Contracts; (ix) Open AI Applications for Smart Contracts; (x) Bitcoin NFT Copyright Ownership using DRM Rights Protection; and (xi) WebRTC-QUIC Secure Video and Messaging Communications.

### I. Bitcoin Inscriptions, Ordinals and Smart Contracts

In December 2022, Bitcoin released open-source software called ORD that runs on top of a Bitcoin Core full node. The software allows users to encode computer files into hexadecimal data inside a Bitcoin transaction (“Inscription”) with a 4 MB size limit and “bind” that posted data to an individual Satoshi, effectively creating an NFT (“Ordinal”). Inscriptions are blobs of arbitrary data and associated metadata, the latter of which tells a Bitcoin node how to render said data (an image, digital art, intellectual property, etc.). The inscriptions are functionally like “call data” on Ethereum in that they store read-only data. Together Inscriptions and Ordinals allows Bitcoin users to now offer the sales of NFTs and the creation of on-chain smart contracts like NFTs on Ethereum and other Blockchains.

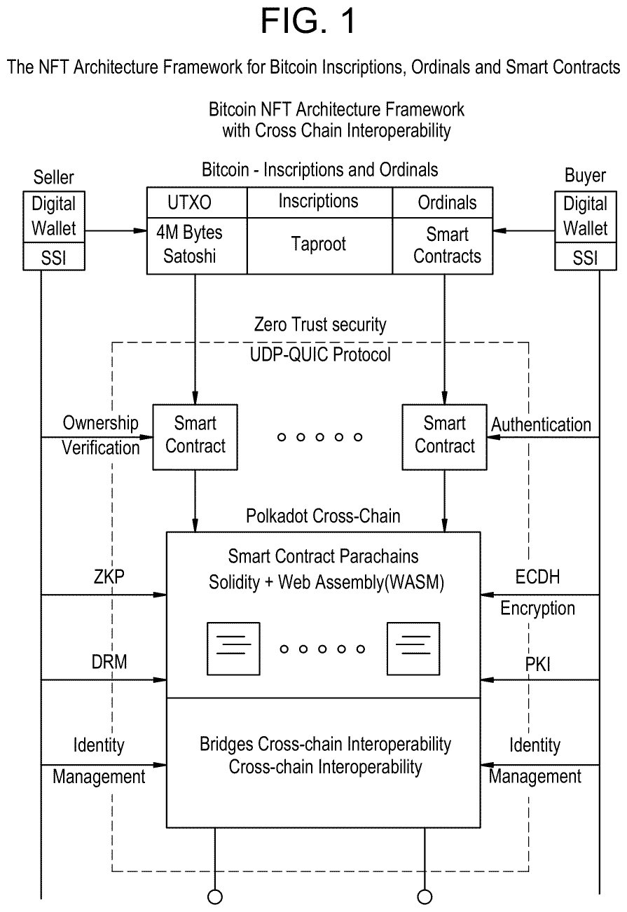

FIG. 1 illustrates the NFT Architecture Framework for Bitcoin Inscriptions, Ordinals and Smart Contracts. FIG. 1 shows a system comprising
a bitcoin-inscriptions and ordinals (BIO) module having an Unspent Transaction Output (UTXO) module, an inscriptions module, an ordinals module, a 4 MB Satoshi module, a taproot module, and a smart contracts module;
a seller module, having a seller digital wallet, configured with a self sovereign identity module, and a buyer module having a buyer digital wallet, configured with a self sovereign identity module, is operatively connected to the bitcoin-inscriptions and ordinals module;
a Zero Trust Security Platform (“ZTS Platform”) in operative communication with the BIO module using a UDP-QUIC protocol, the ZTS platform having a Smart Contract module with seller-side ownership verification and buyer-side authentication, a Cross-chain Module in communication with the Smart Contract module to provide Smart Contract parachains using Solidity & Web Assembly (WASM) code, the Cross-chain Module having a Bridges & Substrates module for cross-chain interoperability, the Cross-chain Module in operative communication with a public key encryption (PKI) module, a Self-Sovereign Identity Management (SSI) module, a Digital Rights Management (DRM) module, a Zero Knowledge Proofs (ZKP) module, and an Elliptical curve-Diffie Hellman (ECDH) encryption module;
an IPFS Decentralized Storage module in operative communication with the ZTS module and having a Virtual Machine (VM) module, an IPFS Gateway module, a gateway Registry module, a Bitcoin NFT & Smart Contract IPFS module, and an OpenAI-Smart Contact Visualization module, the IPFS Gateway module in communication with a Merkle-DAGs module and a DHT module, the IPFS Decentralized Storage module in operative communication with a Content Address module and a Content Link module, the OpenAI-Smart Contact Visualization module in operative communication with a Solidity WASM module and a ChatGPT module;
a Bitcoin-NFT Tokenization module is operatively connected to the IPFS Decentralized Storage module, the Bitcoin-NFT Tokenization module having a Bitcoin Tokens module, a Bitcoin NFTs module, and an Infrastructure Finance Instruments module, a Bank & Private Loan module and a VCs and Private Investor module are operatively connected to the Bitcoin-NFT Tokenization module;
an NFT Copyright Ownership & Validation module is operatively connected to the Bitcoin-NFT Tokenization module, the NFT Copyright Ownership & Validation module having an NFT Copyright Registry module, and a Smart/Ricardian Contract module using legal prose and structured language protocols;
a WebRTC-QUIC Real Time Communications platform is in operative communication with the NFT Copyright Ownership & Validation module, the WebRTC-QUIC Real Time Communications platform having a P2P de-Net using a HTTP/3-QUIC-UDP Transport layer protocol, said P2P de-Net connecting a plurality of user devices having a DRM Application, each user device configured to receive, transmit, and store a smart contract, a video, a text document, and a photo, each user device configured to apply DRM rights restrictions selected from copy restriction, print restriction, forward restriction, expiration, and revoke access, each user device configured with SSI ID, wherein said P2P de-Net having a Blockchain module configured to provide and manage DLT, Crypto hash, SSI ID, and Smart Contracts Metadata, said P2P de_net having a DRM Server-Side Rendering module to apply, monitor, and enforce DRM restrictions on files transferred thru the P2P de-Net; and, optionally
a Bitcoin Social Interaction Platform is in operative communication with the WebRTC-QUIC Real Time Communications platform, said Bitcoin Social Interaction Platform configured to provide access to a video, a podcast, or a live chat on said user devices.

Bitcoin recently updated Taproot and Segregated Witness (SegWit):

Taproot: The Taproot upgrade batches multiple signatures and transactions together, making it easier and faster to verify transactions on Bitcoin's network. It also scrambles transactions with single and multiple signatures together and makes it more difficult to identify transaction inputs on Bitcoin's blockchain.

Segregated Witness: SegWit refers to a change in Bitcoin's transaction format where the witness information was removed from the input field of the block. The stated purpose of Segregated Witness was to prevent non-intentional Bitcoin transaction malleability and allow for more transactions to be stored within a block. Like SegWit, the Taproot upgrade aims to improve the privacy and efficiency of the network but on a larger scale and with a potentially more significant impact expected over the years.

Smart Contract: More importantly, the Bitcoin Taproot upgrade facilitates the implementation of smart contracts, which can be used to eliminate intermediaries from transactions and open the door to decentralized finance (DeFi) for the top cryptocurrency.

In mid-2021, Bitcoin miners signaled their support for the upgrade with a 90% consensus. However, the Bitcoin Taproot upgrade date was not finalized until November 2021 and was fully activated as a soft fork of the protocol on Nov. 14, 2021. The six months between the lock-in and the activation were programmed to allow node operators and miners to fully upgrade to the latest Bitcoin Core version 21.1, which contains the Taproot upgrade.

Due to the peculiarities of both Tapscript (the scripting language used by Taproot) and Taproot which upgrades batches of multiple signatures and transactions together, it makes it easier and faster to verify transactions on Bitcoin's network. It also scrambles transactions with single and multiple signatures together and makes it more difficult to identify transaction inputs on Bitcoin's Blockchain. It shares most operations with legacy and SegWit Bitcoin Script but has a few upgrades introduced in Bitcoin's Taproot and Segregated Witness per the Bitcoin upgrade:

Inscriptions can theoretically be as large as 4 mb. The inscription data is posted to Bitcoin's blockchain as part of the witness data—the section of a transaction that stores transaction signatures, and available for decoding back into viewable content by any full archival Bitcoin node that runs the ORD software.

Ordinals are individual Satoshis (sats), which are currently the smallest Bitcoin denomination (each 1 BTC=100m Satoshis). The term ordinal comes from “Ordinals Theory,” the idea that individual Satoshis can be labeled and tracked across Bitcoin's supply (UTXO set).

UTXO Set—The function of the UTXO set is to act as a global database that shows all the spendable outputs that are available to be used in the construction of a bitcoin transaction. When a new transaction is constructed, it uses an unspent output from the UTXO set, resulting in the set shrinking. Conversely, when a new unspent output is created, the UTXO set will grow. Bitcoin full nodes are required to track all the unspent outputs in existence on the Bitcoin network to ensure a user is not attempting to spend bitcoins that have already been spent, i.e. a double-spend. A user's bitcoin balance is the sum of all the individual outputs that can be spent by their private key. Therefore, when a user initiates a transaction, the outputs from the user's UTXO set is used. All the unspent outputs must entirely be consumed when a transaction is being conducted, with change being sent back if the total value of the outputs is larger than the value of the transaction.

For example, if a user has a UTXO worth 10 bitcoins, but only requires 2 bitcoins for their transaction, then the entire 10 bitcoins is sent with two outputs being produced: Output 1 sends 2 BTC payment to the recipient and Output 2 send 8 BTC payment back to the user's wallet as change.

A transaction consumes previously recorded unspent transaction outputs and creates new transaction outputs that be used in for a future transaction. This allows bitcoins to move from one owner to another, with each transfer consuming and creating UTXOs in a chain of transactions. However, a special type of transaction known as a Coinbase transaction, does not adhere to the input and output chain. A Coinbase transaction is the first transaction a miner places in a block constructed by them; it is a transaction that rewarding the miner in bitcoins for successfully creating a block to be relayed to the network. This transaction type has no inputs, and thus, does not consume a UTXO.

If user's opt-in to this methodology, it becomes possible to see when Satoshis have been mined and in what order. Users can even apply different rarity traits to these individual sats based on various criteria (i.e., how long ago they were mined, whether they participated in a famous transaction, etc.). Recently, there are more than 250,000 inscriptions tied to individual Satoshis (Ordinals), with most of them mined before 2015. While older Satoshis are thought by many to be rare, the reality is that Bitcoin's monetary policy is such that issuance was significantly front-loaded by Satoshi (by the start of 2016, more than 15 million of the currently circulating 19.2m BTC had already been mined).

### Transaction Output

ScriptPubKey is a locking script placed on the output of a Bitcoin transaction that requires certain conditions to be met in order for a recipient to spend his/her bitcoins. Conversely, ScriptSig is the unlocking script that satisfies the conditions placed on the output by the ScriptPubKey, and thus, is what allows the bitcoins to be spent.

Using the previous example, for Bob to spend the bitcoins received from Alice, each output will contain a locking script, ScriptPubKey, which must first be satisfied by the unlocking script, ScriptSig.

To illustrate, when Alice decides to initiate her transaction with Bob, the outputs that Bob receives contain an number of bitcoins that can be spent only when the conditions laid out by the attached ScriptPubKey are satisfied. When Bob decides to spend these outputs, he will create an input that includes an unlocking script, ScriptSig, that must satisfy the conditions that Alice placed on the previous outputs before he can spend them.

### Unspendable Outputs

The Bitcoin UTXO set contains spendable outputs, however, prior to version 0.9 of the Bitcoin Core client, there are instances where the Bitcoin UTXO set contained unspendable outputs.

Unspendable outputs arose from developers using the Bitcoin transaction scripting language, Script, to create applications such as: smart contracts and digital record keeping applications. These applications created outputs that could not be spent, but were regardless still included the UTXO set. The net result of this was an ever increasing UTXO set which made it more expensive to run a Bitcoin full node; remembering that Bitcoin full nodes are required to track all outputs in the UTXO set.

However, in version 0.9 of the Bitcoin core client, a RETURN operator was implemented whereby the operator creates unspendable outputs which are not stored in the UTXO set. Although, even though RETURN outputs are no longer stored in the UTXO set, they are still recorded on the blockchain which still requires disc space.

### Bitcoin Dust

The Bitcoin Core reference implementation defines dust as an output where the fee to require to move it is greater than ⅓ its value. Put more simply, dust is low-value bitcoins wherein the transaction fee incurred in moving them is greater than the value of the bitcoins themselves.

Dust can be problematic because it is inherently uneconomical to transact with. However, by combining separate, low-value outputs, into a single more valuable, output, such a transaction becomes more viable. Some wallet providers provide the option for users to carry out this function.

### Conclusion

The Bitcoin UTXO set contains all the spendable outputs on the Bitcoin network. All outputs are discrete integer values denominated in Satoshis. Bitcoin full nodes are tasked with tracking all spendable outputs on the network to ensure no bitcoins are being double spent.

Unspendable outputs arise because of applications created using Script. Even though unspendable outputs are no longer stored in the UTXO set, they are still stored on the Bitcoin blockchain.

Low-value outputs, known as Bitcoin dust, are bitcoins that cost more to transact with than they are worth.

### II. Bitcoin NFT Architecture Framework

The patent describes a method and system to implement an NFT architecture framework to facilitate NFT-based transactions on Bitcoin deploying Inscriptions, Ordinals and Smart Contracts.

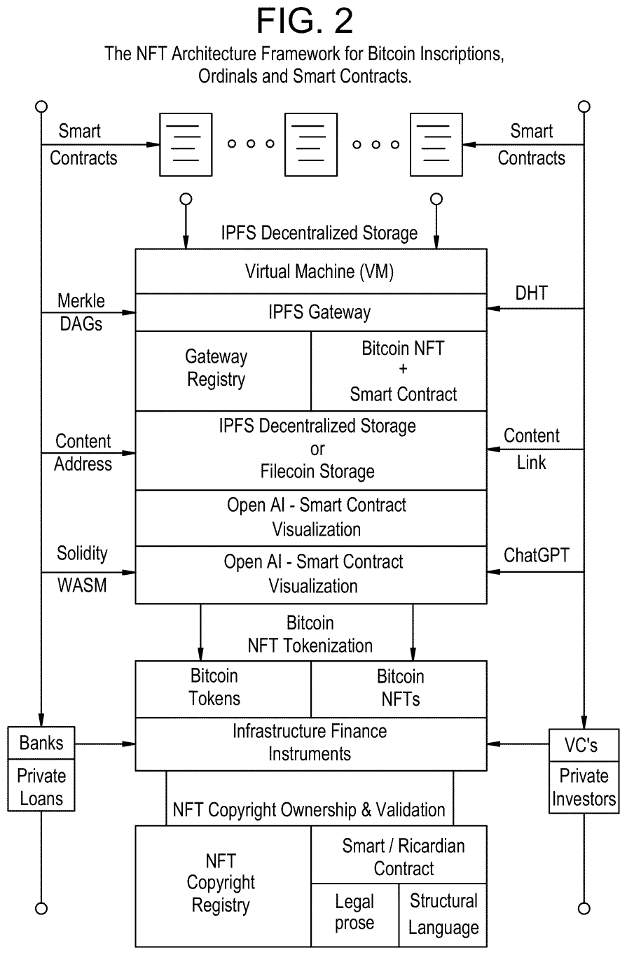

FIG. 2 illustrates the continued NFT Architecture Framework for Bitcoin Inscriptions, Ordinals and Smart Contracts. FIG. 2 shows how smart contract are in communication with an IPFS decentralized storage module. The IPFS module having a virtual machine, an IPFS gateway, a gateway registry, a bitcoin NFT and smart contract module, an IPFS decn storage or FileCoin storage module, and an Open AI-Smart Contract Visualization module. The IPFS module in communication with a Bitcoin NFT Tokenization module having bitcoin tokens, bitcoin NFTs, and infrastructure finance instruments. The Bitcoin NFT Tokenization module in communication with an NFT Copyright Ownership and Validation module having an NFT copyright registry, and a smart/Ricardian contract module. The seller in contact with the IPFS module using Merkle DAGs (IPFS Gateway), content addressing (Storage), and Solidity WASM (Open AI-SmartK Viz module). The seller in communication with a banks/private loans module that connects to the Bitcoin NFT Tokenization module. The buyer in contact with the IPFS module using DHT (IPFS Gateway), content linking (Storage), and ChatGpt (Open AI-SmartK Viz module). The buyer in communication with a VCs-private investor module connected to the Bitcoin NFT Tokenization module.

The Bitcoin NFT Blockchain architecture framework includes five main layers:
Storage Layer,
Authentication Layer,
Verification Layer,
Blockchain Layer, and
Application Layer.

The Bitcoin NFT framework also seamlessly integrates the following technologies and decentralized networks to support the Bitcoin NFT design and implementation: Polkadot's cross-chain network of bridges, substrates, parachains and smart contracts; Cross-chain interoperability; Zero Trust Security; IPFS decentralized smart contract storage; NFT Tokenization and Payment System; Ricardian Contracts (versus Smart Contracts); NFT ownership, copyright, validation, and verification; WebRTC-QUIC real time communications, and Open AI applications for smart contract visualization.

### I) Storage Layer—IPFS Decentralized Smart Contract Storage

Blockchain technology is central to the performance and operation of NFT marketplaces. They provide a permanent and immutable record and timestamp of every NFT transaction. But Blockchain was never designed to provide flexible and permanent storage for Blockchain transactional data including smart contracts and Ricardian contracts. Blockchains provide decentralization but are expensive for data storage and never allow data to be removed. For example, because of the Ethereum blockchain's current storage limits and high maintenance costs, most NFT projects' metadata is maintained off-chain. Bitcoin however does provide an off-chain storage solution for smart contracts. It was not designed to secure and obfuscate data and smart contracts off-chain within the Bitcoin system.

Blockchains like Ethereum, however do provide for off-chain decentralization but are expensive for data storage and never allow data to be removed. For example, because of the Ethereum blockchain's current storage limits and high maintenance costs, many projects' metadata is maintained off-chain. Developers utilize the ERC721 Standard, which features a method known as tokenURI. This method is implemented to let applications know the location of the metadata for a specific item. Currently, the most popular and widely used off-chain storage solution is IPFS decentralized storage.

Some of the benefits of using decentralized storage systems are: (1) Cost savings are achieved by making optimal use of current storage. (2) Multiple copies are kept on various nodes, avoiding bottlenecks on central servers, and speeding up downloads. This foundation layer implicitly provides the infrastructure required for the storage. The items on NFT platforms have unique characteristics that must be included for identification.

Non-fungible token metadata provides information that describes a particular token ID. NFT metadata is either represented on the On-chain or Off-chain. On-chain means direct incorporation of the metadata into the NFT's smart contract, which represents the tokens. On the other hand, off-chain storage means hosting the metadata separately.

InterPlanetary File System (IPFS) is a peer-to-peer hypermedia protocol for decentralized media content storage. Because of the high cost of storing media files related to NFTS on Blockchain, IPFS can be the most affordable and efficient solution. IPFS combines multiple technologies such as Block Exchange System, Distributed Hash Tables (DHT), and Version Control System. On a peer-to-peer network, DHT is used to coordinate and maintain metadata. In other words, the hash values must be mapped to the objects they represent. An IPFS generates a hash value that starts with the prefix QmQm and acts as a reference to a specific item when storing an object like a file. Objects larger than 256 KB are divided into smaller blocks up to 256 KB. Then a hash tree is used to interconnect all the blocks that are a part of the same object. IPFS uses Kamdelia DHT. The Block Exchange System, or BitSwap, is a BitTorrent-inspired system that is used to exchange blocks. It is possible to use asymmetric encryption to prevent unauthorized access to stored content on IPFS.

IPFS uses the following security technology implementations to maintain a safe and easily retrievable smart contract/Ricardian contract storage system: Content addressing with unique digital ID, Content linking using a Merkle DAG and a cryptographic hash function (SHA256), Content discovery using Distributed Hash Tables (DHT).

### 2) Authentication Layer—Decentralized Identity (DID)

The second layer is the authentication layer, which we briefly highlight its functions in this section. The Decentralized Identity (DID) approach assists users in collecting credentials from a variety of issues, such as the government, educational institutions, or employers, and saving them in a digital wallet. The verifier then uses these credentials to verify a person's validity by using a blockchain-based ledger to follow the “identity and access management (IAM)” process. Therefore, DID allows users to be in control of their identity. A lack of NFT verifiability also causes ownership and NFT copyright infringements; of course, the chain of custody may be traced back to the creator's public address to check ownership and smart contract terms and conditions using that address. However, there is no quick and foolproof way to check an NFTs creator's legitimacy. Without such verification built into the NFT, an NFT proves ownership only for the NFT itself and nothing more.

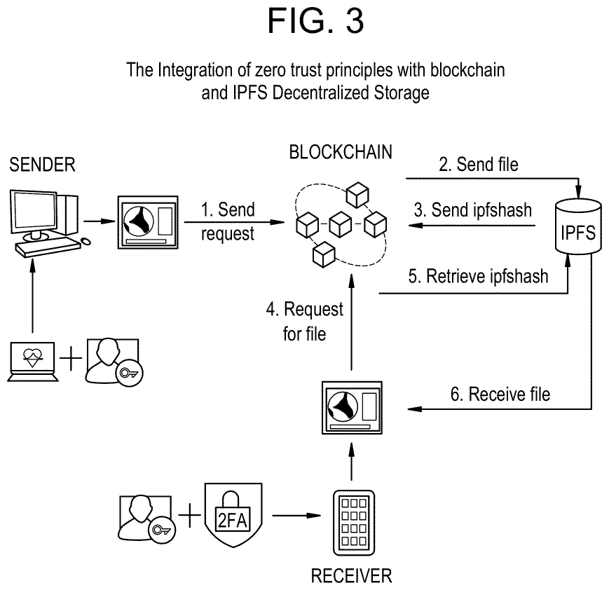

FIG. 3 illustrates the Integration of zero trust principles with blockchain and IPFS Decentralized Storage. FIG. 3 shows the steps: 1. send request, 2. send file, 3. send IPFS hash, 4. request for file, 5. retrieve ipfs hash, and 6. receive file.

### Self-Sovereign Identity Management (SSI)

Self-Sovereign Identity Management, SSI represents a novel solution comprised of a new series of standards that guide a new identity management architecture based on Web3 peer-to-peer principles. With a focus on privacy, security interoperability, SSI applications use public-key cryptography with public blockchains to generate persistent identities for people with private and selective information disclosure. Blockchain technology offers a solution to establish trust and transparency and provide a secure and publicly verifiable KYC (Know Your Customer). The blockchain architecture allows users to collect information from various service providers into a single cryptographically secure and unchanging database that does not need a third party to verify the authenticity of the information.

The authentication platform generates either smart contracts or Ricardian contracts acting as a program that runs on Blockchain to receive and send transactions. They are unalterable privately identifying clients with a thorough KYC process. After KYC approval, the NFT transaction completes the NFT minting process.

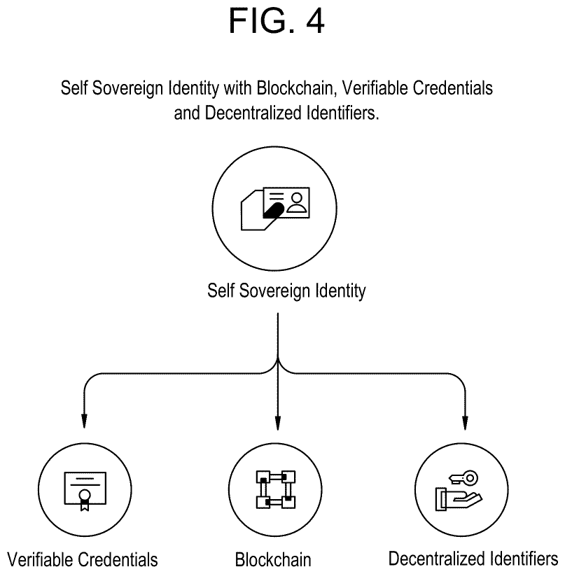

FIG. 4 illustrates the relationship between Self Sovereign Identity with Blockchain, Verifiable Credentials and Decentralized Identifiers.

### Decentralized Identity

Decentralized identity is an emerging ideology that suggests that identity data should only be held by the individual it represents. Users can generate and control their digital identities without depending on third-party service providers. Specifically, decentralized digital identity (DDID) is a decentralized system that aims to reconstruct the current centralized identity management using blockchain technology.

For example, a standard for digital credentials called Verifiable Credentials (VCs) can tokenize a user's identity to enable storing it in a non-custodial wallet. Users can release all or certain aspects of their identity and personal information to third parties, such as the government, banks, or schools, at their discretion. It will also make storing information easier in a single source. Another example is self-sovereign identities (SSI), which focus on verified and authentic credentials linked to real-world verification data managed in a decentralized way.

Decentralized identity gives users full control over their personal data online. On Web3, users from all backgrounds can express themselves and interact in new ways using tools like NFTs and blockchain. Typically, decentralized identity utilizes some forms of decentralized storage to hold an individual's decentralized identifiers (DIDs), such as a non-custodial identity wallet. It could be an app or a browser extension wallet that allows users to create their decentralized identity and manage third-party service providers' access to it. In this design, users are the sole owners of the respective public and private cryptographic keys. Some wallets would make use of other authentication methods to secure users' data. For example, self-sovereign identities (SSIs) link users' credentials to real-world verification data like biometrics and store them on the blockchain. This can also help users self-manage their digital identities without depending on third parties. More importantly, SSIs store the information within non-custodial wallets that are solely controlled by users to ensure the security of personal data. To verify identity in the metaverse, users can sign the transaction with their private key or biometric data on applications that allow using decentralized identity for authentication. The service provider would then use the decentralized identity the user shared to look for the matching unique DID on the blockchain.

### Decentralized Authentication

NFT creators can leverage decentralized identities to verify the authenticity of their work by creating verifiable credentials that prove the identity/profile of who minted the NFT and are reusable on multiple platforms. For example, an artist can mint an NFT and display it on an NFT marketplace to sell it. To claim the authorship and ensure that no one can copy their artwork and sell it, the artist can issue verifiable credentials about the NFT, including their signature, their website, the blockchain they used to mint it, and/or any attribute that proves their identity. Adding an identity layer to NFTs is beneficial for the author, the buyer, and the NFT marketplace such that:

The artist ensures no one can duplicate their work and sell it claiming that they are the original artist.

The buyer can verify that what they are buying is an authentic piece.

The NFT marketplace can become a safe environment for real, authentic individuals buying and trading NFTs on the platform.

Moreover, the NFT itself will have a robust verifiable authenticity credential that travels across different marketplaces and from one owner to another. This eliminates the need for each marketplace to attest for the authenticity when a creator lists their NFT on it.

### Fractal Decentralized Identity

Fractal is an identity verification platform, ranging from human uniqueness for sybil-resistance to KYC/AML for regulatory compliance. Artists who leverage Fractal to issue reusable verifiable credentials can claim authorship rights of their NFTs, even if it travels from one platform to another, or one owner to another. On the other hand, NFT marketplaces that integrate Fractal into their platforms can ensure that their users are unique humans, thus avoiding sybil-attacks and arbitrage while maintaining a safe and privacy-preserving environment for their users.

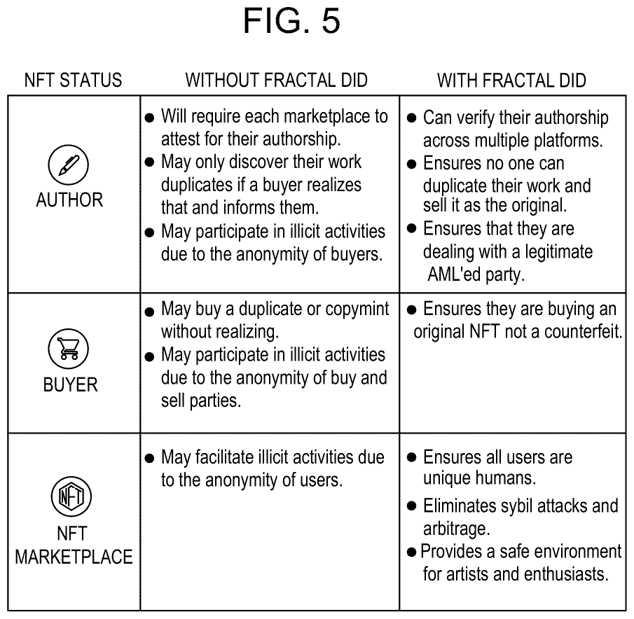

FIG. 5 illustrates Benefits of implementing Fractal decentralized identity for NFTs. FIG. 5 shows that an author can verify their authorship across multiple platforms, ensure no one can duplicate their work and sell it as original, and ensures they are dealing with a legitimate AML'ed party. FIG. 5 shows that a buyer can ensure they are buying an original and not a counterfeit. FIG. 5 shows that the NFT marketplace can ensure that all user a unique humans, elkiminate sybil attacks and arbitrage, and provide a safe environment for artists and enthusiasts.

### NFT User Registration and Login

In the registration process of the authentication protocol, the first step is to initialize a user's public key as their identity key (UserName). Second upload this identity key onto Bitcoin, in which transactions can be verified later by other users. Finally, the user generates an identity transaction.

After registration, an NFT user typically logs in to the NFT system as follows: The user upload's identity information and imports a secret key into the NFT application to log in. The user sends a login request to the NFT provider. The NFT provider analyzes the login request, extracts the hash, queries Bitcoin, and obtains identity information from an identity list (identity transactions). The NFT provider responds with an authentication request when the above process is completed. A timestamp (to avoid a replay attack), the user's UserName, and a signature are all included in the authentication request.

The user creates a digital signature with five parameters: timestamp, UserName, and PK, as well as the UserName and PK of the NFT provider. The user authentication credential can be used as the signature. The NFT provider then verifies the received information, and if the received information is valid, the authentication succeeds; otherwise, the authentication fails, and the user's login is denied.

### 3) Verification Layer

In permissioned blockchains such as Bitcoin, just identified nodes can read and write in the distributed ledger. Nodes can act in different roles and have various permissions. Therefore, a distributed system can be designed to be the identified nodes for patent granting offices.

### Digitalization

For a digital art file to be published as an NFT on Bitcoin, it must have a digitalized format. This level is the “filling step” in traditional NFT registering. An application could be designed in the application layer to allow users to enter different patent information online.

### Recording

NFTs provide valuable information and would bring financial benefits for their owner. If they are publicly published on Bitcoin network, miners may refuse the NFT and take the innovation for themselves. At least it can weaken consensus reliability and encourage miners to misbehave. The inventor should record his innovation privately first using proof of existence to prevent this. The inventor generates the hash of the NFT document and records it in Bitcoin. As soon as it is recorded in Bitcoin, the timestamp and the hash are available for others publicly. Then, the inventor can prove the existence of the patent document whenever it is needed.

Furthermore, using methods like Decision Thinking, an NFT inventor can record each phase of NFT development separately. In each stage, a user generates the hash of the finished part and publishes the hash regarding the last part's hash.

Finally, they have a couple of hashes that indicate NFT development, and they can prove the existence of each phase using the original related documents. This level should be done to prevent others from abusing the digital artwork and taking it for themselves. The creator can make sure that their NFT is recorded confidentially and immutably.

Different hash algorithms exist with different architecture, time complexity, and security considerations. Hash functions should satisfy two main requirements:

Pre-Image Resistance: This means that it should be computationally hard to find the input of a hash function while the output and the hash algorithm are known publicly.

Collision Resistance: This means that it is computationally hard to find two arbitrary inputs, x, and y, that have the same hash output. These requirements are vital for recording patents. First, the hash function should be Pre-Image Resistance to make it impossible for others to calculate the documentation. Otherwise, everybody can read the NFT. Second, the hash function should satisfy Collision Resistance to preclude users from changing their document after recording. Otherwise, users can upload another digital artwork, and after a while, they can replace it with another one.

There are various hash algorithms, and MD and SHA families are the most useful algorithms. According to, Collisions have been found for MD2, MD4, MD5, SHA-0, and SHA-1 hash functions. Hence, they cannot be a good choice for recording NFTs. SHA2 hash algorithm is secure, and no collision has been found. Although SHA2 is noticeably slower than prior hash algorithms, the recording phase is not highly time sensitive. So, it is a better choice and provides excellent security for users.

### Validation

In this phase, the inventors first create NFTs for publication and then publish it to the miners/validators. Miners are some identified nodes that validate NFTs to record in the blockchain. Due to the specialization of NFT validation, miners cannot be inexpert public persons. Therefore, the miners can be related specialist persons that are certified by Bitcoin.

Digital certificates are digital credentials used to verify networked entities' online identities. They usually include a public key as well as the owner's identification. They are issued by Certification Authorities (CAs), who must verify the certificate holder's identity. Certificates contain cryptographic keys for signing, encryption, and decryption. X.509 is a standard that defines the format of public-key certificates and is signed by a certificate authority. X.509 standard has multiple fields.

Version: This field indicates the version of the X.509 standard. X.509 contains multiple versions, and each version has a different structure. According to the CA, validators can choose their desired version.

Serial Number: It is used to distinguish a certificate from other certificates. Thus, each certificate has a unique serial number.

Signature Algorithm Identifier: This field indicates the cryptographic encryption algorithm used by a certificate authority.

Issuer Name: This field indicates the issuer's name, which is generally certificate authority.

Validity Period: Each certificate is valid for a defined period, defined as the Validity Period. This limited period partly protects certificates against exposing CA's private key. Subject Name: Name of the requester. In our framework, it is the validator's name. Subject Public Key Info: Shows the CA's or organization's public key that issued the certificate. These fields are identical among all versions of the X.509 standard.

### Public Key Infrastructure (PKI)

There are four key elements to PKI: Digital Certificates, Public and Private Keys, Certificate Authorities and Certificate Revocation List

A PKI is comprised of Certificate Authorities who issue digital certificates to parties (e.g., users of a service, service provider), who then use them to authenticate themselves in the messages they exchange in their environment. A CA's Certificate Revocation List (CRL) constitutes a reference for the certificates that are no longer valid. Revocation of a certificate can happen for several reasons. For example, a certificate may be revoked because the cryptographic private material associated with the certificate has been exposed.

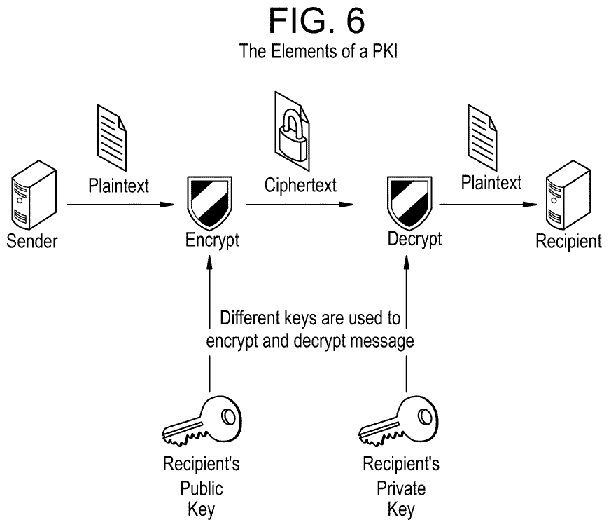

FIG. 6 illustrates the Elements of a PKI.

### Certificate Authority

A Certificate Authority (CA) issues digital certificates. CAs encrypt the certificate with their private key, which is not public, and others can decrypt the certificates containing the CA's public key.

Here, selected miners create a certificate for requested NFT. The NFT creator writes the information of the validator in their certificate and encrypts it with a private key. The validator can use the certificate to assure others about their eligibility. Other nodes can check the requesting node's information by decrypting the certificate using a public key.

Miners form a consensus about the NFT and record the NFT in the Bitcoin blockchain. After that, the NFT is recorded in the blockchain with corresponding comments in granting or needing reformations. If the miners detect the NFT as a malicious request, they do not record it in the blockchain.

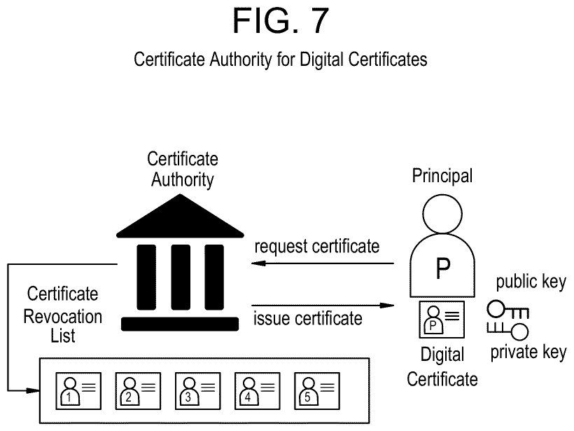

FIG. 7 illustrates Certificate Authority for Digital Certificates.

### 4) Blockchain Layer

The Blockchain layer plays as a middleware between the Verification Layer and Application Layer in the NFTs architecture. The main purpose of the blockchain layer in the architecture is to provide NFT management.

An NFT creator can use multiple blockchain platforms, including Bitcoin, Ethereum, EOS, Flow, and Tezos. Blockchain Systems can be mainly classified into two major types: Permissionless (public) and Permissioned (private) Blockchains based on their consensus mechanism. In a public blockchain, any node can participate in the peer-to-peer network, where the blockchain is fully decentralized. A node can leave the network without any consent from the other nodes in the network.

Bitcoin is one of the most popular examples that fall under the public and permissionless blockchain. Proof of Work (POW), Proof-of-Stake (POS), and directed acyclic graph (DAG) are some examples of consensus algorithms in permissionless blockchains. Bitcoin and Ethereum, two famous and trustable blockchain networks, use the PoW consensus mechanism. Blockchain platforms like Cardano and EOS adopt the POS consensus.

Nodes require specific access or permission to get network authentication in a private blockchain. Hyperledger is among the most popular private blockchains, which allow only permissioned members to join the network after authentication. This provides security to a group of entities that do not completely trust one another but wants to achieve a common objective such as exchanging information. All entities of a permissioned blockchain network can use Byzantine-fault-tolerant (BFT) consensus. The Fabric has a membership identity service that manages user IDs and verifies network participants.

Therefore, members are aware of each other's identity while maintaining privacy and secrecy because they are unaware of each other's activities. Due to their more secure nature, private blockchains have sparked a large interest in banking and financial organizations, believing that these platforms can disrupt current centralized systems. Hyperledger, Quorum, Corda, EOS are some examples of permissioned blockchains.

Reaching consensus in a distributed environment is a challenge. Blockchain is a decentralized network with no central node to observe and check all transactions. Thus, there is a need to design protocols that indicate all transactions are valid. So, the consensus algorithms are considered as the core of each blockchain. In distributed systems, consensus has become a problem in which all network members (nodes) agree on accept or reject of a block. When all network members accept the new block, it can append to the previous block.

As mentioned, the main concern in the blockchains is how to reach consensus among network members. A wide range of consensus algorithms has been designed in which each of them has its own pros and cons. Blockchain consensus algorithms are mainly classified into three groups. The first group, proof-based consensus algorithms require the nodes joining the verifying network to demonstrate their qualification to do the appending task. The second group is voting-based consensus that requires validators in the network to share their results of validating a new block or transaction before making the final decision. The third group is DAG-based consensus, a new class of consensus algorithms. These algorithms allow several different blocks to be published and recorded simultaneously on the network.

The NFT solution in Blockchain (Bitcoin) layer works by implementing the following steps:

Step 1: NFT Creators sign up to the Bitcoin platform.

Creators need to sign up on the Bitcoin platform. Identity information will be required while signing up.

Step 2: NFT Creators upload the NFT on the Bitcoin network.

The creator will upload the NFT and any related data on the Bitcoin network. Bitcoin ensures traceability and auditability to prevent data from duplicity and manipulation. The NFT becomes visible to all network members once it is uploaded to the blockchain.

Step 3: Consumers generate requests to use the content.

Consumers who want to access the content must first register on the Bitcoin network. After Signing up, consumers can ask creators to grant access to the NFT content. Before the NFT owner authorizes the request, a Smart Contract is created to allow customers to access information such as the owner's data. Furthermore, consumers are required to pay fees in either fiat money or unique tokens to use the creator's original information. When the creator approves the request, an NDA (Non-Disclosure Agreement) is produced and signed by both parties. Bitcoin manages the agreement and guarantees that all parties agree to the terms and conditions filed.

Step 4: Bitcoin Miners and Stake Holders Verify and Resolve Copyright Disputes

Blockchain assists the NFT parties in resolving a variety of disputes that may include sharing confidential information, establishing proof of authorship, transferring ownership rights, and resale conditions, etc.

### 5) Application Layer

The Bitcoin NFT tokenization and copyright ownership framework would allow investors including VCs, Banks, and individual investors to tokenize NFTs to create an infrastructure for storing NFT transactions, copyright records, smart Contract terms and conditions and Ricardian contracts on decentralized IPFS storage to enable buyers and sellers to easily sell and monetize their NFT products on the Bitcoin NFT marketplace.

Any buyer satisfied with the conditions can pay using a Bitcoin token or other predetermined crypto coin or fiat currency and immediately unlock the rights to the NFT without either party ever having to interact directly.

The aim is to record the NFT transaction onto a digital, decentralized, and secure Bitcoin network and then to store the transaction data in Smart or Ricardian contracts and the move the contracts and data off-chain to IPFS decentralized p2p storage. Smart Contracts and Ricardian contracts can be attached to NFTs so terms of use and ownership can be outlined and agreed upon without incurring as many legal fees as traditional IP transfers. This is believed to help NFT buyers secure funding, as they could more easily leverage the previously undisclosed value of their NFTs.

In conclusion, the Bitcoin based NFT architecture framework provides strong timestamping, legal Smart and Ricardian contracts, and proof-of-existence. It enables creating a transparent, distributed, cost-effective, and resilient environment that is open to all and where each transaction is auditable. The primary purpose of this Bitcoin architecture framework was to provide an NFT-based system that is secure, private, and confidential and provide decentralized, anti-tamper, and reliable Bitcoin NFT marketplace system for trade and exchange around the world.

### III. Cross Chain Network of Bridges, Substrates & Parachains

Polkadot is a blockchain platform and cryptocurrency. The native cryptocurrency for the Polkadot blockchain is the DOT. It is designed to allow blockchains to exchange messages and perform transactions with each other without a trusted third-party. This allows for cross-chain transfers of data or assets, between different blockchains, and for decentralized applications (DApps) to be built using the Polkadot Network.

Polkadot is a network protocol that allow arbitrary data including smart contracts to be transferred across blockchains. This means that Polkadot is a true multi-chain application environment where things like cross-chain registries and cross-chain computation are possible. Polkadot can transfer this data across public, open, permissionless blockchain as well as private, permissioned blockchains. This makes it possible to build applications that get permissioned data from a private blockchain and use it on a public blockchain. For example, a universities private permissioned academic records chain could send a proof to a degree-verification smart contact on a public chain. The Polkadot Relay Chain will not natively support smart contracts, however, parachains on Polkadot will support smart contracts.

Polkadot unites a network of heterogeneous blockchains called parachains and parathreads. These chains connect to and are secured by the Polkadot Relay Chain. They can also connect with external networks via bridges.

Polkadot's central chain and foundational layer is known as the Relay Chain, which constitutes the base architecture containing all the protocol's validators and authenticators staked in DOT. The Relay Chain is composed of a relatively small number of transaction types and possesses a deliberately minimal layer of functionality, for instance smart contracts are not supported on it. In fact, the main responsibility of Polkadot's Relay Chain is to coordinate and manage the ecosystem which, of course, includes parachains. Any specific work is delegated to parachains, which have differing implementations and features.

Polkadot was designed to be a Layer-0 multi-chain network, meaning that its Central Relay Chain can provide Layer-0 security and scalability for up to 100 Layer-1 blockchains connected as parachains. This is quite the groundbreaker as it enables a plethora of blockchain infrastructures to build and develop within its ecosystem, while furnishing Polkadot with a value-rich, dynamic, and ultimately interoperable network.

Relay Chain—The heart of Polkadot, responsible for the network's shared security, consensus, and cross-chain interoperability.

Parachains—Sovereign blockchains that can have their own tokens and optimize their functionality for specific use cases.

Parathreads—Like parachains but with a pay-as-you-go model. More economical for blockchains that don't need continuous connectivity to the network.

Bridges—Allow parachains and parathreads to connect and communicate with external networks like Ethereum and Bitcoin.

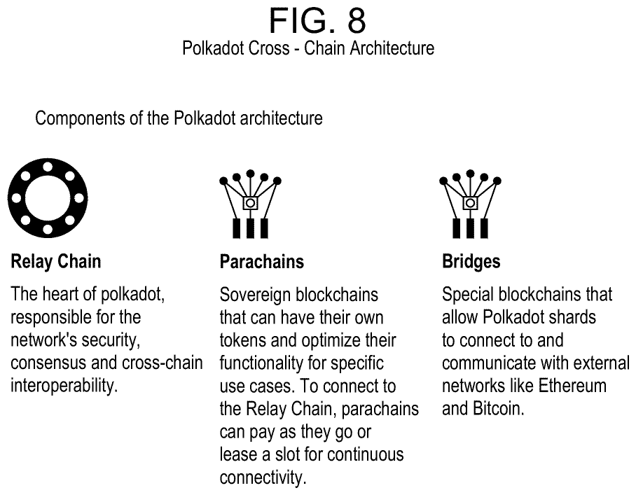

FIG. 8 illustrates Polkadot Cross-Chain Architecture.

### Substrates

Polkadot's relay chain is built with Substrate, a blockchain-building framework that is the distillation of Parity Technologies' learnings building Ethereum, Bitcoin, and enterprise blockchains. Substrate-based chains are designed to seamlessly connect to Polkadot, granting access to its system of parallel transactions, cross-chain transfers, and an expanding support network.

Polkadot's state machine is compiled to WebAssembly (Wasm), a super performant virtual environment. Wasm is developed by major companies, including Google, Apple, Microsoft, and Mozilla, that have created a large ecosystem of support for the standard.

Polkadot's networking uses libp2p, a flexible cross-platform network framework for peer-to-peer applications. Positioned to be the standard for future decentralized applications, libp2p handles the peer discovery, IPFS decentralized storage and communication in the Polkadot ecosystem.

The Polkadot runtime environment is being coded in Rust, C++, and Golang, making Polkadot accessible to a wide range of developers.

### Parachains

Parachains are specialized blockchains that connect to Polkadot. They will have characteristics specialized for their use case and the ability to control their own governance. Interactions on parachains are processed in parallel, enabling highly scalable systems. Transactions can be spread out across the chains, allowing more transactions to be processed over time.

Parachains have their own tokens, fee structures, and economic ecosystems. Bridges allow Polkadot parachains to connect to external networks like Kusama, Bitcoin and Ethereum. Platforms for building and hosting smart contract based dapps and services, with support for Wasm-VM and/or EVM.

Parachains connect to Polkadot by leasing an open slot on the Relay Chain via auction, which involves locking up a bond of DOT, Polkadots native token for the duration of the lease. DOT holders can help their favorite parachains win an auction, potentially earning a reward in return, by contributing to a crowd loan and temporarily locking their own DOT for the parachain's bond.

### Scalability

Through its parachain model, Polkadot allows projects to achieve scalability at Layer-1 rather than having to rely on Layer-2 solutions altogether. This is in fact quite the advancement as it allows for the creation of a majorly decentralised, more efficient methodology of implementing blockchain scalability. This is primarily because parachains, as Polkadot-based Layer-1 blockchains, can process transactions in parallel and spread out the workload consistently across their entire ecosystem, increasing transactional throughput and scalability as a whole.

### Interoperability

Parachains allow blockchain communities to have full control and sovereignty over their own Layer-1 blockchain while also benefitting from the possibility of engaging in free trade with other parachains and external networks. By leveraging Polkadot's cross-chain composability features, parachains can synthesise an interoperable economic infrastructure through which they can exchange assets, data, smart contract calls and off-chain oracle information such as stock price feeds or real-time market developments.

### Cross-Chain Message Passing (XCMP)

Parachains take their name from the concept of parallelised chains that run parallel to the central Relay Chain within the Polkadot ecosystem, on both the Polkadot and Kusama Networks. Due to their parallel nature, parachains are also able to parallelise transaction processing and deliver new levels of scalability to both Polkadot and Polkadot-based projects. They are fully connected to the Relay Chain and enjoy the security provided by the Polkadot framework. However, to communicate with other systems, parachains leverage a mechanism called Cross-Chain Message Passing (XCMP).

Polkadot's XCMP is a protocol that lets its otherwise isolated parachain networks send messages and data between each other in a secure and completely trustless manner. To achieve this, Polkadot deploys a simple queuing mechanism based around a Merkle tree structure to ensure trust and verification clarity. The Relay Chain validators are responsible for moving transactions on the output queue of one parachain into the input queue of the destination parachain, but only the metadata associated with this output-input process in stored as hash within the Relay Chain.

Polkadot has set a few defining parametres with regards to its architecture and main functionalities, and these are listed as follows: Cross-chain messages will not go to the Relay Chain; Cross-chain messages will be limited to a maximum size in bytes; Parachains can reject messages from other parachains; Collators routing messages between chains; Collators generate a list of output messages and will receive input messages from other parachains; When a collator produces a new block to hand off to a validator, it will aggregate the latest input queue data and process it; Validators will authenticate the proof that a parachain's block includes the processing of the expected input messages to that parachain.

Cross-Chain Message Passing (XCMP), that is the mechanism allowing data or assets to be moved between two parachains, is firstly initiated by opening a channel between the two parachains. This channel must be recognized by both the sender and the recipient parachain, and it is a one-way channel. Furthermore, a pair of parachains can have at most two channels between them, one for sending messages and another for receiving them. For the channel to be established, a deposit in DOT is required which will then be returned once the channel closes again.

Difference between a Smart Contract and a Parachain

### Layer of Abstraction

When you write a smart contract, you are creating the instructions that associate with and deploy on a specific chain address. In comparison, a runtime module is the entire logic of a chain's state transitions (what's called a state transition function).

Smart contracts must consciously implement upgradeability while parachains will have the ability to swap out their code entirely through a root command or via the governance pallet. When you build a smart contract, it will eventually be deployed to a target chain with its own environment. Parachains allow the developer to declare the environment of their own chain, even allowing others to write smart contracts for it.

### Gas Fees

Smart contracts must find a way to limit their own execution, or else full nodes are vulnerable to DOS attacks. An infinite loop in a smart contract, for example, could consume the computational resources of an entire chain, preventing others from using it. The halting problem shows that with a powerful enough language, it is impossible to know ahead of time whether or not a program will ever cease execution. Some platforms, such as Bitcoin, get around this constraint by providing a very restricted scripting language. Others, such as Ethereum, “charge” the smart contract “gas” for the rights to execute their code. If a smart contract does get into a state where execution will never halt, it eventually runs out of gas, ceases execution, and any state transition that the smart contract would have made is rolled back. Polkadot uses a weight-fee model and not a gas-metering model.

Parachains can implement arbitrarily powerful programming languages and contain no gas notion for their own native logic. This means that some functionality is easier to implement for the developer, but some constructs, such as a loop without a terminating condition, should never be implemented. Leaving certain logic, such as complex loops that could run indefinitely, to a non-smart contract layer, or even trying to eliminate it, will often be a better choice. Parachains try to be proactive, while smart contract platforms are event-driven.

### Off-Chain Smart Contract

The Polkadot relay chain itself will not support smart contracts. However, since the parachains that connect to Polkadot can support arbitrary state transitions, they can support smart off-chain smart contracts.

Substrate presently supports smart contracts out-of-the-box in two ways:

The EVM pallet offered by Frontier.

The Contracts pallet in the FRAME library for Wasm-based contracts.

### Frontier EVM Smart Contracts

Frontier is the suite of tools that enables a Substrate chain to run smart contracts natively with the same API/RPC interface, Ethereum exposes on Substrate. Ethereum addresses can also be mapped directly to and from Substrate's SS58 scheme from existing accounts.

Substrate offers a built-in contract pallet; as time goes on, more parachains will support WebAssembly (Wasam) smart contracts. Additionally, there is the EVM Pallet, which allows a parachain to implement the Ethereum Virtual Machine, thereby supporting almost direct ports of Ethereum contracts.

### Contracts Pallet for Wasm-Based Contracts

The experience of deploying to an EVM-based chain may be more familiar to developers that have written smart contracts before. However, the Contracts pallet makes some notable improvements to the design of the EVM:

Wasm. The Contracts pallet uses WebAssembly as its compilation target. Any language that compiles to Wasm can potentially be used to write smart contracts. Nevertheless, it is better to have a dedicated domain-specific language, and for that reason Parity offers the ink! language.

Deposit. Contracts must hold a deposit (named ContractDeposit) suitably large enough in order to justify their existence on-chain. A deployer needs to deposit this into the new contract on top of the ExistentialDeposit.

Caching. Contracts are cached by default and therefore means they only need to be deployed once and afterward be instantiated as many times as you want. This helps to keep the storage load on the chain down to the minimum. On top of this, when a contract is no longer being used and the existential deposit is drained, the code will be erased from storage (known as reaping).

### Ink

Ink is a domain specific language for writing smart contracts in Rust and compiles to Wasm code. There are some projects that have built projects in ink! with a decent level of complexity such as Plasm's Plasma contracts, so it is mature enough to start building interesting things. Developers can get started writing smart contracts using ink! by studying the examples that were already written. These can be used as guideposts to write more complex logic that will be deployable on smart contract parachains.

### IV. Bitcoin Cross-Chain NFT Communications

Cross-chain communications refer to the transferring of information between one or more blockchains. Cross chain communications are motivated by two requirements common in distributed systems: accessing data and accessing functionality which is available in other Blockchain or decentralized storage systems. Cross-chain communication provides a single-messaging interface for all cross-chain communication. It enables easy integration into any smart contract application with only a few lines of code, ensuring developers don't waste effort in writing custom code to integrate separately with each chain.

Cross-Chain Communications Protocol is an open-sourced standard for developers to easily build secure cross-chain services and applications. With a universal messaging interface, smart contracts can communicate across multiple blockchain networks, eliminating the need for developers to write custom code for building chain-specific integrations. It opens a new category of DeFi applications that can be built by developers for multi-chain ecosystem.

Off-Chain Consensus—Efficient off-chain consensus that provides enhanced off-chain computation protocol that reduces gas costs for users by efficiently aggregating oracle attestations from hundreds of off-chain nodes, securely validating cross-chain transactions in a tamper-proof way.

Universal interface—to build cross-chain apps using standardized interface for smart contracts to send messages to any blockchain network. With a single method call, developers can communicate across any chain linked blockchain. Data sent across blockchain networks can be encoded and decoded in any manner, providing developers a large degree of flexibility while eliminating the complexity in building chain-specific integrations.

Libp2p Cross-Platform Network—uses libp2p, a flexible cross-platform network framework for peer-to-peer applications. Positioned to be the standard for future decentralized applications, libp2p handles the peer discovery and communication in the cross-chain communications system in conjunction with IPFS p2p decentralized storage and WebRTC p2p multimedia communications.

Cross-Chain interoperability—protocols work in conjunction with a smart contract from the source chain that invokes an HTTP/3 Web Transport Messaging Protocol, which will securely send the message to the destination chain, where another Web Transport Messaging Protocol validates it and sends it to the destination smart contract.

Programmable and Secure Token Bridge—Decentralized and trust-minimized-powered by an enhanced off-chain reporting protocol, hundreds of independent oracle nodes from node providers will cryptographically sign and validate all cross-chain token transactions, mitigating any single point of failure. Compute-enabled-allows developers to build applications (e.g., SSI digital wallets) that can transfer tokens and initiate programmable actions on the destination chain, allowing development of new types of cross-chain token-based applications. Programmable Token Bridge supports both minting and burning and locking and unlocking of ERC-721 tokens.

Highly Secure with Anti-Fraud Network—Secured through an independent anti-fraud Zero Trust Security Network that proactively monitors the blockchain networks to detect issues (e.g., incorrect, or excessive funds transfer) and take preventive measures when a malicious activity is detected (e.g., halt transfer of funds) in a trust-minimized way. The Zero Trust Security Network monitors the cross-chain network for nefarious cross-chain activity and automatically pauses its services to protect users when malicious activity is detected.

Universal and chain-agnostic—A universal interface that provides the ability to transfer tokens to any integrated blockchain network across EVM and non-EVM chains, eliminating the need for developers to build separate bridges for inter-connectivity between individual chains.

Multi-Chain ecosystem—Providing developers a standardized solution for building cross-chain applications, helping expand the multi-chain ecosystem in a secure manner, thereby dramatically increasing the utility of user tokens and ability to seamlessly transfer tokens between different blockchain environments.

### Cross-Chain Communications

Solving for integration between Blockchain platforms may seem simple. One platform need only communicate with another the status of a particular data object and/or pass control. But that apparently simple suggestion reintroduces the need for messaging and data reconciliation—the very thing that blockchain so valuably eliminates. It is possible for leading Blockchain platforms to work together to develop a common standard against which each platform's engineers could design and code compatible components. However, early interest in resolving this problem collaboratively between platform providers have been stymied by two primary challenges:

First, the competitive dynamic of the respective DLT platform providers and their focus on getting to or moving beyond the first versions of their platforms makes their imminent productive collaboration unlikely.

Second, even if that collaboration were to happen, the resulting harmonization could limit further innovation.

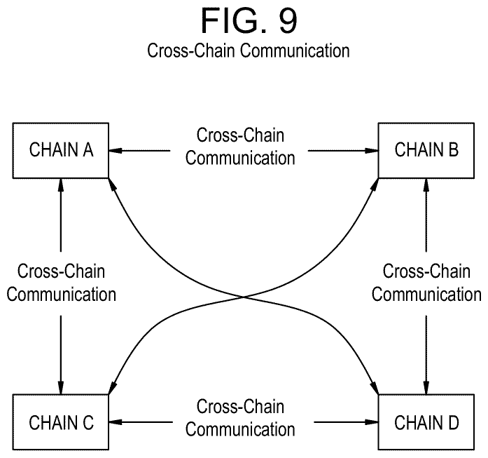

FIG. 9 illustrates Cross-Chain Communication.

The basis of Cross Chain Interoperability solution is to establish a trusted “interoperability node” that sits between the target DLT Blockchain systems. This interoperability node is given the appropriate identity and access control capabilities using “Zero Trust Security” cryptography, SSI Identity Management and UDP-QUIC Web Transport protocols.

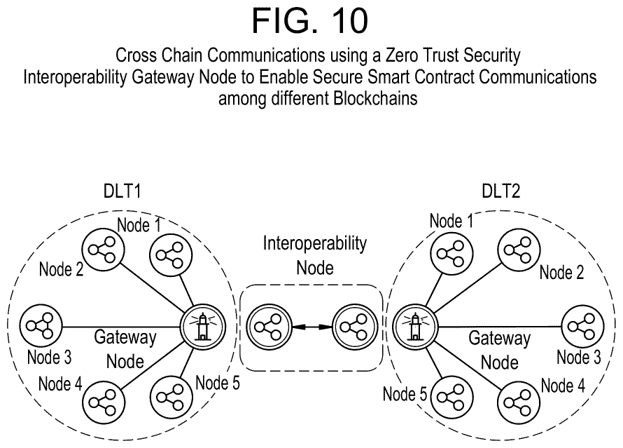

FIG. 10 illustrates Cross Chain Communications using a Zero Trust Security Interoperability Gateway Nodes to Enable Secure Smart Contract Communications among different Blockchains.

### Scalable Heterogeneous Multi-Chain

Scalable multi-chain means that unlike previous blockchain implementations which have focused on providing a single chain of varying degrees of generality over potential applications, it is designed to provide no inherent Blockchain application functionality at all. Rather, it is designed to provide the bedrock “relay-chain” upon which many validatable, globally coherent dynamic data-structures may be hosted side-by-side and are referred to as “parallelized” chains or parachains, though there is no specific need for them to be blockchain in nature. In other words, a scalable multi-chain may be considered equivalent to a set of independent chains (e.g., the set containing Ethereum, Cardano, Solana, and Bitcoin) except for two very important points: pooled security, and trust-free interchain transactability.

These points are why the multi-chain communications system is considered “scalable”. In principle, however, if many nodes are deployed on the multi-chain, it may be substantially parallelized-scaled out-over many parachains. Since all aspects of each parachain may be conducted in parallel by a different segment of the network, the system has some ability to scale. The multi-chain provides a rather bare-bones piece of infrastructure leaving much of the complexity to be addressed at the middleware level. This was a conscious decision intended to reduce development risk, enabling the requisite software to be developed within a short time span and with a good level of confidence over its security and robustness.

### Libp2p Network

Libp2p is a network framework that allows you to write decentralized peer-to-peer applications. Originally the networking protocol of IPFS, it has since been extracted to become its own first-class project. The project was created with the goal to develop an entirely decentralized stack. Additionally, Libp2p is the base for IPFS and a networking library collection that includes:
QUIC-UDP and Web Transport Protocols,

The IPFS and Ethereum blockchains serve as the foundation for the network core.

A modular and extendable abstraction layer for several networks means of transport, including UDP, Web Transport, and MQTT protocols.

Transport—At the foundation of libp2p is the transport layer, which is responsible for the actual transmission and receipt of data from one peer to another. There are many ways to send data across networks in use today, with more in development and still more yet to be designed. libp2p provides a simple interface that can be adapted to support existing and future protocols, allowing libp2p applications to operate in many different runtime and networking environments.

Identity—In a world with billions of networked devices, knowing who you're talking to is key to secure and reliable communication. libp2p uses public key cryptography as the basis of peer identity, which serves two complementary purposes. First, it gives each peer a globally unique “name”, in the form of a PeerId. Second, the PeerId allows anyone to retrieve the public key for the identified peer, which enables secure communication between peers.

Security—It's essential that we are able to send and receive data between peers securely, meaning that we can trust the identity of the peer we're communicating with and that no third-party can read our conversation or alter it in-flight. libp2p supports “upgrading” a connection provided by a transport into a securely encrypted channel. The process is flexible and can support multiple methods of encrypting communication. libp2p currently supports TLS 1.3 and Noise, though not every language implementation of libp2p supports both.

Peer Routing—When you want to send a message to another peer, you need two key pieces of information: their PeerId, and a way to locate them on the network to open a connection. There are many cases where we only have the PeerId for the peer we want to contact, and we need a way to discover their network address. Peer routing is the process of discovering peer addresses by leveraging the knowledge of other peers. In a peer routing system, a peer can either give us the address we need if they have it, or else send our inquiry to another peer who's more likely to have the answer. As we contact more and more peers, we not only increase our chances of finding the peer we're looking for, but we also build a more complete view of the network in our own routing tables, which enables us to answer routing queries from others. The current stable implementation of peer routing in libp2p uses a distributed hash table to iteratively route requests closer to the desired PeerId using the Kademlia routing algorithm.

Content Discovery—In some systems, we care less about who we're speaking with than we do about what they can offer us. For example, we may want some specific piece of data, but we don't care who we get it from since we're able to verify its integrity. libp2p provides a content routing interface for this purpose, with the primary stable implementation using the same Kademlia-based DHT as used in peer routing.

Messaging/PubSub—Sending messages to other peers is at the heart of most peer-to-peer systems, and pubsub (short for publish/subscribe) is a very useful pattern for sending a message to groups of interested receivers. libp2p defines a pubsub interface for sending messages to all peers subscribed to a given “topic”. The interface currently has two stable implementations; floodsub uses a very simple but inefficient “network flooding” strategy, and gossipsub defines an extensible gossip protocol. There is also active development in progress on episub, an extended gossipsub that is optimized for single source multicast and scenarios with a few fixed sources broadcasting to a large number of clients in a topic.

### UDP-QUIC Web Transport Protocol

The critical final ingredient of a scalable multi-chain is interchain communication. Since parachains can have some sort of information channel between them, the multi-chain communications system is designed to exchange information (i.e., documents, messages, smart contracts, videos, etc.) using WebRTC-QUIC communications where the communication among parties is as simple as a transaction executing in a parachain are able to affect the dispatch of a transaction into a second parachain or, potentially, the relay-chain. Like external transactions on production blockchains, they are fully asynchronous and there is no intrinsic ability for them to return any kind of information back to its origin. The transport protocol used in a WebRTC communications channel is based on HTTP/3-UDP-QUIC protocol and referred to as Web Transport protocol (which replaces Web Sockets).

### Blockchain Oracles

Blockchain oracles are entities that connect Blockchain to external systems, thereby enabling smart contracts to execute based upon inputs and outputs from the real worlds. Oracles provide a way for the decentralized Web3 ecosystem to access existing data sources, legacy systems, and advanced computations. Decentralized oracle networks enable the creation of hybrid smart contracts, where on-chain code and off-chain infrastructure are combined to support advanced decentralized applications (DApps) that react to real-world events and interoperate with traditional systems.

### Oracle Problem

The blockchain oracle problem outlines a fundamental limitation of smart contracts-they cannot inherently interact with data and systems existing outside their native blockchain environment. Resources external to the blockchain are considered “off-chain,” while data already stored on the blockchain is considered on-chain. By being purposely isolated from external systems, blockchains obtain their most valuable properties like strong consensus on the validity of user transactions, prevention of double-spending attacks, and mitigation of network downtime. Securely interoperating with off-chain systems from a blockchain requires an additional piece of infrastructure known as an “oracle” to bridge the two environments.

Solving the oracle problem is of the utmost importance because the vast majority of smart contract use-cases like DeFi require knowledge of real-world data and events happening off-chain. Thus, oracles expand the types of digital agreements that blockchains can support by offering a universal gateway to off-chain resources while still upholding the valuable security properties of blockchains. Because the data delivered by oracles to blockchains directly determines the outcomes of smart contracts, it is critically important that the oracle mechanism is correct if the agreement is to execute exactly as expected.

### Decentralized Oracles

Blockchain oracle mechanisms using a centralized entity to deliver data to a smart contract introduce a single point of failure, defeating the entire purpose of a decentralized blockchain application. If the single oracle goes offline, then the smart contract will not have access to the data required for execution or will execute improperly based on stale data.

Even worse, if the single oracle is corrupted, then the data being delivered on-chain may be highly incorrect and lead to smart contracts executing very wrong outcomes. This is commonly referred to as the “garbage in, garbage out” problem where bad inputs lead to bad outputs. Additionally, because blockchain transactions are automated and immutable, a smart contract outcome based on faulty data cannot be reversed, meaning user funds can be permanently lost. Therefore, centralized oracles are a non-starter for smart contract applications.

To overcome the oracle problem necessitates decentralized oracles to prevent data manipulation, inaccuracy, and downtime. A Decentralized Oracle Network, or DON for short, combines multiple independent oracle node operators and multiple reliable data sources to establish end-to-end decentralization. Even more, many DONs incorporate three layers of decentralization—at the data source, individual node operator, and oracle network levels—to eliminate any single point of failure. The Secret NFT architecture deploys a multi-layered decentralization approach, ensuring smart contracts can safely rely on data inputs during their execution.

### Types of Blockchain Oracles

Given the extensive range of off-chain resources, blockchain oracles come in many shapes and sizes. Not only do hybrid smart contracts need various types of external data and computation, but they require various mechanisms for delivery and different levels of security. Generally, each type of oracle involves some combination of fetching, validating, computing upon, and delivering data to a destination.

### Input Oracles

The most widely recognized type of oracle today is known as an “input oracle,” which fetches data from the real-world (off-chain) and delivers it onto a blockchain network for smart contract consumption. These types of oracles are used to power Secret NFTs by providing smart contracts with on-chain access to smart contract data.

### Output Oracles

The opposite of input oracles is “output oracles,” which allow smart contracts to send commands to off-chain systems that trigger them to execute certain actions. This can include telling an IPFS storage system to store the supplied data.

### Cross-Chain Oracles

Another type of oracle are cross-chain oracles that can read and write information between different blockchains. Cross-chain oracles enable interoperability for moving both data and assets between blockchains, such as using data on one blockchain to trigger an action on another or bridging assets cross-chain so they can be used outside the native blockchain they were issued on.

### Compute-Enabled Oracles

A new type of oracle becoming more widely used by smart contract applications are “compute-enabled oracles,” which use secure off-chain computation to provide decentralized services that are impractical to do on-chain due to technical, legal, or financial constraints. This can include using Keepers to automate the running of smart contracts when predefined events take place, computing zero-knowledge proofs to generate data privacy, or running a verifiable randomness function to provide a tamper-proof and provably fair source of randomness to smart contracts.

NFTs with Smart and/or Ricardian Contracts

Oracles enable non-financial use cases for smart contracts such as Private NFTs—Non-Fungible Tokens that can change in appearance, value, or distribution based on external events. Additionally, compute oracles are used to generate verifiable randomness that projects then use to assign randomized traits to NFTs or to select random lucky winners in high-demand NFT drops.

### Sidechains

Sidechains are subchains that run parallel to the mainchain. Sidechains do not contain independent nodes but instead work by connecting their nodes to the existing mainchain. Blockchain technology has scalability issues. In the case of Ethereum, only 15 transactions can be processed per second. Sidechain technology offers a solution to these issues and has already been widely used. Sidechains' greatest strength is increasing the speed of transactions. Since operations are distributed on each sidechain, processing efficiency increases, and depending on the desired use case, the necessary functions (such as speed and computational ability) are readily available. Due to these characteristics, sidechain technology is being used in a variety of commercial fields. Sidechains use consensus algorithms like PoA, PoS, DPoS, and BFT. They can easily overcome the limitations of the mainchain since they have lower fees and a faster transaction processing time. Sidechains also act as a bridge between different cryptocurrencies. The performance of various cryptocurrencies can be upgraded if sidechains are used effectively.

One of the main uses for sidechains is to exchange different blockchain tokens. There have been many attempts to connect different blockchains, such as Bitcoin and Ethereum, but creating bridges between cryptocurrencies has been the most successful thus far. Perhaps the most obvious way to connect cryptocurrencies is to modify the code of Bitcoin or Ethereum itself. However, since it is practically impossible to modify the entire code of another company's blockchain, sidechains are used.

### Sidechain Security

The sidechain construction allows the deployment of an arbitrary number of sidechains on top of existing Bitcoin-based blockchains with a single one-off change to the mainchain protocol. The design is based on an asymmetric peg between the mainchain and its sidechains. The sidechains monitor events on the mainchain, but the main blockchain is agnostic to its sidechains.

Forward transfers from mainchain to sidechain are simpler to construct than backward transfers that return assets to the mainchain. Here, the receiving chain (mainchain) cannot verify incoming backward transfers easily. The design introduces a SNARK-based proving system, where sidechains generate a proof for each given period, or Epoch, that is submitted to the mainchain together with that epoch's backward transfers. The backward transfers and the proof are grouped into a special container that structures communication with the mainchain.

The cryptographic proofs allow the mainchain to verify state transitions of the sidechain without monitoring it directly. Some modifications to the mainchain needed to enable this sidechain design are the following:

### Sidechain Transactions Commitment

A new data field called Sidechain Transactions Commitment is added to the mainchain block header. It is the root of a Merkle tree whose leaves are made up of sidechain relevant transactions contained in that specific block. Including this data in the block header allows sidechain nodes to easily synchronize and verify incoming transactions without needing to know the entire mainchain block.

### Sidechain Deployment

A special type of bootstrapping transaction is introduced in which several important parameters of the new sidechain are defined. The sidechain identifier ledger Id is set, as well as the verifying key to validate incoming withdrawal certificates. This bootstrapping transaction also describes how proof data will be provided from sidechain to mainchain with regards to the number and types of included data elements. Additionally, the length of a withdrawal epoch is defined in the bootstrapping transaction.

### Forward Transfers

A forward transfer moves assets from the mainchain to one of its sidechains. These transactions, more specifically the transaction outputs, are unspendable on the mainchain, but include some metadata so they are redeemable on one of the sidechains. It is the responsibility of sidechain nodes to monitor the mainchain for incoming transactions and include them in a sidechain block.

### Dynamic NFTs

NFTs are unique digital objects that exist on a blockchain. Every NFT can be differentiated from another through a 1-of-1 tokenID and its unique contract address. Metadata such as images, video files, or other data can be attached, meaning that it's possible to own a token that represents a unique digital object.

The most common NFT use case is currently digital art; an artist mints a token representing a digital artwork and a collector can purchase that token, marking their ownership. Once NFTs are minted, their tokenIDs don't change. Keep in mind that ascribing metadata, which incorporates an NFT's description, image, and more is completely optional. In its most bare-bones form, an NFT is simply a transferable token that has a unique tokenID.

Registering unique assets and freely trading them on a common decentralized platform (blockchain) has standalone value. The limitation is that the blockchain creates its value of decentralized security by disconnecting from all other systems, meaning NFT-based assets do not interface with data and systems outside the blockchain (static). Oracles can resolve this connectivity problem by allowing NFTs to interact with the outside world. The next evolution in NFTs is moving from static NFTs to dynamic NFTs-perpetual smart contracts that use oracles to communicate with and react to external data and systems. The oracle allows the NFT to use external data/systems as a mechanism for minting/burning NFTs, trading peer-to-peer, and checking state.

Static NFTs are currently the most common type of NFT, used for the most part by NFT art projects and play-to-earn game projects and as digital collectibles. Beyond these use cases, they also offer a unique value proposition for digitizing items in the real world, such as real estate deeds, patents, and other unique identifiers.

However, this model is limited by the permanence of static NFTs, because the metadata attached to them is fixed once they're minted on a blockchain. Use cases such as tokenizing real-world assets, building progression-based video games, or creating blockchain-based fantasy sports leagues often require data to be updated. dNFTs offer a best-of-both-worlds approach, with NFTs retaining their unique identifiers while able to update aspects of their metadata. Put simply, a dynamic NFT is an NFT that can change based on external conditions. Change in a dynamic NFT often refers to changes in the NFT's metadata triggered by a smart contract. This is done by encoding automatic changes within the NFT smart contract, which provides instructions to the underlying NFT regarding when and how its metadata should change.

An often-overlooked component of dynamic NFT (dNFT) design is how to reliably source the information and functionality needed to build a secure, fair, and automated dNFT process. Dynamic NFT metadata changes can be triggered in numerous ways based on external conditions. These conditions can exist both on and off-chain. However, blockchains are inherently unable to access off-chain data and computation.

The NFT p2p network design enables these limitations to be overcome by providing various off-chain data and computation services that can be used as inputs to trigger dNFT updates. As the dNFT ecosystem expands and NFTs become more heavily integrated with the real world, the dynamic NFT design acts as a bridge between the two disconnected worlds, enabling automated, decentralized, and engaging dNFT processes to be built.

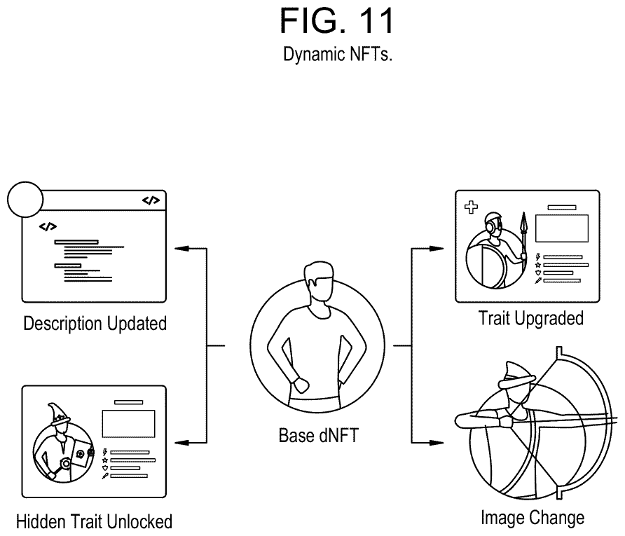

FIG. 11 illustrates Dynamic NFTs.

### Cross-Chain Smart Contract Protocols

Cross-chain Smart Contract and Ricardian Contracts are decentralized applications that are composed of multiple different smart contracts deployed across multiple different blockchain networks that interoperate to create a single unified application. This new design paradigm is a key step in the evolution of the multi-chain ecosystem and has the potential to create entirely new categories of smart contract use cases that leverage the unique benefits of different blockchains, sidechains, and layer-2 networks.

Historically, the adoption of smart contracts has largely taken place on the Ethereum mainnet due to it being the first blockchain network to support fully programmable smart contracts. Alongside its first-mover advantage, additional factors have also contributed to Ethereum's adoption, such as its growing network effect, decentralized architecture, time-tested tooling, and an extensive community of Solidity developers. However, rising demand for Ethereum smart contracts has led to an increase in network transaction fees over time, as demand for Ethereum's block space (computing resources) exceeds supply. While the Ethereum mainnet continues to provide one of the most secure networks for smart contract execution, many end-users have begun to seek lower-cost alternatives.

In response, the adoption of Smart/Ricardian contracts on alternative layer-1 blockchains, sidechains, and layer-2 rollups has rapidly increased in the past year in order to meet the needs of users and developers. The availability of new on-chain environments has increased the total aggregate throughput of the smart contract economy, leading to the onboarding of more users who are able to transact at a lower cost. Furthermore, each blockchain, sidechain, and layer-2 network offers its own approach to scalability, decentralization, mechanism design, consensus, execution, data availability, privacy, and more. In the multi-chain ecosystem, all these different approaches can be implemented and battle-tested in parallel to push forward the ecosystem's development.

The Ethereum community has embraced the multi-chain approach, as evidenced by the adoption of a rollup-centric roadmap for scaling the throughput of the Ethereum ecosystem via the deployment of various layer-2 scaling solutions. Layer-2 networks increase the transaction throughput of Ethereum-based smart contracts, resulting in lower fees per transaction while retaining the security properties of the Ethereum mainnet. This is achieved by verifying off-chain computations on the Ethereum baselayer blockchain using fraud proofs or validity proofs, and in the future, also leveraging data sharding to expand capacity for rollup calldata.

To take advantage of the multi-chain ecosystem, many developers are now increasingly deploying their existing smart contract codebase across multiple networks rather than on just one blockchain. By developing multi-chain smart contracts, projects have been able to both expand their user base and experiment with new features on lower-cost networks that would otherwise be too cost-prohibitive. The multi-chain approach has become increasingly commonplace across numerous DeFi verticals.

### V. Zero Trust Security Framework for Bitcoin NFTS

The Zero Trust Security framework was developed by the CIA and published by NIST in 2019. The following 5 steps summarize the main features of the Zero Trust architecture, and which was designed by NIST to address security issues associated with corporate and Internet of Things (IoT) networks.

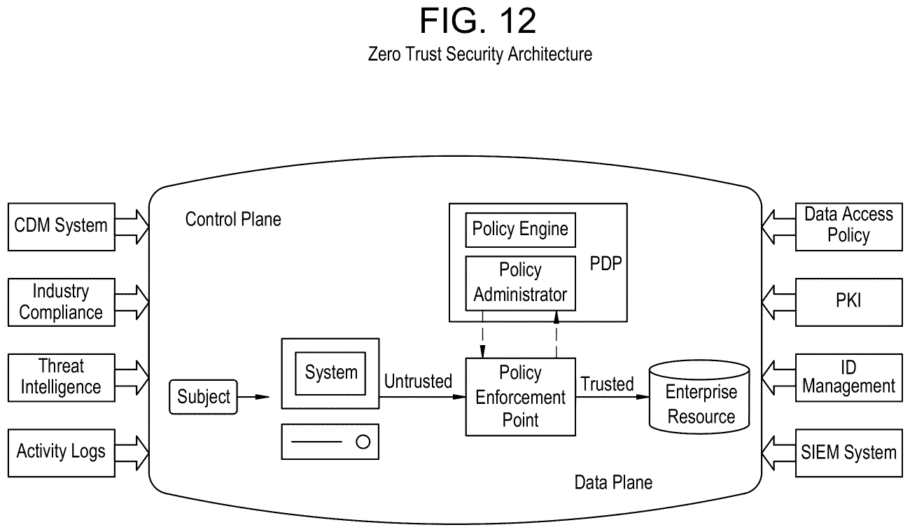

FIG. 12 illustrates a Zero Trust Security Architecture.

Step 1: Segment the network.

Traditional cybersecurity has a single boundary of trust: The edge of the enterprise network. Zero trust is more secure where users must constantly request access to areas they need to be, and if there isn't an absolute need for them to be there then security keeps them out.

Network segmentation is a key feature of ZTA. There are lots of security boundaries throughout a segmented network, and only the people who absolutely need access can get it. This is a fundamental part of zero-trust networking and eliminates the possibility that an attacker who gains access to one secure area can automatically gain access to others.

Step 2: Implement access management and identity verification.

Multi-factor authentication (MFA) is a fundamental part of good security, whether it's zero trust or not. Under a zero trust system users should be required to use at least one two-factor authentication method, and possibly different methods for different types of access.

Along with MFA, roles for employees need to be tightly controlled, and different roles should have clearly defined responsibilities that keep them restricted to certain segments of a network. The ZTA recommends using the principle of least privilege (POLP) when determining who needs access to what.

Step 3: Extend the principle of least privilege to the firewall.

Zero trust isn't concerned only with users and the assets they use to connect to a network. It's also concerned with the network traffic they generate. Best practices require that privilege should be applied to network traffic both from without and within a network.

Establish firewall rules that restrict network traffic between segments to only those absolutely needed to accomplish tasks. It's better to have to unblock a port later than to leave it open from the get-go and leave an open path for an attacker.

Step 4: Firewalls should be contextually aware of traffic.

Rules-based firewall setups aren't enough. What if a legitimate app is hijacked for nefarious purposes, or a DNS spoof sends a user to a malicious webpage?

To prevent problems like those it's essential to design firewalls to look at all inbound and outbound traffic to ensure it looks legitimate for an app's purpose as well as checking it against blacklists, DNS rules, and other data described in Figure—above.

Step 5: Gather, and analyze, security log events.

Zero trust, just like any other cybersecurity framework, requires constant analysis to find its weaknesses and determine where to reinforce its capabilities. There's a lot of data generated by cybersecurity systems and parsing it for valuable information can be difficult. Zero Trust recommends using SEIM software to do a lot of the analytics legwork, saving time on the tedious parts so IT leaders can do more planning for future attacks. Security Information and Event Management (SIEM) is a software solution that aggregates and analyzes activity from many different resources across your entire IT infrastructure. SIEM collects security data from network devices, servers, domain controllers etc.

Zero Trust Security Interworking with Bitcoin NFTs

KryptoGuard has designed a patented implementation of a Zero Trust Security Enclave applied to Bitcoin based NFTs, as summarized in FIGS. 7 and 8.

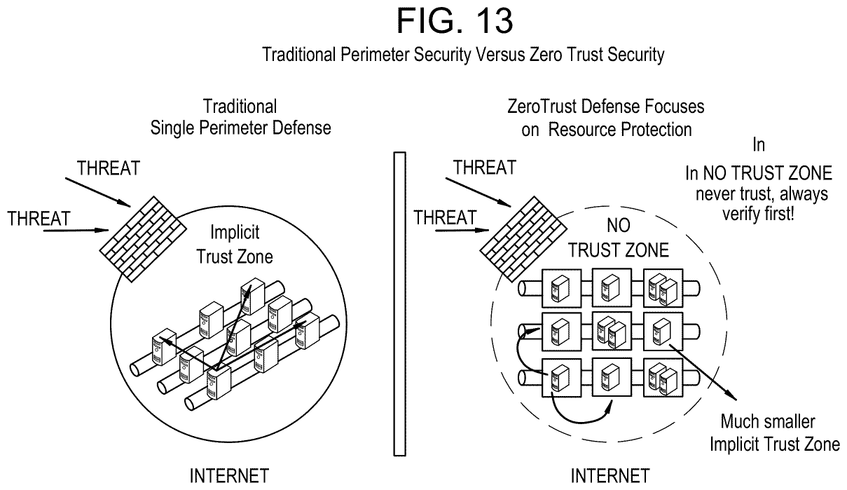

FIG. 13 illustrates Traditional Perimeter Security Versus Zero Trust Security.

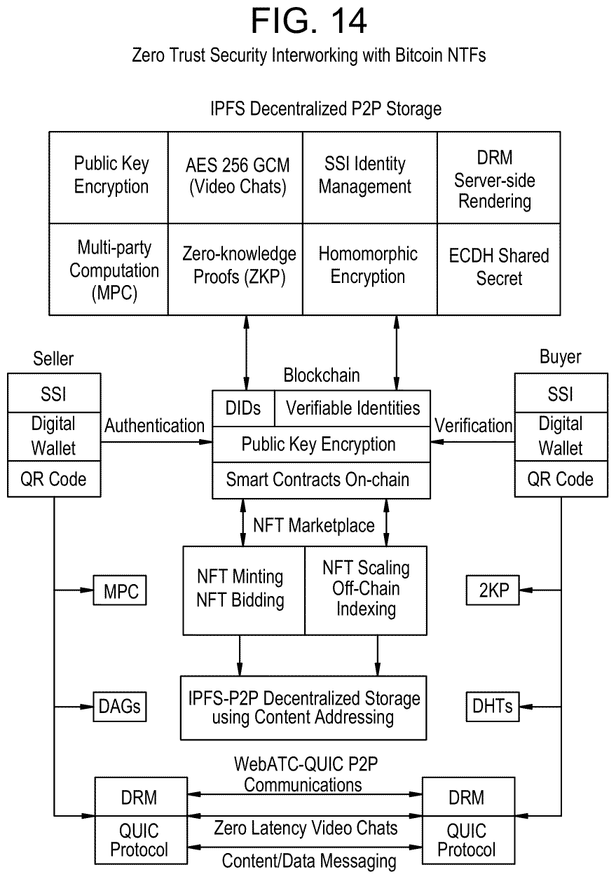

FIG. 14 shows the Zero Trust Security Interworking with Bitcoin NFTs. FIG. 14 shows a seller having an SSI, digital wallet, and QR code authenticates via a blockchain module. The blockchain module handles DIDs, verifiable identities, public key encryption, and smart contracts on-chain. The blockchain module in communication with an IPFS decentralized P2P storage module. The IPFS module having public key encryption, video chats, SSI management, DRM rendering, MPC, ZKP, HE, and ECDH share secret. The seller uses MPC and DAGs to connect through a DRM system using a QUIC protocol to a buyer. The buyer having an SSI, digital wallet, and QR code to verify via the blockchain module. The blockchain module in communication with an NFT marketplace module having NFT minting, NFT bidding, NFT scaling, and off-chain indexing. The NFT marketplace module in communication with an IPFS-P2P Decentralized Storage with Content Addressing module.

A description of the Zero Trust Security Enclave interworking with Blockchain, Secret NFTs and Web3 p2p networks including IPFS decentralized storage, WebRTC-QUIC real time multimedia communications and scalable cross chain interoperability is described below.

### Public-Key Encryption

Public-key cryptography is a cryptographic system that uses pairs of keys. Each pair consists of a public key (which may be known to others) and a private key (which may not be known by anyone except the owner). The generation of such key pairs depends on cryptographic algorithms which are based on mathematical problems termed one-way functions. Effective security requires keeping the private key private; the public key can be openly distributed without compromising security.

With public-key cryptography, robust authentication is also possible. A sender can combine a message with a private key to create a short digital signature on the message. Anyone with the sender's corresponding public key can combine that message with a claimed digital signature; if the signature matches the message, the origin of the message is verified (i.e., it must have been made by the owner of the corresponding private key).

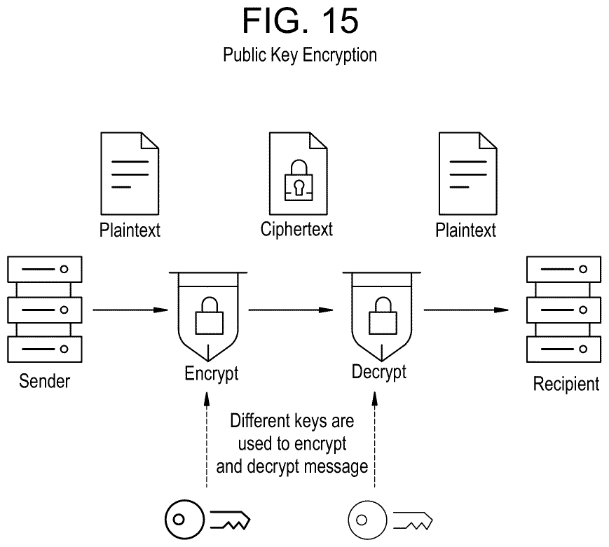

FIG. 15 shows an example of Public Key Encryption where a sender encrypts plain text using an encrypt key, is transmitted as a cipher text, is decrypted using a decrypt key to convert back to plain text for a receiver.

### Self-Sovereign Identity Management (SSI)

Self-sovereign identity (SSI) is an approach to digital identity that gives individuals control of their digital identities. SSI addresses the difficulty of establishing trust in an interaction. To be trusted, one party in an interaction will present credentials to the other parties, and those relying parties can verify that the credentials came from an issuer that they trust. In this way, the verifier's trust in the issuer is transferred to the credential holder. This basic structure of SSI with three participants is sometimes called “the trust triangle”.

Decentralized identifier documents or DIDs are a type of identifier that enables a verifiable, decentralized digital identity. They are based on the Self-sovereign identity paradigm. A DID identifies any subject (e.g., a person, organization, thing, data model, abstract entity, etc.) that the controller of the DID decides that it identifies. These identifiers are designed to enable the controller of a DID to prove control over it and to be implemented independently of any centralized registry, identity provider, or certificate authority. DIDs are URIs that associate a DID subject with a DID document allowing trustable interactions associated with that subject. Each DID document can express cryptographic material, verification methods, or service endpoints, which provide a set of mechanisms enabling a DID controller to prove control of the DID. Service endpoints enable trusted interactions associated with the DID subject. A DID document might contain semantics about the subject that it identifies. A DID document might contain the DID subject itself (e.g., a data model).

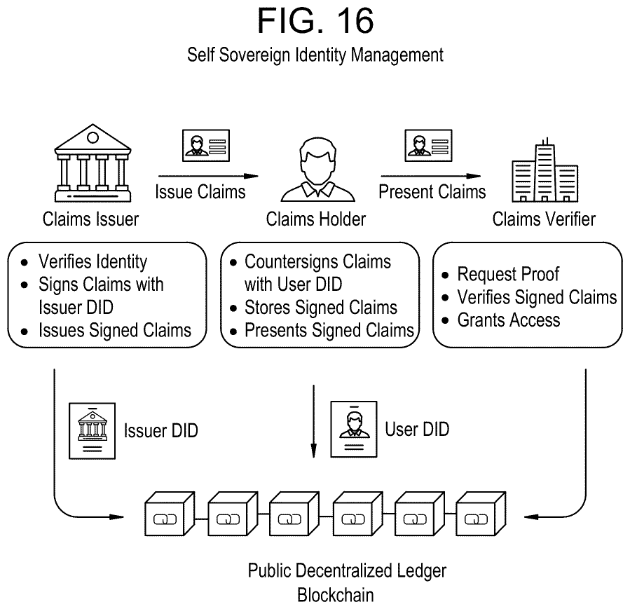

FIG. 16 shows the Self Sovereign Identity (SSI) Management process. A claim issuer sends a claim to a claims holder, who presents claims to a claims verifier. The claims issuer sends the issuer DID to a public decentralized ledger blockchain, the claims holder sends a user DID to the public decentralized ledger blockchain, and the claims verifier requests proof, verifies signed claims, and grants access when in communication with the public decentralized ledger blockchain.

### Zero Knowledge Proof (ZKP)

A Layer-2 Ethereum scaling solution provider has developed a new self-sovereign, zero-knowledge proof (ZKP) identity service called Polygon ID. The solution will enable users to verify their credentials and identity without ever revealing any personal information. ZKP performs implements authentication without passwords and protects proprietary information by sharing proofs about the data without sharing the actual data.

The concept behind zero-knowledge proof is unique indeed. A zero-knowledge proof is a unique method where a user can prove to another user that he/she knows an absolute value, without conveying any extra information. Here, the prover could prove that he knows the value z to the verifier without giving him any information other than the fact that he knows the value z.

The main essence behind this concept is to prove possession of knowledge without revealing it. The primary challenge here is to show that you know a value z without saying what z is or any other info. If a user wants to prove a statement, then he would be required to know the secret information. This way the verifier would not be able to relay the information to others without knowing the secret info. Thus, the statement will always need to include that the prover knows the knowledge, but not the information itself. Meaning, you can't say the value of z but can state that you know z. Here, z could mean anything.

This is the core strategy of zero knowledge proof applications. Otherwise, they won't be zero knowledge proof applications. That's why experts consider zero knowledge proof applications to be a special case where there isn't any chance to convey any secret information.

### Zero Knowledge Proof Properties

A zero-knowledge proof needs to have three different properties to be fully described. They are:

Completeness: If the statement is true and both users follow the rules properly, then the verifier would be convinced without any artificial help.

Soundness: In case of the statement being false, the verifier would not be convinced in any scenario. (The method is probabilistically checked to ensure that the probability of falsehood is equal to zero)

Zero-knowledge: The verifier in every case would not know any more information.

Zero knowledge encryption can be of two kinds-Interactive zero knowledge proof; Non-interactive zero knowledge proof.

### Interactive Zero Knowledge Proof

This type of zero knowledge proof authentication would require interactions between peers or any computer systems. By interacting, the prover can prove the knowledge, and the validator can validate it.

This is the most typical scenario of zero knowledge proof blockchain. Here, you would be proving without disclosing the understanding. But you are also revealing it to the user you're interacting with. So, if someone is just watching you two, he won't be able to verify your knowledge.

Although it's one of the best privacy protocols, still it requires a lot of efforts when you want to prove it to more than one people. This is because you would have to repeat the same process repeatedly to each person as just by watching they can't agree with you.

This protocol would need any kind of interactive response from the verifier to execute. Or else, the prover can never prove it on their own. The interactive input could be a form of challenge or another kind of experiments. Obviously, the process must convince the verifier about knowing the knowledge.

In other cases, the verifier could record the process and then play it for other so that they can also see it. But whether other people would be convinced or not depends solely on them. They may accept it or not.

This is why interactive zero knowledge proof blockchain is more efficient for few participants rather than a large group.

### Non-Interactive Zero Knowledge Proof

Non-interactive zero knowledge proof blockchain is here to verify one's statement to a larger group of people. You don't always have to go for the non-interactive zero knowledge proof blockchain to check though. Often, you might be able to find any trusted verifier source who can vouch for you.

But when you can't find anyone, then non-interactive zero knowledge proof blockchain is the way to go.

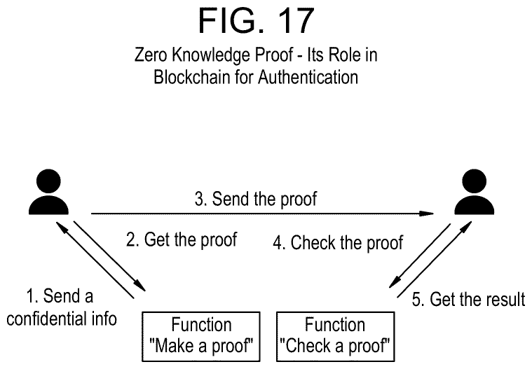

FIG. 17 shows a Zero Knowledge Proof process and its role in Blockchain for Authentication. Step 1. Send a confidential info, 2. make a proof, 3. send the proof to the receiver, 4. receiver checks the proof, and 5. obtains the result.

### Digital Rights Management-Server-Side Rendering

NFTs revolutionized the creative landscape for art, culture, music, sports, etc. But the ability to integrate and wrap this NFT tokenized representation with enciphered verification and a validation process guaranteed by the blockchain is not straight forward. That is, because these are confined to a single network and may need to use bridges to move the tokenized representations with additional verification, and that only addresses the ownership or claim. It does not guarantee “digital rights.”

A need exists for a secure digital rights management (DRM) system to be integrated into the Zero Trust Security Platform to manage, protect, and control all private messaging and multimedia communications between secret NFT patent buyers and sellers. The DRM system consists of a secure content based messaging and object sharing mobile or desktop application connected to a Web3 DRM server, that provides encryption and digital rights management of the messages, videos, content attachments, blockchain transactions, and smart contracts with the capability of rendering links to such electronic messaging objects, e.g. messages, documents, photos, video, smart contracts shared between NFT users and the ability to revoke access to the electronic messaging objects when a DRM violations occur.

In this DRM design, the application can interface with a user's contacts application and operate in both Android and iOS environments. The secure text messaging and object sharing application connects to DRM server to locate an attachment, assign DRM permissions to either the text message, the attachment, or both, store the DRM-modified electronic messaging object, and transmit an HTML link from a Sender to a Receiver. The DRM design also includes a privacy preserving cryptographic system for secure messaging and object sharing that comprises an encrypted DRM mobile messaging app, and an encrypted DRM server. The term “Server-side rendering”, or SSR, is the ability of an application to display the webpage on the server instead of rendering it in the browser. Server-side rendering (SSR) sends a fully rendered page to a client-device. In one embodiment, the SSR uses static rendering to send a fully rendered HTML to a recipient browser. In another embodiment, the SSR uses dynamic rendering to produce HTML on-demand for each URL link. In a preferred embodiment, the DRM Server dynamically selects the type of SSR depending on the type of messaging content being delivered.

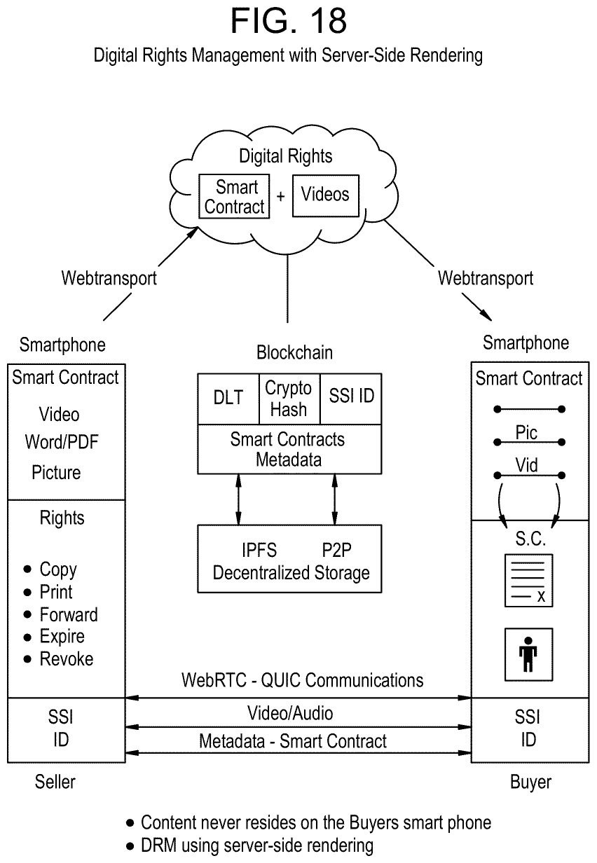

FIG. 18 shows Digital Rights Management with Server-Side Rendering. This figure shows how two users having a smartphone app according to the invention can use web transport to access cloud-based digital property, smart contracts, videos, etc. The sender can select DRM restrictions which are enforced by server-side rendering (the receiving device can view/interact but does not receive a local copy). A blockchain module handles the DLT, crypto hash, SSI ID, and smart contracts metadata as between the two users.

### Secure Multi-Party Computation (MPC)

Secure multi-party computation (also known as secure computation or privacy-preserving computation) is a subfield of cryptography with the goal of creating methods for parties to jointly compute a function over their inputs while keeping those inputs private. Unlike traditional cryptographic tasks, where cryptography assures security and integrity of communication or storage and the adversary is outside the system of participants (an eavesdropper on the sender and receiver), the cryptography in this model protects participants' privacy from each other.

In a democratic world, we rely on mechanisms in which all concerned parties are consulted and heard before important decisions are taken. Multi-Party Computation (MPC) imbibes this philosophy in which two or more parties jointly compute an output by combining their individual inputs. The combined computed output could be used for taking important actions such as executing transactions on blockchain. MPC also ensures that the private inputs of each party are kept confidential, thus adding another dimension of Zero Knowledge Proof (ZKP) as described earlier.

MPC solutions must adhere to two main principles:
Input privacy—the private data held by parties collaborating to build a combined output cannot be inferred or deduced
Correctness—the output obtained is always correct and parties should not be able to influence an incorrect output

MPC works on the assumption that all concerned parties can communicate on a secured and reliable channel. Each party exchanges an encrypted version of their private input, which undergoes computational operations to build the desired output. MPC systems also need to consider that certain parties can be dishonest (adversaries) and the implementation complexity is directly proportional to the type of adversaries (partially or fully dishonest) expected in a particular use case.

In Secure MPC, computations can be performed on data contributed by multiple parties without any individual party being able to see more than the portion of the data they contributed. This enables secure computation to be performed without the need for a trusted third party.

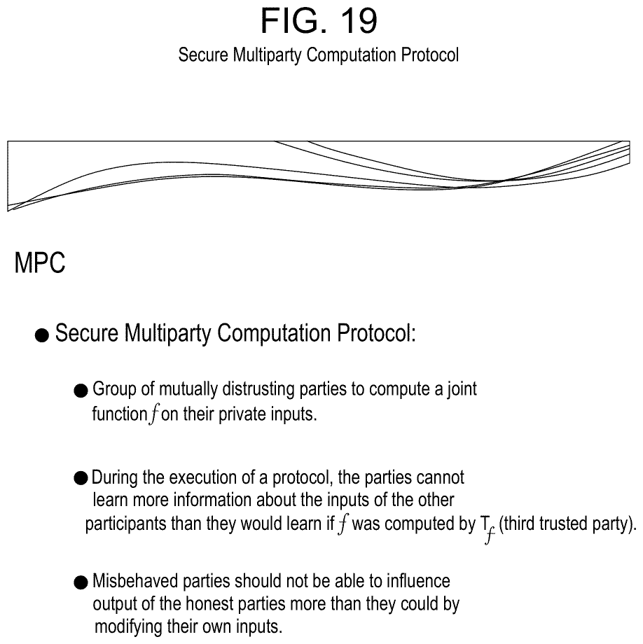

FIG. 19 show a table of Secure Multiparty Computation Protocol.

### Homomorphic Encryption

Homomorphic encryption is a form of encryption that permits users to perform computations on its encrypted data without first decrypting it. These resulting computations are left in an encrypted form which, when decrypted, result in an identical output to that produced had the operations been performed on the unencrypted data. Homomorphic encryption can be used for privacy-preserving outsourced storage and computation. This allows data to be encrypted and outsourced to commercial cloud environments for processing, all while encrypted.

For sensitive data, such as secret NFTs, homomorphic encryption can be used to enable new services by removing privacy barriers inhibiting data sharing or increase security to existing services. Moreover, even if the NFT service provider is compromised, the data would remain secure.

Homomorphic encryption is a form of encryption with an additional evaluation capability for computing over encrypted data without access to the secret key. The result of such a computation remains encrypted. Homomorphic encryption can be viewed as an extension of public-key cryptography. Homomorphic refers to homomorphism in algebra: the encryption and decryption functions can be thought of as homomorphisms between plaintext and ciphertext spaces.

Homomorphic encryption includes multiple types of encryption schemes that can perform different classes of computations over encrypted data. The computations are represented as either Boolean or arithmetic circuits. Some common types of homomorphic encryption are partially homomorphic, somewhat homomorphic, and fully homomorphic encryption.

For most homomorphic encryption schemes, the multiplicative depth of circuits is the main practical limitation in performing computations over encrypted data. Homomorphic encryption schemes are inherently malleable. In terms of malleability, homomorphic encryption schemes have weaker security properties than non-homomorphic schemes.

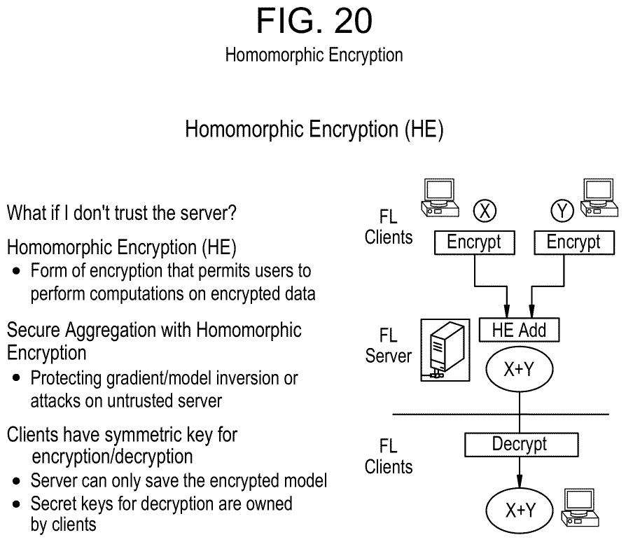

FIG. 20 shows Homomorphic Encryption as a form of encryption that permits users to perform computations on encrypted data. HE uses secure aggregation to protect against gradient/model inversion or attacks on an untrusted server. The server can save the encrypted model and the secret, symmetric keys for decryption are owned by clients.

### VI. Off-Chain IPFS Decentralized Smart Contract Storage

Interplanetary File System (IPFS) is a distributed system for storing and accessing files, websites, applications, and data. IPFS makes this possible for not only web pages but also any kind of file a computer might store, whether it's a document, an email, or even a database record. Instead of being location-based, IPFS addresses a file by what's in it, or by its content. The content identifier above is a cryptographic hash of the content at that address. The hash is unique to the content that it came from, even though it may look short compared to the original content. It also allows you to verify that you got what you asked for-bad actors can't just hand you content that doesn't match. Because the address of a file in IPFS is created from the content itself, links in IPFS can't be changed. For example, If the text on a web page is changed, the new version gets a new, different address. The content can't be moved to a different address.

Filecoin is an open-source, public cryptocurrency and digital payment system intended to be a blockchain-based cooperative digital storage and data retrieval method. It is made by Protocol Labs and shares some ideas from IPFS allowing users to rent unused hard drive space. A blockchain mechanism is used to register the deals. Filecoin is an open protocol and backed by a blockchain that records commitments made by the network's participants, with transactions made using FIL, the blockchain's native currency. The blockchain is based on both proof-of-replication and proof-of-spacetime.

### IPFS Fundamental Principles

There are three fundamental principles to understanding IPFS: Unique identification via content addressing; Content linking via directed acyclic graphs (DAGs); Content discovery via distributed hash tables (DHTs).

### Content Addressing

IPFS uses content addressing to identify content by what's in it rather than by where it's located. Every piece of content that uses the IPFS protocol has a content identifier, or CID, that is its hash. The hash is unique to the content that it came from, even though it may look short compared to the original content.

Many distributed systems use content addressing through hashes as a means for not just identifying content, but also linking it together-everything from the commits that back your code to the blockchains that run cryptocurrencies leverage this strategy. However, the underlying data structures in these systems are not necessarily interoperable.

This is where the Interplanetary Linked Data (IPLD) project comes in. IPLD translates between hash-linked data structures, allowing for the unification of the data across distributed systems. IPLD provides libraries for combining pluggable modules (parsers for each possible type of IPLD node) to resolve a path, selector, or query across many linked nodes, allowing you to explore data regardless of the underlying protocol. IPLD provides a way to translate between content-addressable data structures: “Oh, you use Git-style, no worries, I can follow those links. Oh, you use Ethereum, I got you, I can follow those links too!” IPFS follows data-structure preferences and conventions. The IPFS protocol uses those conventions and IPLD to get from raw content to an IPFS address that uniquely identifies content on the IPFS network.

### Directed Acyclic Graphs (DAGs)

IPFS and many other distributed systems take advantage of a data structure called directed acyclic graphs (opens new window), or DAGs. Specifically, they use Merkle DAGs, where each node has a unique identifier that is a hash of the node's contents. Identifying a data object (like a Merkle DAG node) by the value of its hash is content addressing.

IPFS uses a Merkle DAG that is optimized for representing directories and files, but you can structure a Merkle DAG in many ways. For example, Git uses a Merkle DAG that has many versions of your repo inside of it. To build a Merkle DAG representation of your content, IPFS often first splits it into blocks. Splitting it into blocks means that different parts of the file can come from different sources and be authenticated quickly.

With Merkle DAGs everything has a CID. Let's say you have a file, and its CID identifies it. What if that file is in a folder with several other files? Those files will have CIDs too. What about that folder's CID? It would be a hash of the CIDs from the files underneath (i.e., the folder's content). In turn, those files are made up of blocks, and each of those blocks has a CID. You can see how a file system on your computer could be represented as a DAG. You can also see how Merkle DAG graphs start to form.

Another useful feature of Merkle DAGs and breaking content into blocks is that if you have two similar files, they can share parts of the Merkle DAG, i.e., parts of different Merkle DAGs can reference the same subset of data. For example, if you update a website, only updated files receive new content addresses. Your old version and your new version can refer to the same blocks for everything else. This can make transferring versions of large datasets (such as genomics research or weather data) more efficient because you only need to transfer the parts that are new or changed, instead of creating entirely new files each time.

### Distributed Hash Tables (DHTs)

To find which peers are hosting the content you're after (discovery), IPFS uses a distributed hash table, or DHT. A hash table is a database of keys to values. A distributed hash table is one where the table is split across all the peers in a distributed network. To find content, you ask these peers.

The libp2p project (discussed later) is the part of the IPFS ecosystem that provides the DHT and handles peers connecting and talking to each other. (Note that, as with IPLD, libp2p can also be used as a tool for other distributed systems, not just IPFS.)

Once you know where your content is (or, more precisely, which peers are storing each of the blocks that make up the content you're after), you use the DHT again to find the current location of those peers (routing). So, to get to content, use libp2p to query the DHT twice.

You've discovered your content, and you've found the current location(s) of that content. Now, you need to connect to that content and get it (exchange). To request blocks from and send blocks to other peers, IPFS currently uses a module called Bitswap (opens new window). Bitswap allows you to connect to the peer or peers that have the content you want, send them your wantlist (a list of all the blocks you're interested in), and have them send you the blocks you requested. Once those blocks arrive, you can verify them by hashing their content to get CIDs and compare them to the CIDs that you requested. These CIDs also allow you to deduplicate blocks if needed. There are other content replication protocols available as well, the most developed of which is Graphsync. SHA file hashes and content IDs may be used to verify the integrity of a file by matching SHA hashes, but SHA hashes won't match CIDs. Because IPFS splits a file into blocks, each block has its own CID, including separate CIDs for any parent nodes. The DAG keeps track of all the content stored in IPFS as blocks, not files, and Merkle DAGs are self-verified structures.

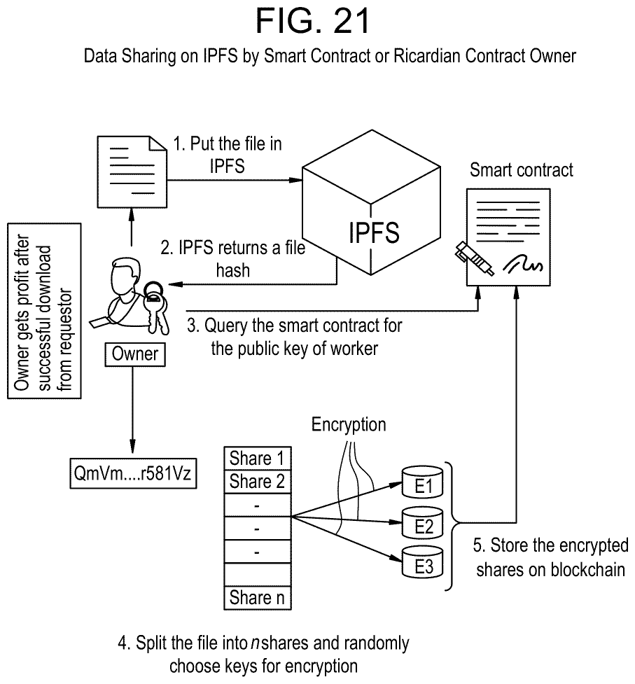

FIG. 21 shows Data Sharing on IPFS by Smart Contract or Ricardian Contract Owner. FIG. 21 shows step 1. put the file in IPFS, 2. IPFS returns a file hash, 3. query the smart contract for the public key of worker, 4. split the file into n shares and randomly choose keys for encryption, and 5. store the encrypted shares on blockchain.

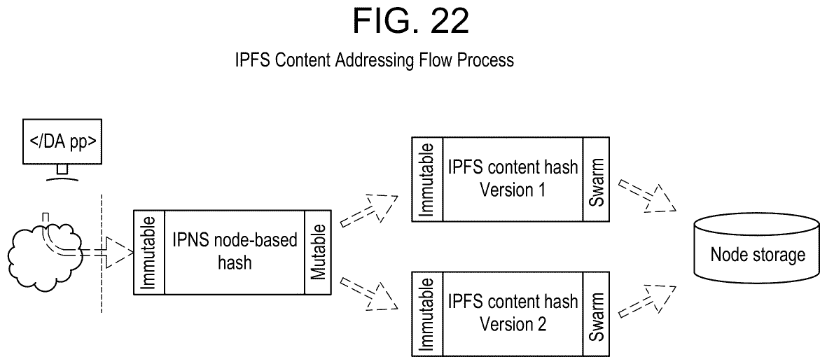

FIG. 22 shows the IPFS Content Addressing Flow Process. A DApp entry sends a cloud communication to an IPNS node-based hash to convert an immutable to a mutable configuration. Two immutable versions are created and swarm files are sent to Node storage.

### IPFS Node Network

As a protocol for peer-to-peer data storage and delivery, IPFS is a public network of Nodes participating in the network store data affiliated with globally consistent content addresses (CIDs) and advertise that they have those CIDs available for other nodes to use through publicly viewable distributed hash tables (DHTs). This paradigm is one of IPFS's core strengths—at its most basic, it's essentially a globally distributed “server” of the network's total available data, referenceable both by the content itself (those CIDs) and by the participants (the nodes) who have or want the content.

What this does mean, however, is that IPFS itself isn't explicitly protecting knowledge about CIDs and the nodes that provide or retrieve them. This isn't something unique to the distributed web; on both the d-web and the legacy web, traffic and other metadata can be monitored in ways that can infer a lot about a network and its users. Some key details on this are outlined below, but in short: While IPFS traffic between nodes is encrypted, the metadata those nodes publish to the DHT is public. Nodes announce a variety of information essential to the DHT's function—including their unique node identifiers (PeerIDs) and the CIDs of data that they're providing—and because of this, information about which nodes are retrieving and/or re-providing which CIDs is publicly available.

IPFS protocol itself explicitly does not have a privacy or security layer built in. This is in line with key principles of the protocol's modular design that is, different uses of IPFS over its lifetime may call for different approaches to privacy. Explicitly implementing an approach to privacy within the IPFS core could “box in” future builders due to a lack of modularity, flexibility, and futureproofing. On the other hand, freeing those building on IPFS to use the best privacy approach for the situation at hand ensures IPFS is useful. To address this security issue, additional measures such as disabling reproving, encrypting sensitive content, or even running a private IPFS network.

All traffic on IPFS is public, including the contents of files themselves, unless they're encrypted. For purposes of understanding IPFS privacy, this may be easiest to think about in two halves: content identifiers (CIDs) and IPFS nodes themselves.

### Content Identifiers

Because IPFS uses content addressing rather than the legacy web's method of location addressing, each piece of data stored in the IPFS network gets its own unique content identifier (CID). Copies of the data associated with that CID can be stored in any number of locations worldwide on any number of participating IPFS nodes. To make retrieving the data associated with a particular CID efficient and robust, IPFS uses a distributed hash table (DHT) to keep track of what's stored where. When you use IPFS to retrieve a particular CID, your node queries the DHT to find the closest nodes to you with that item—and by default also agrees to re-provide that CID to other nodes for a limited time until periodic “garbage collection” clears your cache of content you haven't used in a while. You can also “pin” CIDs that you want to make sure are never garbage-collected—either explicitly using IPFS's low-level pin API or implicitly using the Mutable File System (MFS)—which also means you're acting as a permanent provider of that data.

This is one of the advantages of IPFS over traditional legacy web hosting. It means retrieving files—especially popular ones that exist on lots of nodes in the network—can be faster and more bandwidth-efficient. However, it's important to note that those DHT queries happen in public. Because of this, it's possible that third parties could be monitoring this traffic to determine what CIDs are being requested, when, and by whom. As IPFS continues to grow in popularity, it's more likely that such monitoring will exist.

### Node Identifiability

The other half of the equation when considering the prospect of IPFS traffic monitoring is that nodes' unique identifiers are themselves public. Just like with CIDs, every individual IPFS node has its own public identifier (known as a PeerID).

While a long string of letters and numbers may not be a “Johnny Appleseed” level of human-readable specificity, your PeerID is still a long-lived, unique identifier for your node. Keep in mind that it's possible to do a DHT lookup on your PeerID and, particularly if your node is regularly running from the same location (like your home), find your IP address. It's possible to reset your PeerID if necessary, but similarly to changing your user ID on legacy web apps and services, is likely to involve extra effort. Additionally, longer-term monitoring of the public IPFS network could yield information about what CIDs your node is requesting and/or re-providing and when.

### IPFS Security

If there are situations in which a user needs to remain private but still want to use IPFS, one of the approaches outlined below will work.

### Controlled Sharing

By default, an IPFS node announces to the rest of the network that it is willing to share every CID in its cache (in other words, reproviding content that it's retrieved from other nodes), as well as CIDs that you've explicitly pinned or added to MFS to make them consistently available. If you′d like to disable this behavior, you can do so in the reprovider settings (opens new window) of your node's config file. Changing your reprovider settings to “pinned” or “roots” will keep your node from announcing itself as a provider of non-pinned CIDs that are in your cache—so you can still use pinning to provide other nodes with content that you care about and want to make sure continues to be available over IPFS.

### IPFS Gateway

Using a IPFS gateway is one way to request IPFS-hosted content without revealing any information about your local node-because you aren't using a local node. However, this method does keep you from enjoying all the benefits of being a full participant in the IPFS network.

IPFS gateways are primarily intended as a “bridge” between the legacy web and the distributed web; they allow ordinary web clients to request IPFS-hosted content via HTTP. That's great for backward compatibility, but if you only request content through public gateways rather than directly over IPFS, you're not actually part of the IPFS network; that gateway is the network participant acting on your behalf. It's also important to remember that gateway operators could be collecting their own private metrics, which could include tracking the IP addresses that use a gateway and correlating those with what CIDs are requested. Additionally, content requested through a gateway is visible on the public DHT, although it's not possible to know who requested it.

### IPFS Encryption

There are two types of encryptions in a network: transport-encryption and content-encryption.

TLS—Transport-encryption is used when sending data between two parties. Transport Layer Security (TLS) is a cryptographic protocol designed to provide communications security over a computer network. The protocol has been widely used in applications such as email, instant messaging, and voice over IP, but its use in securing HTTPS remains the most publicly visible. The TLS protocol aims primarily to provide cryptography, including privacy (confidentiality), integrity, and authenticity through the use of certificates, between two or more communicating computer applications. It runs in the application layer and is itself composed of two layers: the TLS record and the TLS handshake protocols.

UDP-QUIC—QUIC (QUIC-UDP Internet Connections) is a new transport protocol for the internet, developed by Google. QUIC solves a number of transport-layer and application-layer problems experienced by modern web applications, while requiring little or no change from application writers. QUIC is very similar to TCP+TLS+HTTP/2 but implemented on top of UDP. Having QUIC as a self-contained userspace protocol allows innovations which aren't possible with existing protocols as they are hampered by legacy clients and middleboxes. Key advantages of QUIC over TCP+TLS+HTTP/2 include: Connection establishment latency; Improved congestion control; Multiplexing without head-of-line blocking; Forward error correction; Connection migration

Content encryption—is used to secure data until someone needs to access it. In cryptography, encryption is the process of encoding information. This process converts the original representation of the information, known as plaintext, into an alternative form known as ciphertext. Ideally, only authorized parties can decipher a ciphertext back to plaintext and access the original information. Encryption does not itself prevent interference but denies the intelligible content to a would-be interceptor. Modern encryption schemes use the concepts of public-key and symmetric-key. Modern encryption techniques ensure security because modern computers are inefficient at cracking the encryption.

IPFS uses transport encryption or UDP-QUIC but not content encryption. This means that the data source is secure when being sent from one IPFS node to another. However, anyone can download and view that data or smart contract if they have a CID. The lack of content encryption is an intentional decision. Instead of forcing the user to deploy a specific encryption protocol, the user is free to choose whichever method is best for the security of the project. This modular design keeps IPFS lightweight and free of vendor lock-in.

If your privacy concerns are less about the potential for monitoring and more about the visibility of the IPFS-provided content itself, this can be mitigated simply by encrypting the content before adding it to the IPFS network. While traffic involving the encrypted content could still be tracked, the data represented by encrypted content's CIDs remains unreadable by anyone without the ability to decrypt it. The Zero Trust Security Platform always deploys advanced encryption to the content either 256 AES symmetric key encryption (approved by the NSA) or RSA Asymmetric Encryption Algorithm.

### IPFS Design for Secure File Sharing and Decentralized Storage of Smart Contracts

The Blockchain-IPFS architecture design and workflow for decentralized file sharing consisting of: A File Processing and Text Editor Application (dApp), Ethereum Blockchain, Smart Contracts used to govern, manage, and provide traceability into stored and shared content, IPFS decentralized storage system, File security using AES-256 symmetrical encryption and Elliptical Curve Digital Signature (ECDA), Encrypted files stored on IPFS which can only be accessed by the file editor.

The file and data sharing application ensures that the digital content would only be accessible in the application and will not be available in the end-users' operating system. Any modify or share operations performed on shared files are recorded separately to the blockchain to ensure security, integrity, and transparency.

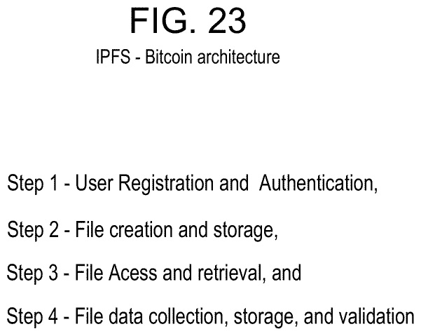

FIG. 23—illustrates the IPFS-Bitcoin workflow, a 4-step process for securing and sharing smart contracts and data files.

### The Bitcoin-IPFS Workflow Process

The Bitcoin-IPFS system workflow shows the interworking system components and process of the IPFS file storage and sharing architecture. Users first register to the File Processing application. The registration details of the user are added to the Ethereum blockchain by the application. After creation of the file in the application's inbuilt text processing and editor application, users can decide if the file should be shared or made public. If the file is supposed to be shared, the file owner provides the public key of recipients with whom the file should be shared with. The application then deploys a smart contract which stores the file metadata. It then encrypts the document and adds to IPFS in an encrypted format. To access the files, users are required to use the file sharing application since the file would be decrypted only in the application editor. The application uses the file smart contract to access the file metadata, fetches the file from IPFS, decrypts the file and opens in the file processing and editor application. To collect data and files, a user log calls to functions of smart contracts to request the files or data performed in the application editor. After an operation is performed, a permanent record is generated which is then uploaded to the network and securely stored in Bitcoin.

The IPFS-Bitcoin architecture can be divided into four main steps or phases:

### IPFS-Bitcoin Architecture

Step 1—User Registration and Authentication,
Step 2—File creation and storage,
Step 3—File Access and retrieval, and
Step 4—File data collection, storage, and validation

A more detailed discussion of the 4-step workflow process for IPFS data and file sharing interworking with Web3 is described below.

### Step 1—User Registration and Authentication

Users are required to register to the system to have a unique identity. Every user is required to create a smart contract which will act as a unique identity for them. The Metadata smart contract acts as a gatekeeper to generates a smart contract for every user after their registration. During the registration process, each user provides a registration key in the form of a string as an input to the application. Using this registration key and a current timestamp, the application generates public-private key pair using Elliptical Curve Digital Signature Algorithm (ECDSA). The Metadata deploys a smart contract of the registered user and obtains address of the deployed smart contract. The deployed user's smart contract contains user's Metadata which includes user's public key, registration key, an array of information regarding the files which have been shared with the user.

The Metadata also contains a mapping of every registered user's public key to the address of their deployed smart contract. After the deployment of the user's smart contract, the received deployed address of the user's smart contract is added to the mapping in the Metadata's smart contract. The public key generated during the registration process is used by the file owner while specifying the recipient to whom the file will be shared with. The registration key and private key will be used to validate the user authenticity during the login process of the file processing and sharing application. For authentication, user will provide registration which includes public and private key as an input to the file sharing application. The registration key is encrypted using private key. Using the received public key as an input, user's smart contract deployed address can be fetched from the Metadata's mapping. As the user's smart contract is fetched from the obtained address, to validate the user, the application sends the Encrypted Registration Key to the encryption validation function of the user's smart contract. The Encrypted Registration Key is then decrypted using public key of the user, and if resulting string is same as registration key of the user's smart contract, then user will be validated otherwise the authentication would fail.

### Step 2—File Creation and Storage

The owner creates a file in the application editor and requests a selected file for sharing on the File Processing application. The application creates a random key to encrypt the file using AES-256 symmetric key encryption. This random key will be the ‘Secret Key’ for any given file which will only reside in owner's File Processing application. The application then encrypts the file with the Secret Key. This encrypted file is added to the IPFS network. IPFS network returns hash of the uploaded file. As shown in Step 2, a smart contract is created for every deployed file on IPFS. The metadata smart contract acts as a factory to generate smart contracts for every file shared on the application. File's smart contract contains metadata which includes filename, IPFS address of the encrypted file and owner's public key. After deployment of the smart contract, the shared file application will receive the deployed file smart contract's address. Now, the file owner can specify the following types of access control for the specified file:

Shared File: In this access control, the owner can share the file with other users by using the public key of the user that they want to share the file with. After giving this public key to the File application as an input, the application will encrypt the secret key of the file with public key of the user with whom the file is to be shared with to create an ‘Encryption Key’. This is asymmetric encryption, whereas the ‘Encryption Key’ can only be decrypted by the user who has corresponding Private Key. The Smart contract of the file, for shared mode contains a mapping of the receiver user's public key to the Encryption Key of the file. This mapping will be added to the shared file's smart contract. The files Metadata will access the user's Metadata to obtain the deployed address of receiver's user smart contract. The shared files smart contract address will be added to the receiver's user smart contract. Thus, the receiver user smart contract now will contain an array of deployed address of all the files which are shared with them.

Public: In this access control, the owner can share the file to every user who is registered on the file sharing application. The owner will specify the Secret Key in the file's smart contract. The owner will send their public key along with deployed file smart contract's address to the Metadata smart contract. After these specifications are sent to the file's smart contract, other users will be able to access it if they are authorized of the File Sharing application.

### Step 3—File Access and Retrieval

On the file sharing application interface, after giving user's logging details such as registration key, public key and private key, the application will retrieve the user's deployed smart contract using Metadata smart contract. If user is validated, then file sharing application will now access the user's smart contract using the Metadata. The user smart contract contains the address of deployed smart contracts of all files shared with them. These files will appear on the application interface as ‘my fileshares’. The Application interface will also retrieve all files which are publicly shared using Metadata smart contract. The following mechanisms are performed for the access control types:

Shared File: Using the file's deployed smart contract address, the file sharing application will retrieve the key available in the mapping of the public key to encrypted key using the user's own public key. The received key will then be decrypted by user's private key in the application, and the generated key will be used to decrypt the accessed files by the file sharing application.

Public: Using the file deployed smart contract address, the file sharing application will request the decryption key of the file from corresponding file's smart contract deployed on blockchain. This key will be internally sent to the application and file share will decrypt the file and open in the application editor. The file accessed will be available to read for a session where session time would be a defined parameter. Also, the file can be modified in file share application, which will be redeployed in application along with original owner's public key attached to it. The uploaded content can only be accessed by using the application editor. The content cannot be downloaded nor be copied to clipboard of operating system from the editor.

Step 4—IPFS Process Validation and Integration with Web3 Applications

The IPFS validation process for the file and editing application consists of the following:

React.js is an open-source front-end JavaScript library for building user interfaces based on UI components and is used for the front end and interfaces with the Web3 client UI and Web3 servers, Solidity—is an object-oriented programming language for writing smart contracts and is used for developing Smart Contracts, Web3.js—is a collection of libraries that allow users to interact with local or remote Ethereum nodes and is used to interact with Ethereum nodes using an HTTP connection.

### Filecoin

Filecoin combines the benefits of content-addressed data leveraged by IPFS with blockchain-powered storage guarantees. The network offers robust and resilient distributed storage at massively lower cost compared to current centralized alternatives.

Developers choose Filecoin because it: is the world's largest distributed storage network, without centralized servers or authority; offers on-chain proofs to verify and authenticate data; is highly compatible with IPFS and content addressing; is the only decentralized storage network with petabyte-scale capacity; stores data at extremely low cost (and keeps it that way for the long term).

### Filecoin and IPFS

How do Filecoin and IPFS work together? They are complementary protocols for storing and sharing data in the distributed web. Both systems are open-source and share many building blocks, including content addressing (CIDs) and network protocols (libp2p).

IPFS does not include built-in mechanisms to incentivize the storage of data for other people. To persist IPFS data, you must either run your own IPFS node or pay a provider.

This is where Filecoin comes in. Filecoin adds an incentive layer to content-addressed data. Storage deals are recorded on-chain, and providers must submit proofs of storage to the network over time. Payments, penalties, and block rewards are all enforced by the decentralized protocol.

Filecoin and IPFS are designed as separate layers to give developers more choice and modularity, but many tools are available for combining their benefits. This diagram illustrates how these tools (often called storage helpers) provide developer-friendly APIs for storing on IPFS, Filecoin, or both.

Filecoin and IPFS are complementary protocols for storing and sharing data in the distributed web. Both systems are free, open-source, and share many building blocks, including data representation formats (IPLD) and network communication protocols (libp2p).

IPFS allows users to store and transfer verifiable, content-addressed data in a peer-to-peer network. It is great for getting started using content addressing for all sorts of distributed web applications.

IPFS alone does not include a built-in mechanism to incentivize the storage of data for other people. Built on top of IPFS, Filecoin is the distributed storage network to add longer term data persistence via on-chain storage deals, along with built-in economic incentives to ensure files are stored reliably over time. However, the processes of storing, verifying, and retrieving data are computationally expensive and can take time. Therefore, many solutions (called storage helpers) combine the two networks to get the best of both worlds: IPFS for content addressing & data discovery, and Filecoin for longer-term persistence.

### VII. Bitcoin NFT Tokenization

This Section describes the tokenization of Bitcoin NFT transactions using a NFT Platform design described herein comprising a Bitcoin NFT platform with an integrated Artificial Intelligence (AI) module to provide adaptive computing, intelligent agents and learning algorithms to monetize NFT assets both traded and non-traded. Key benefits of tokenization include increased liquidity, faster settlement, lower costs, and bolstered risk management.

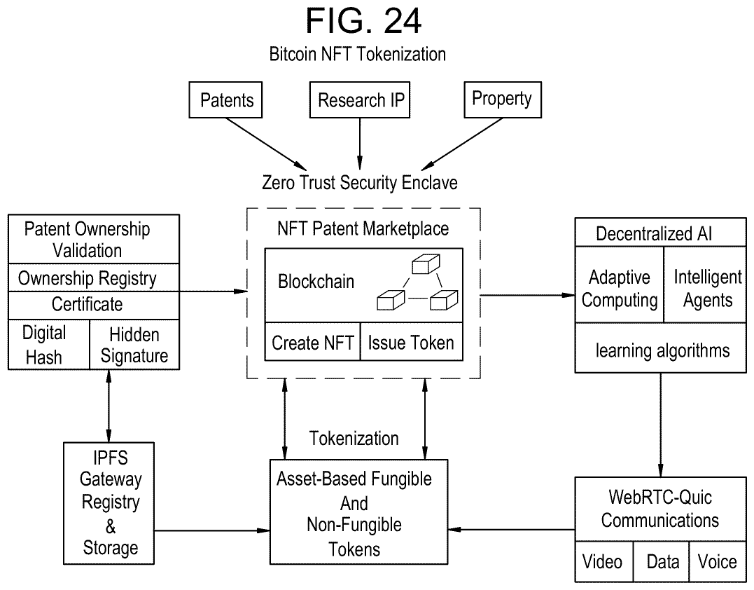

FIG. 24 illustrates Bitcoin NFT Tokenization. FIG. 24 shows patents, research IP, property being submitted to a Zero Trust Security Enclave. The Enclave includes an NFT Marketplace with blockchain, a create NFT module, and an issue token module. An ownership module validates ownership using an ownership registry to check the digital hash and hidden signature of a certificate. A decentralized AI module provides adaptive computing, intelligent agents, and learning algorithms, such as Open AI, ChatGpt, and so forth. An IPFS module provides gateway, registry and storage functions. A tokenization modules handles asset-based fungible and non-fungible tokens. And a communication modules uses WebRTC-QUIC for video, data, and voice communications.

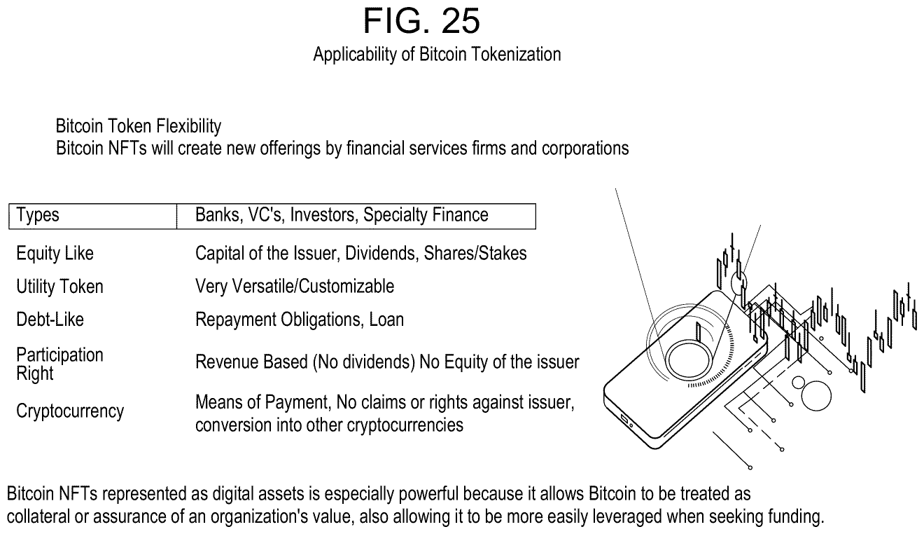

FIG. 25 illustrates the Applicability of Bitcoin Tokenization. FIG. 25 shows Bitcoin Token flexibility.

Capital markets are still in the early phases of the adoption of Blockchain, Bitcoin, and distributed ledger technologies (DLT) and the industry continues to seek viable use cases. One broad category of such use cases is the creation of digitally tokenized assets, in which the token either represents a property interest that exists only in the Blockchain (such as non-certificated securities) or represents an asset existing off the Blockchain. The tokenization of real-world assets continues to gain momentum, and investments are being made across the industry.

### Tokenization of NFTs for VCs, Investors and Banks for Collateral Based Bitcoin Based NFT Transactions

While not new to the blockchain world, the tokenization of real-world assets is now attracting industry attention. Fundamentally, tokenization is the process of converting rights—or a unit of asset ownership—into a digital token on a blockchain. Tokenization can be applied to regulated financial instruments such as equities and bonds, tangible assets such as real estate, precious metals, and even to Tokenization of Copyright to works of authorship (e.g., music) and intellectual property such as patents. The benefits of tokenization are particularly apparent for assets not currently traded electronically, such as works of art or exotic cars.

While not new to the blockchain world, the tokenization of real-world assets is now attracting industry attention. Fundamentally, tokenization is the process of converting rights—or a unit of assets not currently traded electronically, such as works of art or exotic cars, as well as those needing increased transparency in payment and data flows to improve their liquidity and tradability.

The tokenization of physical assets brings a range of benefits to market participants:

Broader investor base: There is a limit to the level of fractionalization possible with real-world assets. Selling 1/20 of an apartment or a fraction of a company share is not currently practicable. However, if that asset is tokenized, this limitation is removed, and it becomes possible to buy or sell tokens representing fractions of ownership, allowing a far broader investor base to participate. A good example of how tokenization could change the dynamic of numerous assets is in the fine art market. The prohibitive prices that some artists command at auction means that only a highly restricted number of high-net-worth individuals have the means to invest in this asset, with most retail investors unable to participate. Issuing tokens that represent fractional ownership of an artwork may fundamentally change the situation. For example, the property rights in the most valuable painting by Jean-Michel Basquiat—sold for an eyewatering $110 million by Sotheby's in 2017—could be tokenized, affording even small retail investors the opportunity to acquire a fractional interest in the painting. Tokenization would therefore open the market to a whole new set of investors, now able to diversify their investment portfolios into asset classes previously well out of their reach.

Broader geographic reach: Public blockchains are inherently global in nature because they present no external barrier to the global population and investor. However, in the Institutional Market, relevant KYC (Know Your Client) and AML (Anti-Money Laundering) laws and programs must be followed, and hence the broader adoption of public blockchains has been curbed. Nonetheless, several public blockchains are now performing KYC and AML—and this evolution and trust is expanding the footprint of these digital, Tokenized assets. Importantly, permissioned blockchains are also evolving, providing an important step for the Institutional investor.

Decreased cost for reconciliation in securities trading: The Bitcoin infrastructure provides a digital ledger for the record keeping of each shareholder position. For the issuer, this will greatly improve the efficiency of numerous administrative processes, such as profit sharing, voting rights distribution, buy-backs, and so on. Further, the existence of a secondary market will also facilitate the accounting operations of professional investors, such as net-asset-value calculations. As the market becomes more comfortable with the digital ledger as the “golden copy” of data, reconciliation may be completely obviated, as the parties will rely on and accept this record.

Regulatory evolution: There is a slow but steady movement by regulators in developed markets to lay the foundation of regulatory frameworks for the creation and exchange of digital asset tokens. Importantly, the real-time data and immutability of data held in a digital ledger will enhance the role that regulators aim to improve—clarity and protection for investors.

Improved asset-liability management: Tokenization will improve the ability to manage asset-liability risk through accelerated transactions and improved transparency.

Increase in available collateral: By accelerating and improving the fractionalization of new asset classes, tokenization will expand the range of available and acceptable collateral beyond traditional assets. This will significantly increase the options available to market participants when selecting non-cash assets as collateral in the securities lending or repo markets. Coupled with the holistic benefits of Tokenization described above, collateral management globally may be more efficient, transparent, and relevant in new asset classes.

Tokenization has potential to improve investment management.

Reduced settlement times: Tokenization can reduce transaction times, potentially by permitting 24×7 trading, and as smart contracts triggered by predefined parameters can instantaneously complete transactions, reduce settlement times from the current durations, at best T+2, to essentially real-time transactions. This can reduce counterparty risk during the transaction and reduce the possibility of trade breaks.

Infrastructure upgrade: For many asset classes, fundraising and trading remain slow, laborious, and require an exchange of paper-based documents. By digitizing these assets on a DLT infrastructure, efficiency in these markets can be vastly improved, with effects further amplified in areas that currently have non-existent traditional infrastructure.

Decreased cost for reconciliation in crypto trading: The Bitcoin infrastructure provides a digital ledger for the record keeping of each shareholder position. For the issuer, this will greatly improve the efficiency of numerous administrative processes, such as profit sharing, voting rights distribution, buy-backs, and so on. Further, the existence of a secondary market will also facilitate the accounting operations of professional investors, such as net-asset-value calculations and as the market becomes more comfortable with the digital ledger.

### IP Tokenization Process

Tokenization is the process of taking traditional NFT assets (like digital art and real estate) and dividing them into digital tokens that can be traded on a blockchain. This makes it easier for people to invest in and trade such assets and helps create a more liquid market.

In essence, tokenization is the process of converting asset ownership rights into digital tokens on a blockchain and can be used to tokenize several things, including:

In essence, tokenization is the process of converting asset ownership rights into digital tokens on a blockchain and can be used to tokenize several things, including: Tangible assets like precious metals, real estate, art and more; Intangible assets such as intellectual property rights; and Regulated financial instruments like bonds and equities.

In the context of Bitcoin NFTs, tokenization refers to the fractionalization (dividing the into smaller parts) through tokens stored on a Bitcoin. This way, investors can directly own a piece of a token's underlying real-world asset or intangible asset without having to purchase or manage the entire property.

Tokenization can help make investing in patents more accessible and liquid. Rather than purchasing an entire IP, investors can now buy tokens representing a portion of the property. This makes it easier for people to invest and helps create a more liquid market.

### Benefits of Bitcoin Tokenization

Tokenization has the potential to revolutionize the way we invest and trade assets by making it easier and more accessible for everyone, especially for small businesses and individuals who own Bitcoin. For example, tokenization can help with:

### Liquidity

The conversion of NFTs into “Bitcoin tokens” implies that a direct investment in an NFT property is treated as an indirect one. This allows issuers to secure higher liquidity, as the number of buyers is not limited to those who can afford the entire asset. In addition, tokenization also allows for fractional ownership, opening investment opportunities to a larger pool of potential investors.

### Transparency

The use of blockchain technology brings a new level of transparency. Since data is stored on a decentralized ledger, all transactions are visible to everyone on the network. Completed transactions can no longer be changed, manipulated, or canceled, in turn creating a more secure and trustworthy system. This increased transparency helps to build trust and confidence in the market and reduce fraudulent activity.

### Automation

The use of Ricardian contracts can help to automate several processes involved in NFT transactions, such as ownership transfers, document verification, dividend payments and compliance. This can help make the process more efficient and streamlined, saving time and money for all parties involved.

### Accessibility

Tokenization removes current limitations on the fractionalization of assets, making it possible for a wider investor base to participate. Barriers to entry are removed since assets once available only to a select and privileged few can now be accessed by a larger number of people. This increased accessibility helps to democratize the market and level the playing field.

### Reducing Geographic Constraints

The global nature of public blockchains facilitates the tokenization of assets, making them available to investors anywhere in the world. This helps break down geographic boundaries and connect global markets. For example, an IP asset in New York can now be tokenized and made available to investors in Japan, and vice versa, provided the participating blockchain complies with relevant Know Your Client and Anti-Money Laundering laws.

### VIII. Ricardian Contracts Versus Smart Contracts

Kryptoguard has designed a system and method to legally validate and verify NFT digital copyright ownership between buyers and sellers by deploying Bitcoin based Ricardian contracts interworking with a Zero Trust Security framework consisting of Digital Rights Management (DRM) and Digital Watermarking technologies and integrated with an off-chain IPFS based decentralized NFT copyright ownership registry. The system is also designed to facilitate peer-to-peer (p2p) real time communications between NFT buyers and sellers using browser based WebRTC-UDP-QUIC to provide secure voice, video, and content messaging communications. The system also provides integrated fee-based copyright insurance protection for NFT marketplaces with high value digital content including rare books, digital art, music, digital property, gaming, sport memorabilia, etc.

### Smart Contracts

Smart contracts are the executable programs that run on Blockchain. Smart contracts are written using specific programming languages that compile to Blockchain bytecode (low-level machine instructions called opcodes). Not only do smart contracts serve as open-source libraries, but they are also essentially open API services that are always running and can't be taken down. Smart contracts provide public functions which users and applications (Dapps) may interact with, without needing permission Any application may integrate with deployed smart contracts to compose functionality, such as adding data feeds or to support token swaps. Additionally, anyone can deploy new smart contracts to Blockchain to add custom functionality to meet their application's needs.

Any developer can create a smart contract and make it public to the network, using the blockchain as its data layer, for a fee paid to the network. Any user can then call the smart contract to execute its code, again for a fee paid to the network. Thus, with smart contracts, developers can build and deploy arbitrarily complex user-facing apps and services such as: marketplaces, financial instruments, games, etc.

### Ricardian Contracts

A Ricardian Contract is a legal contract that is a form of digital documents that act as an agreement between two parties on the terms and condition for an interaction between the agreed parties. What makes it unique is—it is cryptographically signed and verified. Even when it is a digital document, it is available in a human-readable text that is also easy to understand for people (lawyers). It is a unique legal agreement or document that is readable for computer programs as well as humans at the same time. Ricardian contracts have two parts or serve two purposes. First, it is an easy-to-read legal contract between two or more parties. A lawyer can easily understand it, and even you can read it and understand the core terms of the Contract. Second, it is a machine-readable contract as well. With blockchain (Bitcoin) platforms, these contracts can now easily hashed, signed, and can be saved on the blockchain (Bitcoin). Ricardian Contracts merge legal contracts with technology, blockchain technology to be precise. They bind the parties into a legal agreement before the execution of the actions on the blockchain network.

For the validity of the legal Contract, an issuer can create a legal framework. Both parties or holders fill that legal framework and agree on it by signing it. Ricardian Contracts are a type of Smart Contracts or use the code used in Smart Contracts. They are also live contracts that can be changed after the execution of an event. For example, in the case of a contract that is about buying and selling a car between the two parties, one clause can be about contacting an authority that can confirm if the seller is the actual owner of the vehicle. Once you have the information, you can add it to the Ricardian Contract, creating a new version of the Contract. This way, the Ricardian Contract executes different events and moves towards a logical conclusion based on the outcome of each event.

### Digital Contract Hash

Once the Contract is prepared, it is signed digitally, and the Contract is agreed to refer to the hash of the Contract. For example, if there is a financial transaction taking place under the agreement, the transaction will apply to the hash of that Contract, along with paying parties.

### Hidden Digital Signature

Ricardian contracts also use hidden signatures to make the process more secure. The signing of the contracts takes place through private keys. Later, the hash of the agreement is used to attach that hidden signature to the Contract.

### Benefits of Ricardian Contracts

Ricardian contracts made some new possibilities a reality on the blockchain (Bitcoin) networks. Some of its applications as well as benefits include:

For the first time, it allows the legally enforceable transfer of physical assets as well as rights on the blockchain network, which was not possible with Smart Contracts. When smart-contracts were also used for the same purpose, they can't legally-enforce the transfer.

Ricardian Contracts can save effort, costs, and time you may have to invest when a dispute arises. The machine-readable legal contracts are not open to any interpretation, which is the main drawback of human-readable legal contracts. Lawyers can interpret the content based on their liking, which may result in a conflict.

### Difference Between Smart Contracts and Ricardian Contracts

### Smart Contracts

Smart contracts are also machine-readable Contract, or a set of instructions that control and direct the upcoming actions and events. Smart Contracts act as contracts to provide trust during an exchange and can be used to exchange money, shares, property, and other assets on the internet. You can do that by defining obligations between two parties and executing them through computer code. They are an essential part of the process on the blockchain network where the parties remain anonymous.

These are the core characteristics of a Smart Contract: Executes on its own based on the instructions provided in the computer code, Self-verifying and auto-enforcing, Immutable, which means you can't edit the terms.

### Cost Savings

The only issue with Smart Contracts is that they are not legally binding agreements, which is why, if anything goes wrong, it is hard to prove a case against fraud or scam in the court of law as it is not a legally binding agreement. The second core difference is it is not human readable as well. It is just a code, but Ricardian contracts are readable by both humans and machines.

### Ricardian Contracts

Ricardian Contracts outline the intentions as well as actions based on the legal agreement that will take place in the future. The fundamental difference between both contracts on blockchain platforms is the type of agreement. One (Ricardian contracts) records the agreement between multiple parties, while the other (Smart Contracts) executes whatever is defined in the agreement as action.

Ricardian Contract is a legally valid contract, while Smart Contracts are not. It turns a human-readable legal contract into machine-readable code that can be executed by the software. Smart Contracts automate the actions on a blockchain application. However, they also have some limitations, as you cannot have a clear idea of what happens next in many scenarios. In that case, you can't use Smart Contracts to automate something that you are not sure of.

In such a case, if an event occurs that is not planned for in the instructions provided in the Smart Contracts, it can cause a significant problem. As a Smart Contract also doesn't have any legal framework that can define how to proceed forward in such an event, it just doesn't work in such cases. You can also say, Smart Contracts lack the ability to evolve around such scenarios in the absence of a legal framework.

Here are the core characteristics of the Ricardian contracts: Available in printable form and human parsable, Program parsable with all forms equivalent in terms of manifest, Signed by the issuer and both parties.

### Ricardian Contract Security

Ricardian Contracts are very secure as they use cryptographic signatures. Each document in the Contract has unique identification by its hash. This means once it is agreed upon by both parties and turned into a machine-readable form, it is impossible for anyone to arbitrarily change the legal agreement. This also offers protection from a commonly used tactic in legal agreements called frog boiling. Under traditional legal agreements, an issuer with the upper hand keeps changing the terms in the agreement during the execution. This is not possible with the Ricardian Contracts. To sign Ricardian Contracts, you can use private keys. When you add the signature of the issuer of the Contract to the document, it creates a legible and binding agreement about the information described in the document. It is also possible to track the parties involved with the help of the private key and hold them accountable.

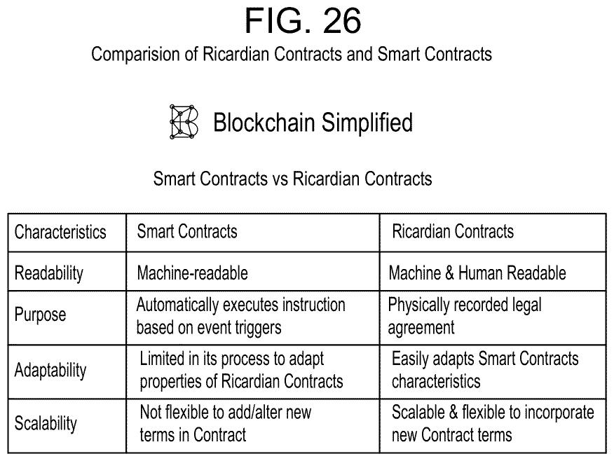

FIG. 26 shows a Comparison of Ricardian Contracts and Smart Contracts.

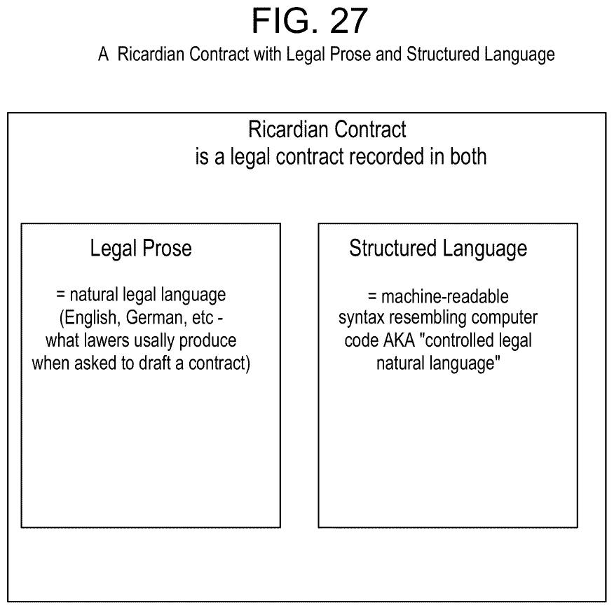

FIG. 27 illustrates a Ricardian Contract with Legal Prose and Structured Language.

### IX. Open AI Applications for Smart Contracts

### Artificial Intelligence (AI) and Smart Contracts

Open AI is a natural language processing tool driven by AI technology that allows users to have human-like conversations and much more with the chatbot. The language model can answer questions and assist you with tasks like composing emails, essays, and code. It uses a sequence model and was built for text production tasks including question-and-answer, text-summarization, and machine translation. Combining Web3 with foundational models like ChatGPT opens up a world of new possibilities.

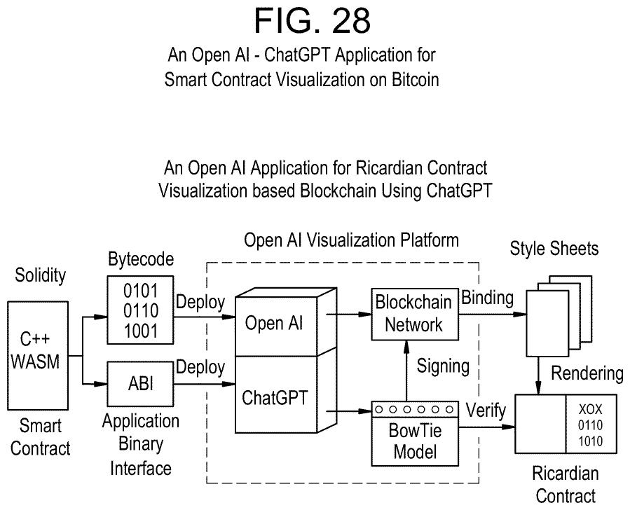

FIG. 28 shows an Open AI-ChatGPT Application for Smart Contract Visualization on Bitcoin. A smart contract made using Solidity in C++ WASM is sent to an application binary interface along with bytecode. The bytecode and ABI are deployed to an OpenAI Visualization platform having an OpenAI module and ChatGPT module. The platform also has a blockchain network module for binding to StyleSheets and a BowTie model module for signing and verifying to the rendered Ricardian contract.

Developers still struggle with the programming of smart contracts for Blockchain on-chain transaction records and for off-chain IPFS decentralized smart contract storage. This issue can be resolved with help of ChatGPT. Think of a smart contract assistant that will provide the appropriate smart contract code snippet for a developer if they input “What is the solidity program to obtain a loan at a Bank or a tokenized finance from a VC or institutional investor,”

Self-executing audits are laborious, expensive, and uncomfortable tasks that must be finished. Running tests that are frequently hidden from smart contract authors is most of the auditing procedure. Think about a refined ChatGPT implementation for self-executing audits that can accept a language input and run a series of tests in a particular smart contract.

Intelligence NFTs—The possibility to develop a new era of conversationally intelligent non-fungible tokens (NFT) is one of the most well-known uses of models like ChatGPT. Think about an NFT collection that lets you inquire about concepts and inspirations or certain aesthetic elements.

Crypto Wallets—Wallets serve as the main point of contact for interactions with decentralized apps in the Web3 environment. We can observe a similar trend in crypto wallets, where customer satisfaction in Web2 applications is also being reinvented with fundamental models like ChatGPT as a key component. Think of a wallet application where a user may express their intent to carry out a transaction, get information, or carry out particular tasks using natural language.

### Benefits of AI Applications for Bitcoin

Artificial intelligence (AI) and smart contracts are two of the most promising technologies of our time. Both have the potential to revolutionize a wide range of industries and change the way we live and work. But what happens when these two technologies intersect? One of the most obvious ways that AI and smart contracts can intersect is using smart contract-based decentralized autonomous organizations (DAOs). These are organizations that are run entirely by code, with no human intervention. AI can be used to make these organizations more efficient and effective by automating decision-making processes and handling complex tasks. For example, a DAO could use AI to optimize supply chain logistics or analyze financial data to make investment decisions.

Another way that AI and smart contracts can intersect is using smart contract-based prediction markets. These are markets where people can bet on the outcome of events and are often used to forecast the likelihood of future events. AI can be used to analyze large amounts of data and make more accurate predictions, which can be used to inform the decisions of traders and investors. AI and smart contracts can also be used together to create new types of digital assets. For example, a smart contract could be used to create a digital token that represents a share in an AI-powered hedge fund. The smart contract would automatically manage the fund's investments and distribute profits to token holders.

Finally, AI and smart contracts can be used to create new forms of decentralized finance (Defi) that are more efficient and secure. For example, a smart contract could be used to create a decentralized lending platform that uses AI to underwrite loans and assess credit risk.

### X. Bitcoin NFT Copyright Ownership Using DRM Rights Protection

This section describes a system and method to legally validate and verify NFT copyright ownership between buyers and sellers by deploying Bitcoin based Ricardian contracts interworking with a Zero Trust Security framework consisting of Digital Rights Management (DRM) and Digital Watermarking technologies and integrated with an off-chain IPFS based decentralized NFT copyright ownership registry. The system is also designed to facilitate peer-to-peer (p2p) real time communications between NFT buyers and sellers using browser based WebRTC-UDP-QUIC to provide secure voice, video, and content messaging communications. The system also provides integrated fee-based copyright insurance protection for NFT marketplaces with high value digital content including rare books, digital art, music, digital property, gaming, sport memorabilia, etc.

The NFT copyright ownership, validation and verification system comprised of the following network components: Bitcoin with on-chain Ricardian contracts that describe the copyright ownership between an NFT buyer and seller; Zero Trust Security-Zero Trust Network Access; Self-Sovereign (SSI) wallet for user registration and authentication; Digital Rights Management (DRM) security and permissions; Digital Watermarking; Zero Knowledge Proofs (ZKP); Multiparty Computation (MPC); NFT scaling; Off-chain indexing; NFT Marketplace; Copyright Ownership verification; Copyright certification; NFT creation; Bitcoin Token issuance; IPFS Gateway Registry; Copyright registry; Ricardian contract digital hash; Ricardian contract hidden digital signature; IPFS Decentralized Storage; Decentralized Ricardian contract storage; Content addressing with unique digital ID; Content linking using a Merkle DAG and a cryptographic hash function (SHA256); Content discovery using Distributed Hash Tables (DHT); WebRTC-QUIC-UDP Real Time p2p Communications; SSI digital wallet for user authentication and validation; Browser based p2p secure connections between NFT buyers and sellers; Voice, data, and video; and NFT Copyright Insurance using legal Ricardian contracts.

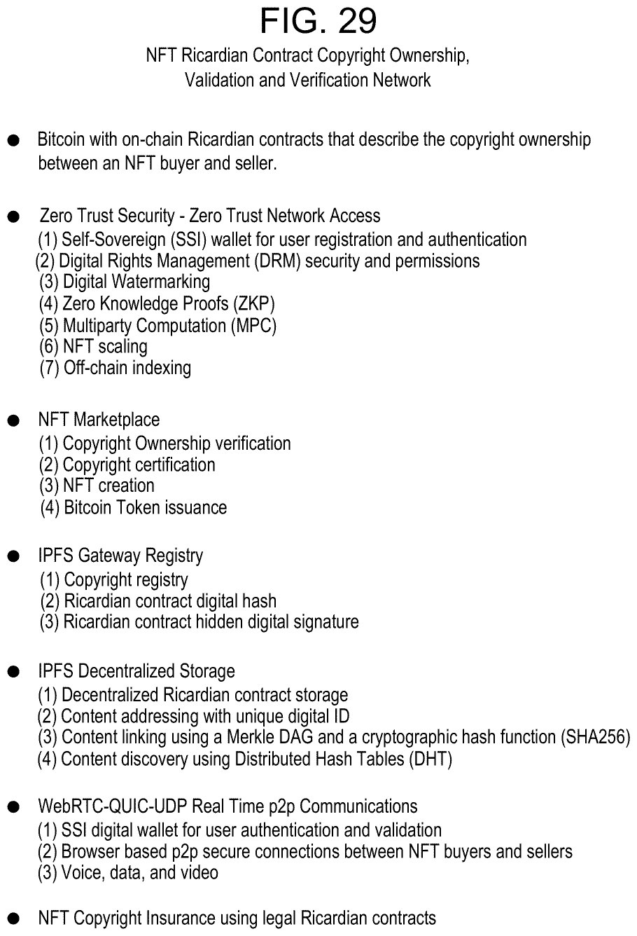

FIG. 29—illustrates the NFT Ricardian Contract Copyright Ownership, Validation and Verification Network.

### Copyright Ownership, Validation and Verification Process

The system has been designed to create and deploy Ricardian contracts that are recorded on Bitcoin, then processed off-chain in an IPFS gateway copyright registry and then stored in IPFS decentralized storage to legally validate and verify NFT digital copyright ownership between NFT buyers and sellers.

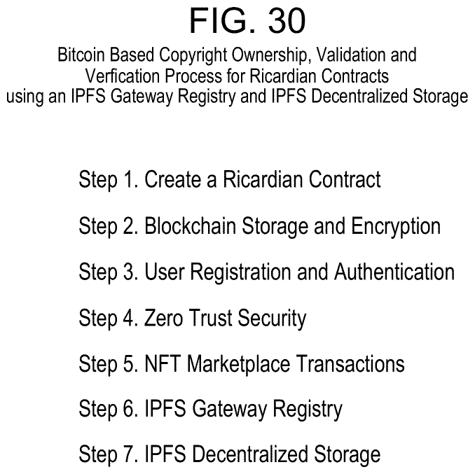

FIG. 30—illustrates the Bitcoin Based Copyright Ownership, Validation and Verification Process for Ricardian Contracts using an IPFS Gateway Registry and IPFS Decentralized Storage.

### Step 1. Create a Ricardian Contract

The Ricardian contract between an NFT buyer and seller is created to detail the legal copyright ownership of the NFT transaction.

### Step 2. Blockchain Storage and Encryption

The Ricardian contract is stored on-chain in Bitcoin where the Ricardian contract is assigned a digital hash and a hidden digital signature.

### Step 3. User Registration and Authentication

The buyer and seller are required to deploy a Self-Sovereign Identity (SSI) based digital wallet to join and access the NFT marketplace. The SSI wallet is used to provide user registration and authentication.

### Step 4. Zero Trust Security

Zero Trust Security is implemented to provide a security enclave for the NFT minting, scaling, and indexing process which includes Digital Rights Management (DRM), Digital Watermarking, Zero Knowledge Proofs, and Multiparty Computation.

### Step 5. NFT Marketplace Transactions

The NFT transaction between the buyer and seller performs copyright ownership verification for the seller and copyright certification for either the seller or buyer using the legal terms specified in the Ricardian contract. The NFT is created, and the transaction is completed, and crypto token is executed.

### Step 6. IPFS Gateway Registry

The NFT copyright ownership transaction record and the Ricardian contract are both recorded and stored in the IPFS Gateway Registry where the legal copyright owner is recorded via the Ricardian contract hash and hidden signature in Step

### Step 7. IPFS Decentralized Storage

The NFT Ricardian contract is permanently stored in IPFS decentralized storage. IPFS storage uses Content Addressing with unique digital ID, Content linking using a Merkle DAG and a cryptographic hash function (SHA256) and Content discovery using Distributed Hash Tables (DHT) to store, manage, retrieve NFT Ricardian contracts and provide these documents and records based on Blockchain requests.

### IPFS Registry and Storage System for NFT Copyright Ownership, Validation and Verification Using Smart Contracts

The Copyright Gateway Registry and IPFS Storage system consists of: A File Processing and Text Editor Application (dApp), Blockchain, Smart Contracts are used to govern, manage, and provide traceability into stored and shared content, Copyright gateway copyright registry, IPFS decentralized storage system, File security using AES-256 symmetrical encryption and Elliptical Curve Digital Signature (ECDA), Encrypted files stored on IPFS which can only be accessed through the file editor.

The decentralized file and data sharing application ensures that the digital content would only be accessible in the application and will not be available in the end-users' operating system. Any modify or share operations performed on shared files are recorded separately to the blockchain to ensure security, integrity, and transparency.

### Ricardian or Smart Contract-IPFS Workflow Process

The Ricardian-IPFS system workflow shows the interworking system components and process of the IPFS file storage and sharing architecture. Users first register to the File Processing application. The registration details of the user are added to the Blockchain by the application. After creation of the file in the application's inbuilt text processing and editor application, users can decide if the file should be shared or made public. If the file is supposed to be shared, the file owner provides the public key of recipients with whom the file should be shared with. The application then deploys a Ricardian contract which stores the file metadata. It then encrypts the document and adds to IPFS in an encrypted format. To access the files, users are required to use the file sharing application since the file would be decrypted only in the application editor. The application uses the file Ricardian contract to access the file metadata, fetches the file from IPFS, decrypts the file and opens in the file processing and editor application. To collect data and files, a user log calls to functions of Ricardian contracts to request the files or data performed in the application editor. After an operation is performed, a permanent record is generated which is then uploaded to the Blockchain network and securely stored in the Blockchain.

The IPFS-Copyright Registry architecture can be divided into four main steps or phases:

### IPFS-Copyright Registry Architecture

Step 1—User Registration and Authentication,
Step 2—File creation and storage,
Step 3—File Access and retrieval, and
Step 4—File data collection, storage, and validation

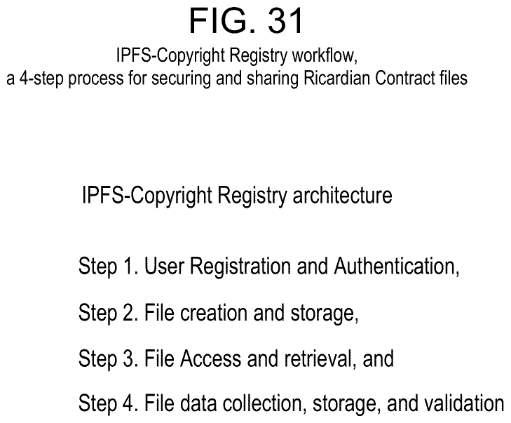

FIG. 31—illustrates the IPFS-Copyright Registry workflow, a 4-step process for securing and sharing Ricardian Contract files.

A more detailed discussion of the 4-step workflow process for IPFS data and file sharing interworking with the Copyright Registry is described below.

### Step 1—NFT User Registration, Authentication and Verification Using Zero Trust Security

Users are required to register to the system to have a unique identity. Every user is required to create a smart contract which will act as a unique identity for them. The Metadata Ricardian contract acts as a gatekeeper to generate a Ricardian contract for every user after their registration. During the registration process, each user provides a registration key in the form of a string as an input to the application. Using this registration key and a current timestamp, the application generates public-private key pair using Elliptical Curve Digital Signature Algorithm (ECDSA). Metadata deploys a Ricardian contract of the registered user and obtains the address of the deployed Ricardian contract. The deployed user's Ricardian contract contains user's Metadata which includes user's public key, registration key, an array of information regarding the files which have been shared with the user.

The Metadata also contains a mapping of every registered user's public key to the address of their deployed Ricardian contract. After the deployment of the user's Ricardian contract, the received deployed address of the user's Ricardian contract is added to the mapping in the Metadata's Ricardian contract. The public key generated during the registration process is used by the file owner while specifying the recipient to whom the file will be shared with. The registration key and private key will be used to validate the user authenticity during the login process of the file processing and sharing application. For authentication, users will provide registration which includes public and private key as an input to the file sharing application. The registration key is encrypted using a private key. Using the received public key as an input, user's Ricardian contract deployed address can be fetched from the Metadata's mapping. As the user's Ricardian contract is fetched from the obtained address, to validate the user, the application sends the Encrypted Registration Key to the encryption validation function of the user's Ricardian contract. The Encrypted Registration Key is then decrypted using the public key of the user, and if the resulting string is same as registration key of the user's Ricardian contract, then user will be validated otherwise the authentication would fail.

### Step 2—NFT Copyright File Creation and Storage

The owner creates a file in the application editor and requests a selected file for sharing on the File Processing application. The application creates a random key to encrypt the file using AES-256 symmetric key encryption. This random key will be the ‘Secret Key’ for any given file which will only reside in the owner's File Processing application. The application then encrypts the file with the Secret Key. This encrypted file is added to the IPFS network. IPFS network returns the hash of the uploaded file. As shown in Step 2, a Ricardian contract is created for every deployed file on IPFS. The metadata Ricardian contract acts as a factory to generate Ricardian contracts for every file shared on the application. The file's Ricardian contract contains metadata which includes filename, IPFS address of the encrypted file and owner's public key. After deployment of the Ricardian contract, the shared file application will receive the deployed file Ricardian contract's address. Now, the file owner can specify the following types of access control for the specified file.

Shared File: The owner can share the file with other users by using the public key of the user that they want to share the file with. After giving this public key to the File application as an input, the application will encrypt the secret key of the file with the public key of the user with whom the file is to be shared to create an Encryption Key′. This is asymmetric encryption, whereas the ‘Encryption Key’ can only be decrypted by the user who has corresponding Private Key. The Ricardian contract of the file, for shared mode contains a mapping of the receiver user's public key to the Encryption Key of the file. This mapping will be added to the shared file's Ricardian contract. The files Metadata will access the user's Metadata to obtain the deployed address of receiver's user Ricardian contract. The shared files Ricardian contract address will be added to the receiver's user Ricardian contract. Thus, the receiver user Ricardian contract now will contain an array of deployed addresses of all the files which are shared with them.

### Step 3—NFT File Access and Retrieval

On the file sharing application interface, after giving user's logging details such as registration key, public key and private key, the application will retrieve the user's deployed Ricardian contract using Metadata Ricardian contract. If the user is validated, then the file sharing application will now access the user's Ricardian contract using Metadata. The user Ricardian contract contains the address of deployed Ricardian contracts of all files shared with them. These files will appear on the application interface as ‘my fileshares’. The Application interface will also retrieve all files which are publicly shared using Metadata Ricardian contract. The following mechanisms are performed for the access control types:

Shared File: Using the file's deployed Ricardian contract address, the file sharing application will retrieve the key available in the mapping of the public key to encrypted key using the user's own public key. The received key will then be decrypted by user's private key in the application, and the generated key will be used to decrypt the accessed files by the file sharing application.

Step 4—IPFS Process Validation and Integration with the IPFS Gateway Registry and Blockchain

The IPFS validation process for the file and editing application consists of the following:
React.js is an open-source front-end JavaScript library for building user interfaces based on UI components and is used for the front end and interfaces with the Blockchain NFT platform,
Solidity—is an object-oriented programming language for writing Ricardian contracts and is used for developing Ricardian Contracts,
Web3.js—is a collection of libraries that allow users to interact with local or remote Ethereum Blockchain nodes and is used to interact with Blockchain nodes using an HTTP connection, including Web Transport protocols based on WebRTC-QUIC-UDP.

### XI. WebRTC UDP-QUIC Video and End-to-End Secure Messaging Communications Using DRM Content Security

WebRTC is a free, open-source platform which facilitates browser-based P2P communications (voice, video, and data) on Android, IOS, and PC platforms. WebRTC is supported by most browser technologies including Chrome, Firefox, Safari Opera, and MS Edge.

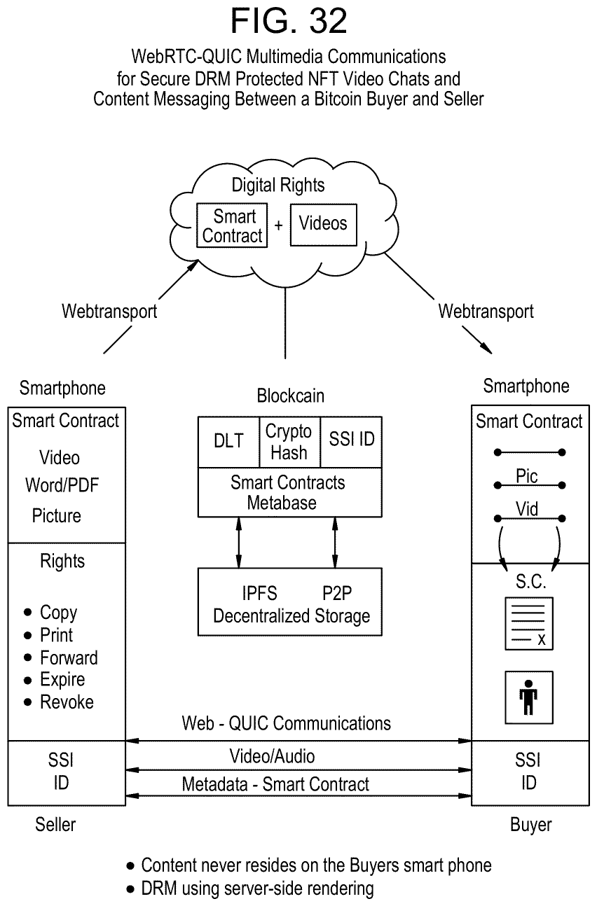

FIG. 32—WebRTC-QUIC Multimedia Communications for Secure DRM Protected NFT Video Chats and Content Messaging Between a Bitcoin Buyer and Seller. This figures shows how two users having a smartphone app according to the invention can use web transport to access cloud-based digital property, smart contracts, videos, etc. The sender can select DRM restrictions which are enforced by server-side rendering (the receiving device can view/interact but does not receive a local copy). A blockchain module handles the DLT, crypto hash, SSI ID, and smart contracts metadata as between the two users.

### WebRTC-QUIC Browser Based Real Time Communications

WebRTC-QUIC is a technology that enables Web applications and sites to capture and optionally stream audio and/or video media, as well as to exchange arbitrary data between browsers without requiring an intermediary. The set of standards that comprise WebRTC makes it possible to share data and perform teleconferencing peer-to-peer, without requiring that the user install plug-ins or any other third-party software.

Multiple video and audio messaging systems have been developed recently. However, many systems require proprietary hardware and software systems, and are complicated to set up for an average user. Systems that are easy to set up and use often provide low quality video and audio. Commercial grade systems provide high quality video and audio, but these systems are expensive to install and require specialized technical support to operate and maintain.

WebRTC is a powerful, and highly disruptive cutting-edge technology and standard that has been developed over the last decade. As opposed to specialized applications and hardware, WebRTC leverages a set of plugin-free APIs used in both desktop and mobile browsers to provide high-quality functional video and audio streaming services. Previously, external plugins were required to achieve similar functionality to that provided by WebRTC.

WebRTC provides a secure real-time communications service for audio and video streaming communications and content sharing that securely connects multiple users using a proprietary application that uses WebRTC technology to establish a Peer-to-Peer (P2P) connection. WebRTC uses multiple standards and protocols, including data streams, STUN/TURN servers, signaling, JSEP, ICE, SIP, SDP, NAT, UDP/TCP, and network sockets.

However, there continues to be a need for security, encryption, DRM protection, and the advantages provided by incorporating blockchain technology for storage and sharing of streamed video, streamed audio, real-time messages, and DRM-protected files.

WebRTC-QUIC uniquely combines advanced security technologies to provide user-based permissions control when communicating and sharing rich media content with other users including End-to-End Encryption (E2EE), Hash Technology (DHT), and Digital Rights Protection (DRM). It has also designed a unique cloud based streamed video storage and sharing platform service for consumers and business video storage and sharing applications.

Avila Technology has been granted several patents for WebRTC that provide push-button connectivity between users for video and audio streaming using WebRTC technology for Web3 services to discover and establish peer-to-peer connection between users having a proprietary mobile or desktop application. Using the browser-based app, a sender may select one or more receivers, who also have the app, to have a video or audio chat, or share a file. Selecting the receiver(s) to send an invite initiates a complex group of processes, programming, and protocols, including generating a specific discovery communication file, sending the discovery communication file in a series of specially encrypted communications to a networked Web3 platform that includes a WebRTC Gateway Server, a Signaling Server, an IPFS Storage Server, and a Private Blockchain.

The WebRTC Gateway Server provides the discovery communication to the receiver using subscriber information managed in a private blockchain and stored in distributed IPFS storage with all lookup and delivery communications and all stored data specially encrypted. The receiver app generates a specific response/acceptance file, sends encrypted notification back to the WebRTC Gateway Server, and the WebRTC Gateway Server working with the Signaling Server to generate a peer-to-peer connection using the private and public IP addresses of the sender and receiver.

The sender may apply DRM permissions to the streamed video or audio content in the peer-to-peer connection and the app uses an encryption key that is integrated into and required for the playback CODEC to process the content and where a DRM violation results in revocation of the encryption key. Multi-party video and audio conferences may be broadcast using insertable streams for insertion of user defined processing steps for encoding/decoding of WebRTC media stream tracks and for end-to-end encryption of the encoded data.

### UDP—QUIC Transport Layer Network Protocol—WebTransport

QUIC is a general-purpose transport layer network protocol designed to improve connectivity, reliability and speed for real time communications services on WebRTC peer-to-peer platform. QUIC is used by more than half of all connections from the Chrome web browser to Google's servers. Microsoft Edge and Firefox support it. Safari implements the protocol, however it is not enabled by default.

QUIC improves performance of connection-oriented web applications that are currently using TCP. It does this by establishing a number of multiplexed connections between two endpoints using User Datagram Protocol (UDP), and is designed to obsolete TCP at the transport layer for many applications, thus earning the protocol nickname “TCP/2”. QUIC works hand-in-hand with HTTP/2's multiplexed connections, allowing multiple streams of data to reach all the endpoints independently, and hence independent of packet losses involving other streams. In contrast, HTTP/2 hosted on Transmission Control Protocol (TCP) can suffer head-of-line-blocking delays of all multiplexed streams if any of the TCP packets are delayed or lost.

QUIC's secondary goals include reduced connection and transport latency, and bandwidth estimation in each direction to avoid congestion. It also moves congestion control algorithms into the user space at both endpoints, rather than the kernel space, which will allow these algorithms to improve more rapidly. Additionally, the protocol can be extended with forward error correction (FEC) to further improve performance when errors are expected.

Transmission Control Protocol, or TCP, aims to provide an interface for sending streams of data between two endpoints. Data is handed to the TCP system, which ensures the data makes it to the other end in the same form, or the connection will indicate that an error condition exists.

To do this, TCP breaks up the data into network packets and adds small amounts of data to each packet. This additional data includes a sequence number that is used to detect packets that are lost or arrive out of order, and a checksum that allows the errors within packet data to be detected. When either problem occurs, TCP uses automatic repeat request (ARQ) to tell the sender to re-send the lost or damaged packet.

In most implementations, TCP will see any error on a connection as a blocking operation, stopping further transfers until the error is resolved or the connection is considered failed. If a single connection is being used to send multiple streams of data, as is the case in the HTTP/2 protocol, all of these streams are blocked although only one of them might have a problem. For instance, if a single error occurs while downloading a GIF image, the entire rest of the page will wait while that problem is resolved.

As the TCP system is designed to look like a “data pipe”, or stream, it deliberately contains little understanding of the data it transmits. If that data has additional requirements, like encryption using TLS, this must be set up by systems running on top of TCP, using TCP to communicate with similar software on the other end of the connection. Each of these sorts of setup tasks requires its own handshake process. This often requires several roundtrips of requests and responses until the connection is established. Due to the inherent latency of long-distance communications, this can add significant overhead to the overall transmission.

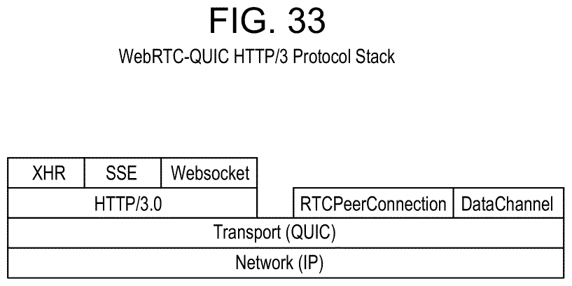

FIG. 33 illustrates the WebRTC-QUIC HTTP/3 Protocol Stack.

### QUIC+UDP Versus TCP+TLS

QUIC aims to be nearly equivalent to a TCP connection but with much-reduced latency. It does this primarily through two changes that rely on the understanding of the behavior of HTTP traffic.

The first change is to greatly reduce overhead during connection setup. As most HTTP connections will demand TLS, QUIC makes the exchange of setup keys and supported protocols part of the initial handshake process. When a client opens a connection, the response packet includes the data needed for future packets to use encryption. This eliminates the need to set up the TCP connection and then negotiate the security protocol via additional packets. Other protocols can be serviced in the same way, combining multiple steps into a single request-response. This data can then be used both for following requests in the initial setup, as well as future requests that would otherwise be negotiated as separate connections.

The second change is to use UDP rather than TCP as its basis, which does not include loss recovery. Instead, each QUIC stream is separately flow controlled and lost data retransmitted at the level of QUIC, not UDP. This means that if an error occurs in one stream, the protocol stack can continue servicing other streams independently. This can be very useful in improving performance on error-prone links, as in most cases considerable additional data may be received before TCP notices a packet is missing or broken, and all this data is blocked or even flushed while the error is corrected. In QUIC, this data is free to be processed while the single multiplexed stream is repaired.

QUIC includes several other more changes that also improve overall latency and throughput. For instance, the packets are encrypted individually, so that they do not result in the encrypted data waiting for partial packets. This is not generally possible under TCP, where the encryption records are in a byte stream and the protocol stack is unaware of higher-layer boundaries within this stream. These can be negotiated by the layers running on top, but QUIC aims to do all of this in a single handshake process.

Another goal of the QUIC system is to improve performance during network-switch events, like what happens when a user of a mobile device moves from a local WiFi hotspot to a mobile network. When this occurs on TCP, a lengthy process starts where every existing connection times out one-by-one and is then re-established on demand. To solve this problem, QUIC includes a connection identifier which uniquely identifies the connection to the server regardless of source. This allows the connection to be re-established simply by sending a packet, which always contains this ID, as the original connection ID will still be valid even if the user's IP address changes.

QUIC can be implemented in the application-space, as opposed to being in the operating system kernel. This generally invokes additional overhead due to context switches as data is moved between applications. However, in the case of QUIC, the protocol stack is intended to be used by a single application, with each application using QUIC having its own connections hosted on UDP. Ultimately the difference could be very small because much of the overall HTTP/2 stack is already in the applications (or their libraries, more commonly). Placing the remaining parts in those libraries, essentially the error correction, has little effect on the HTTP/2 stack's size or overall complexity.

QUIC allows future changes to be made more easily as it does not require changes to the kernel for updates. One of QUIC's longer-term goals is to add new systems for forward error correction (FEC) and improved congestion control.

One concern about the move from TCP to UDP is that TCP is widely adopted and many of the “middle-boxes” in the internet infrastructure are tuned for TCP and rate-limit or even block UDP. Google carried out several exploratory experiments to characterize this and found that only a small number of connections were blocked in this manner. This led to the use of a rapid fallback-to-TCP system; Chromium's network stack opens both a QUIC and traditional TCP connection at the same time, which allows it to fallback with negligible latency.

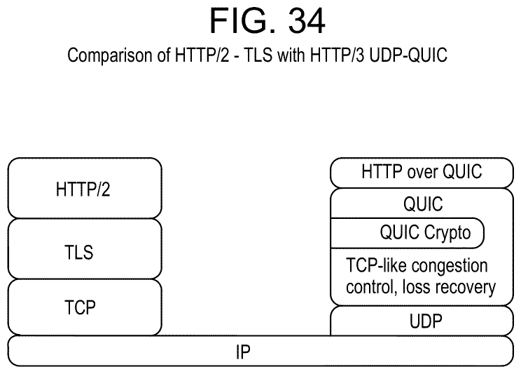

FIG. 34 illustrates a Comparison of HTTP/2-TLS with HTTP/3 UDP-QUIC.

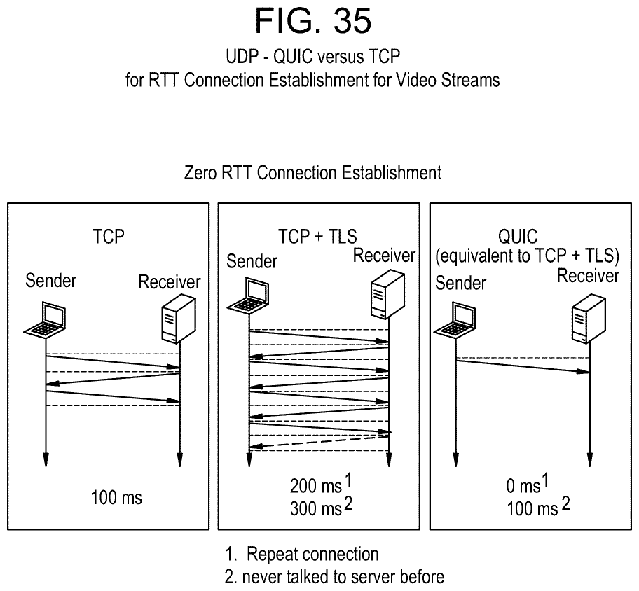

FIG. 35 shows UDP-QUIC versus TCP for RTT Connection Establishment for Video Streams. TCP between sender and receiver requires about 3 bounces and can a connection latency of about 100 ms. TCP+TLS requires up to 8 bounces and can have a connection latency of 200 ms for repeat connections and 300 ms to provision a first time connection to the server. QUIC requires a single hop and has a connection latency of 0 ms for repeat connections and 100 ms to provision a first time connection to the server.

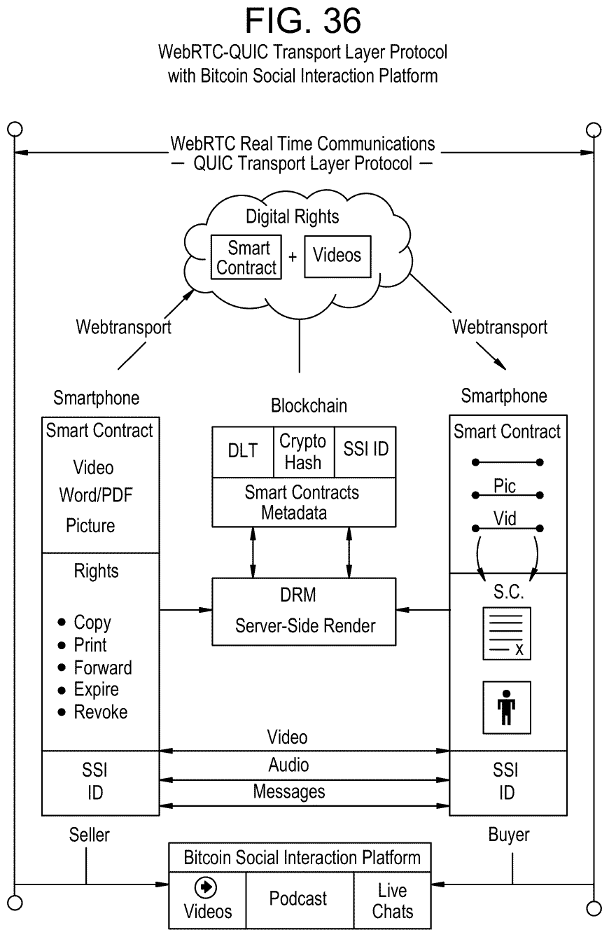

Referring now to FIG. 36 is an illustration of a non-limiting example of a WebRTC-QUIC Transport Layer Protocol with Bitcoin Social Interaction Platform. This figures shows how two users having a smartphone app according to the invention can use web transport to access cloud-based digital property, smart contracts, videos, etc. The sender can select DRM restrictions which are enforced by server-side rendering (the receiving device can view/interact but does not receive a local copy). A blockchain module handles the DLT, crypto hash, SSI ID, and smart contracts metadata as between the two users. A Bitcoin Social Interaction Platform module handles social network video sharing, podcasts, live chats, and so forth.

### Definitions

The terminology used herein is for the purpose of describing particular embodiments only and is not intended to limit the full scope of the claims. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

As used herein, the singular forms “a”, “an” and “the” are intended to include the plural forms as well, unless the context clearly indicates otherwise. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” etc.). Similarly, the terms “comprises” and/or “comprising,” when used in this specification, specify the presence of stated features, integers (or fractions thereof), steps, operations, elements, and/or components, but do not preclude the presence or addition of one or more other features, integers (or fractions thereof), steps, operations, elements, components, and/or groups thereof. As used in this document, the term “comprising” means “including, but not limited to.”

As used herein the term “and/or” includes any and all combinations of one or more of the associated listed items. It should be understood that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All ranges disclosed herein also encompass any and all possible subranges and combinations of subranges thereof unless expressly stated otherwise. Any listed range should be recognized as sufficiently describing and enabling the same range being broken down into at least equal subparts unless expressly stated otherwise. As will be understood by one skilled in the art, a range includes each individual member.

The embodiments herein, and/or the various features or advantageous details thereof, are explained more fully with reference to the non-limiting embodiments that are illustrated in the accompanying drawings and detailed in the following description. Descriptions of well-known components and processing techniques are omitted so as to not unnecessarily obscure the embodiments herein. Like numbers refer to like elements throughout.

The examples and/or embodiments described herein are intended merely to facilitate an understanding of structures, functions, and/or aspects of the embodiments, ways in which the embodiments may be practiced, and/or to further enable those skilled in the art to practice the embodiments herein. Similarly, methods and/or ways of using the embodiments described herein are provided by way of example only and not limitation. Specific uses described herein are not provided to the exclusion of other uses unless the context expressly states otherwise.

### LEGAL EQUIVALENTS

Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

Where schematics and/or embodiments described above indicate certain components arranged in certain orientations or positions, the arrangement of components may be modified. While the embodiments have been particularly shown and described, it will be understood that various changes in form and details may be made. Any portion of the apparatus and/or methods described herein may be combined in any combination, except mutually exclusive combinations.

The embodiments described herein can include various combinations and/or sub-combinations of the functions, components, and/or features of the different embodiments described. Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

1. (canceled)

2. (canceled)

3. (canceled)

4. A system for a Bitcoin NFT architecture framework with cross chain inter-operability, comprising:
a bitcoin-inscriptions and ordinals (BIO) module having computer programming code saved to memory and executable on a processor for operating the BIO module, the BIO module comprising an Unspent Transaction Output (UTXO) module, an inscriptions module, an ordinals module, a 4 MB Satoshi module, a taproot module, and a smart contracts module;
a seller module having computer programming code saved to memory and executable on a processor for operating the seller module, the seller module having a seller digital wallet configured with a seller self sovereign identity module, and a buyer module having a buyer digital wallet configured with a buyer self sovereign identity module, the seller module operatively connected to the bitcoin-inscriptions and ordinals module;
a Zero Trust Security Platform (“ZTS Platform”) having computer programming code saved to memory and executable on a processor for operating the ZTS Platform, the ZTS Platform in operative communication with the BIO module using a UDP-QUIC protocol, the ZTS platform having a Smart Contract module for performing seller-side ownership verification and buyer-side authentication, the ZTS Platform having a Cross-chain Module in communication with the Smart Contract module for providing Smart Contract parachains using Solidity & Web Assembly (WASM) code, the Cross-chain Module having a Bridges & Substrates module for providing cross-chain interoperability, the Cross-chain Module in operative communication with a public key encryption (PKI) module, a Self-Sovereign Identity Management (SSI) module, a Digital Rights Management (DRM) module, a Zero Knowledge Proofs (ZKP) module, and an Elliptical curve-Diffie Hellman (ECDH) encryption module;
an IPFS Decentralized Storage module having computer programming code saved to memory and executable on a processor for operating the IPFS Decentralized Storage module, the IPFS Decentralized Storage module in operative communication with the ZTS module and having a Virtual Machine (VM) module, an IPFS Gateway module, a gateway Registry module, a Bitcoin NFT & Smart Contract IPFS module, and an OpenAI-Smart Contact Visualization module, the IPFS Gateway module in communication with a Merkle-DAGs module and a DHT module, the IPFS Decentralized Storage module in operative communication with a Content Address module and a Content Link module, the OpenAI-Smart Contact Visualization module in operative communication with a Solidity WASM module and a ChatGPT module;
a Bitcoin-NFT Tokenization module having computer programming code saved to memory and executable on a processor for operating the Bitcoin-NFT Tokenization module, the Bitcoin-NFT Tokenization module operatively connected to the IPFS Decentralized Storage module, the Bitcoin-NFT Tokenization module having a Bitcoin Tokens module, a Bitcoin NFTs module, and an Infrastructure Finance Instruments module, a Bank & Private Loan module and a VCs and Private Investor module are operatively connected to the Bitcoin-NFT Tokenization module;
an NET Copyright Ownership & Validation module having computer programming code saved to memory and executable on a processor for operating the NFT Copyright Ownership & Validation module, the NFT Copyright Ownership & Validation module operatively connected to the Bitcoin-NFT Tokenization module, the NFT Copyright Ownership & Validation module having an NFT Copyright Registry module, and a Smart/Ricardian Contract module using legal prose and structured language protocols;
a WebRTC-QUIC Real Time Communications platform having computer programming code saved to memory and executable on a processor for operating the WebRTC-QUIC Real Time Communications platform, the WebRTC-QUIC Real Time Communication platform in operative communication with the NFT Copyright Ownership & Validation module, the WebRTC-QUIC Real Time Communications platform having a P2P de-Net using a HTTP/3-QUIC-UDP Transport layer protocol, said P2P de-Net connecting a plurality of user devices having a DRM Application, each user device configured to receive, transmit, and store a smart contract, a video, a text document, and a photo, each user device configured to apply DRM rights restrictions selected from copy restriction, print restriction, forward restriction, expiration, and revoke access, each user device configured with SSI ID, wherein said P2P de-Net having a Blockchain module configured to provide and manage DLT, Crypto hash, SSI ID, and Smart Contracts Metadata, said P2P de_net having a DRM Server-Side Rendering module to apply, monitor, and enforce DRM restrictions on files transferred thru the P2P de-Net; and,
a Bitcoin Social Interaction Platform having computer programming code saved to memory and executable on a processor for operating the Bitcoin Social Interaction Platform, the Bitcoin Social Interaction Platform in operative communication with the WebRTC-QUIC Real Time Communications platform, said Bitcoin Social Interaction Platform configured to provide access to a video, a podcast, or a live chat on said user devices
wherein the Cross-chain module having computer programming code saved to memory and executable on a processor for providing cross-chain communication is configured to use cross-chain communication selected from Chainlink, Polkadot Blockchain, and Kusama (Cosmos),
wherein Chainlink is configured as a decentralized Oracle Network that provides cross-chain interoperability and enables non-blockchain enterprises to securely connect with many blockchain platforms, wherein Chainlink is a decentralized oracle network or blockchain abstraction layer that uses blockchain technology to securely enable computations on-chain and off-chain, supporting hybrid smart contracts, wherein Chainlink is configured to integrate with a Bitcoin NFT marketplace to provide access to a blockchain network selected from the group consisting of Ethereum, Solana, Cardano, and Binance, wherein Chainlink blockchain is hosted on the Ethereum platform, which uses the proof-of-stake (PoS) operating protocol, wherein Decentralized Oracles connect blockchains to external systems to allow smart contracts to execute based on inputs and outputs originating from the blockchain, wherein Chainlink is configured to use hybrid smart contracts to decentralize moving smart contracts on and off blockchains,
wherein Polkadot Blockchain is configured as a blockchain platform providing blockchains to exchange messages and perform transactions with each other without a trusted third-party permitting cross-chain transfers of data and assets including smart contracts between different blockchains, and said Polkadot Blockchain is configured for building decentralized applications (DApps) using a Polkadot Network, said Polkadot Network configured with a network protocol that transfers smart contracts across blockchains in a multi-chain application environment where cross-chain registries, cross-chain computation and transfer of smart contracts are possible, said Polkadot Network configured to unite a network of heterogeneous blockchains called parachains, wherein said parachains connect to and are secured by a Polkadot Relay Chain, and
wherein Cosmos is configured as a scalable network of specialized blockchains built using Polkadot Substrates, Cosmos has an Inter-Blockchain Communication (IBC) protocol that provides ability to exchange data and token value securely and restlessly across sovereign blockchains that support IBC, wherein tokens and data (smart contracts) can be exchanged across different blockchains, wherein IBC takes siloed, Cosmos-based blockchains and combines to make an ecosystem called a Cosmos Network.

5. (canceled)

6. (canceled)

7. (canceled)

8. (canceled)

9. A method for generating and transmitting from a first user to a second user, a BTC+NFT identifier using BitCoin blockchain to provide a secure, anonymous, and confidential NFT transaction for an NFT buyer and an NFT seller, comprising the step:
generating and transmitting from a first user to a second user using the system of claim 4, a BTC+NFT identifier using BitCoin blockchain configured to provide a secure, anonymous, and confidential NFT transaction for an NFT buyer and an NFT seller for transacting an NFT identifying a piece of art, a video game product, an intellectual property (IP) asset, a sport related wager or transaction, an on-line gaming transaction, a real estate asset and transaction, and a music-related asset, said BTC+NFT identifier configured to fit within a 4 MB space of a Satoshi unit in a BitCoin block in a BitCoin blockchain, said BTC+NFT identifier pointing to a distributed ledger having a smart contract stored in an IPFS storage facility.
